(19) United States
(12) Patent Application Publication
(10) Pub. No.: US 2010/0318371 A1
(43) Pub. Date: Dec. 16, 2010

(54) COMPREHENSIVE HAZARD EVALUATION SYSTEM AND METHOD FOR CHEMICALS AND PRODUCTS

(75) Inventors: Johnny R. Sanders, JR., Duncan, OK (US); Denise A. Tuck, Katy, TX (US); Patrick J. Finley, Duncan, OK (US); Cliff Paterson, Aberdeen (GB); John A. Hall, Kingwood, TX (US)

Correspondence Address: ROBERT A. KENT, P.O. BOX 1431, DUNCAN, OK, 73536, US

(73) Assignee: HALLIBURTON ENERGY SERVICES, INC., Houston, TX (US)

(21) Appl. No.: 12/483,071

(22) Filed: Jun. 11, 2009

(51) Int. Cl. G06Q 99/00; G06F 17/30; G06F 17/00

(52) U.S. Cl. 705/1.1; 715/273; 705/347; 707/912; 707/955

(57) ABSTRACT

A comprehensive hazard evaluation system and method for chemicals and products. The system includes a memory and a processor. The memory stores the component make-up for each of a number of products. The memory also stores an environmental hazard score, an environmental health hazard score, and a physical hazard score for each component. A product hazard score is determined and stored based on the environmental hazard score, the environmental health hazard score, and the physical hazard score. The processor is operable to process user request and to display the product hazard score for at least one product on a display.

### TECHNICAL FIELD

The present disclosure relates to a chemical and product scoring and comparison system and method, and more particularly to a comprehensive hazard evaluation system and method for chemicals and products.

### BACKGROUND

The oil and gas industry as well as other industries use a number of chemical products for various jobs. For example, in the oil and gas industry, chemical products are used in drilling fluids, in cementing, and in fracture and other production enhancement fluids.

Chemical products are formulated with different chemicals and with chemicals in different concentration to provide the products with different properties and performance characteristics. Chemicals are labeled and classified according to several different system including the United Nations' Globally Harmonized System of Classification and Labeling of Chemicals (GHS). Thus, some products may be suitable for some projects while not being suitable for other projects. By providing a full suite of products, a wide range of projects may be performed.

Products are typically selected for use based on product performance and cost. Thus, for example, a product may be selected if it provides the best performance. However, if other products provide acceptable performance at a lesser price, a less expensive alternative may be selected.

### SUMMARY

A system and method for presenting comprehensive hazard information for a plurality of products is provided. The system includes memory storing the component make-up for a plurality of products. An environmental hazard score, an environmental health hazard score, and a physical hazard score are also stored for each component. A product hazard score is determined and stored for each product based on the environmental hazard score, the environmental health hazard score, and the physical hazard score. A processor is operable to process user requests and to display the product hazard score for one or more products on a display. In addition, the system may print the hazard score, a representation of the hazard score, a comparative graph of hazard scores, the underlying component scores (e.g., envir hazard, envir health hazard, physical hazard scores), and/or any other information used in determining the scores. The system may also store, electronically communicate, displaying, update, and/or otherwise process one or more of the following.

In a particular embodiment, the environmental hazard score, the environmental health hazard score, and the physical hazard score may be weighted based on the percentage of the component in the product and/or based on a level of environmental, environmental health and physical impact of the component. In this and other embodiments, the environmental hazard score may comprise a plurality of water, air, soil, sustainability and hazardous waste scores. The environmental health hazard score may comprise a plurality of carcinogen/mutagen/reproductive hazard, toxicity, eye/skin, and aspiration scores. The physical hazard scores may comprise a plurality of explosive, compressed gasses, flammable liquids, flammable solids, oxidizers, corrosives, and radioactive scores.

The method and system of the disclosure may allow a user to quantify the environmental properties of chemical products by usage type so that the products can be prioritized for use based on the products potential health, safety and environmental hazards. For example, the method and system may balance the degree of hazard level of a chemical product for environmental hazard, physical hazard and environmental health hazard categories. In this embodiment, a score for each product component may be added to give the product a score for each hazard category. The score from each hazard category may be added together to compile a total hazard score for the product. In one embodiment, the lower the score, the more environmentally responsible the chemical product.

The score for chemical products in the same usage type can be compared to determine the most environmentally responsible chemicals for use. The scores can be used to promote the use of “green” and more environmentally responsible chemicals, to help in the development of less hazardous chemical products, to help prioritize products in a chemical portfolio, and to establish the impact of a product with a scientifically defendable system.

The details of one or more embodiments of the disclosure are set forth in the accompanying drawings and the description below. Other features, objects, and advantages will be apparent from the description and drawings, and from the claims.

### DESCRIPTION OF DRAWINGS

FIG. 1 illustrates an example system, with data hosted on high-availability web-servers, application servers, and rich clients interfacing over standard HTTP and HTTPs for presenting a product hazard platform in accordance with certain embodiments included in the present disclosure;

FIG. 2 illustrates an example configuration of a product hazard engine in accordance with certain embodiments included in the present disclosure;

FIG. 3 illustrates an example flow diagram of a method for defining and storing hazard scores for criteria in one or more hazard categories;

FIG. 4 illustrates an example flow diagram of a method for determining, storing and displaying product hazard scores;

FIGS. 5A-5N, 6A-6F and 7A-7R illustrate example Graphical User Interfaces (GUls) displaying charts of criteria and associated definitions for the exemplary environmental, physical and environmental health hazard categories;

FIGS. 8-10 illustrate example GUIs displaying charts of hazard scores for criteria of the environmental, physical and environmental health hazard categories;

FIGS. 11A-11F, 12A-12L, 13A-13F, 14A-14D, 15A-15F, 16A-16F and 17A-17F illustrate example GUIs displaying charts of product hazard scores for exemplary products based on the environmental, physical and environmental health hazard categories; and

FIG. 18 illustrates an example GUI displaying a comparative graph of product hazard scores of the products of FIGS. 11-17.

Like reference symbols in the various drawings indicate like elements.

### DETAILED DESCRIPTION

This disclosure involves systems, methods, and software for viewing, evaluating, analyzing, selecting and/or otherwise managing chemical products and/or chemical components of products based on comprehensive hazard information. These example systems, methods, and software may include techniques at a remote data source or at the front-end client for facilitating product information review, evaluation and/or display. Specifically, such techniques may involve creating a graphical display space interacting with product and/or chemical hazard information and data represented by objects within that space, and identifying, requesting, and populating from a remote location over a network. The user may interact with the system by clicking a displayed object to reveal further information detail in the form of charts, graphs, spreadsheets, textual information, or web-links. Upon initialization or user-selection in the graphical space, data sets used to populate the display are requested and transmitted to the system via HTTP (or HTTPs) web-services links, SQL database links, or other remote data population methods. Example data sets may include environmental hazard, environmental health hazard, and/or physical hazard data and scores as well as underlying criteria and definitions for each hazard category. Other or different hazard categories may be used. For example, waste disposal classification, energy use, and other categories impacting human or animal health or environment. Carbon footprint may be considered within a category or otherwise. In other words, the display is, in one embodiment, a view of comprehensive hazard information for products.

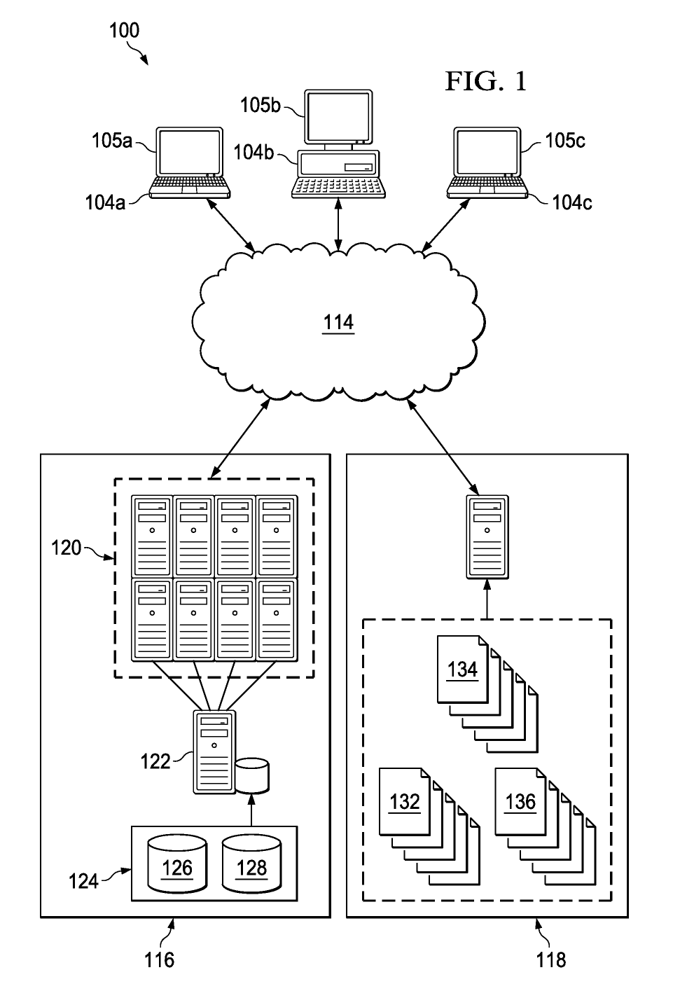

At a high level, an example platform implementing some or all of the techniques described herein can include a client and a backend data source, typically resident at a server or server bank as shown by FIG. 1. The client may be a thick or intelligent client that retrieves the information to satisfy a request, but without the overhead of retrieving the entire data set or the need to have a local representation of the data. Moreover, while being implemented in a thick client, the interface may use the more familiar elements of a browser. Additionally, these components allow for standardized or generic data processing interfaces, as well as easy scalability.

Very fast, interactive visualization in the example systems may use a software “kernel” that is high performance, optimized, and utilizes the high-quality visualization capability available in hardware today. One of the features of such example software is ease of use and modularity. The software may also allow for custom workflows to be developed that couple traditional tools such as spreadsheets, graphs and charts into a portfolio creation and analysis tool that enables the user to glean relevance and insight from data. The modular nature of the technology may allow add-on applications that can serve several markets at once with low cost of development. In addition, this architecture may easily serve customers requiring proprietary interconnections with their own software. For example, hazard categories, criterion and definitions may be shared while customers may individually retain product information and formulation.

To facilitate the low-cost, interactive nature of the display, very large data handling over networks is another design feature of the software system. The technology is limited only by the memory of the host computer running the system, and by the bandwidth of the network connection feeding data to the program. The ability to handle very large datasets interactively helps provide customers with the capability to analyze vast amounts of data—visually—very fast. Data throughput over networks, such as the internet, is enhanced by minimizing the requested data set to reduce bandwidth and increase processing speed. Indeed, the data flow can be optimized be sending compressed text over HTTP (or HTTPs) instead of—or as a supplement to—over complex or congested database connections. These text connections can be much more flexible and quick than static (or hard-coded) connections, ODBC, JDBC, and so forth.

Turning to the illustrated example environment in FIG. 1, the product hazard information platform 100 includes or is communicably coupled with one or more servers 120 or 122, one or more clients 104, and a network 114. The servers 120 and 122 may represent one or more logical or physical locations for the chemical and/or product hazard information application provider, such as backend process 116 and a front-end process 118. For example, as illustrated the product hazard information platform may be implemented using application servers 120 and database servers 122; but, for ease of reference, such functionality as appropriate may be embodied within a single server or server bank and will be referred to as server 120. The server 120 includes memory and one or more processors and comprises an electronic computing device operable to receive, transmit, process, store or manage data associated with the system. Generally, this disclosure provides merely one example of computers that may be used with the disclosure. As used in this document, the term “computer” is intended to encompass any suitable processing device. For example, the platform can be implemented using computers other than servers, as well as a server pool or bank. Indeed, the server 120 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. The server may be adapted to execute any operating platform including Linux, UNIX, Windows Server, or any other suitable operating system. According to one embodiment, the server may also include or be communicably coupled with a web server 130 and/or a mail server.

Memory 124 may include any storage or database module and may take the form of volatile or non-volatile tangible memory including, without limitation, magnetic media, optical media, random access memory (RAM), read-only memory (ROM), removable media, or any other suitable local or remote memory component. For example, this memory can include local RAM or any appropriate repository such as, for example, a secure server, a data center or warehouse, a dedicated computer, third party data providers, and others. Regardless of the particular configuration, the memory may typically store some or all of classes, frameworks, applications, backup data, jobs, web services or interfaces, or other information that includes parameters, variables, algorithms, instructions, rules, or references thereto. In the illustrated example, memory 124 stores a chemical hazard database 126 and a product database 128. The memory may also include any other appropriate data such as VPN applications, firmware logs and policies, firewall policies, a security or access log, print or other reporting files, HTML files or templates, and others. For example, illustrated web server 130 references or stores the website 132, downloads 134, and online help 136.

The server 120 also includes a processor. The processor executes instructions and manipulates data to perform the operations of the server such as, for example, a central processing unit (CPU), a blade, an application specific integrated circuit (ASIC), or a field-programmable gate array (FPGA). Although described as a single processor in the server, multiple processors may be used according to particular needs and reference to processor is meant to include multiple processors where applicable.

The server 120 also includes an interface for communicating with other computer systems, such as the clients, over the network in a client-server or other distributed environment. Generally, the interface comprises logic encoded in software and/or hardware in a suitable combination and operable to communicate with the network. More specifically, the interface may comprise software supporting one or more communications protocols associated with communications such that the network or hardware is operable to communicate physical signals.

The network 114 facilitates wireless or wireline communication between the server and any other local or remote computer, such as the clients. The network 114 may be all or a portion of an enterprise or secured network. In another example, the network 114 may be a virtual private network (VPN) merely between the server and the client across wireline or wireless link. Such an example wireless link may be via 802.11a, 802.11b, 802.11g, 802.11n, 802.20, WiMax, and many others. While described as a single or continuous network, the network 114 may be logically divided into various sub-nets or virtual networks without departing from the scope of this disclosure, so long as at least a portion of the network may facilitate communications between the server and at least one client. For example, the server 120 may be located within its own local network 114 (the “provider” network) and the client 104 may be located within its own local network 114 (the “customer” or “analyst” network), with them being connected across a third network 114. In other words, the network 114 encompasses any internal or external network, networks, sub-network, or combination thereof operable to facilitate communications between various computing components in the system. The network may communicate, for example, Internet Protocol (IP) packets, Frame Relay frames, Asynchronous Transfer Mode (ATM) cells, voice, video, data, and other suitable information between network addresses. The network 114 may include one or more local area networks (LANs), radio access networks (RANs), metropolitan area networks (MANs), wide area networks (WANs), all or a portion of the global computer network known as the Internet, and/or any other communication platform or systems at one or more locations such as the example in FIG. 1A. In certain embodiments the network 114 may be a secure network associated with the enterprise and certain local or remote clients 104.

The client 104 is any computing device operable to present the user with the landscape or other display in an appropriate form. To do so, the client 104 may connect or communicate with the server 120 or other components on the network 114 to collect hazard, product and chemical data that can enhance the user's experience or analysis. At a high level, each client 104 includes at least the GUI 105 and, in some cases, an agent and comprises an electronic computing device operable to receive, transmit, process and store any appropriate data associated with the backup system. It will be understood that there may be any number of clients 104 communicably coupled to the server 120 (or 122 and 130). For example, the clients 104 can include one local client and three external clients to the illustrated portion of the network. Further, “the client,” “customer,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. As used in this disclosure, the client 104 is intended to encompass a personal computer, touch screen terminal, workstation, network computer, kiosk, wireless data port, smart phone, personal data assistant (PDA), one or more processors within these or other devices, or any other suitable processing device. For example, the client 104 may be a laptop that includes an input device, such as a keypad, touch screen, mouse, or other device that can accept information, and an output device that conveys information associated with the operation of the server or the clients, including digital data, visual information, or the GUI 105. Both the input device and output device may include fixed or removable storage media such as a magnetic computer disk, CD-ROM, or other suitable media to both receive input from and provide output to users of the clients through the display, namely the GUI 105.

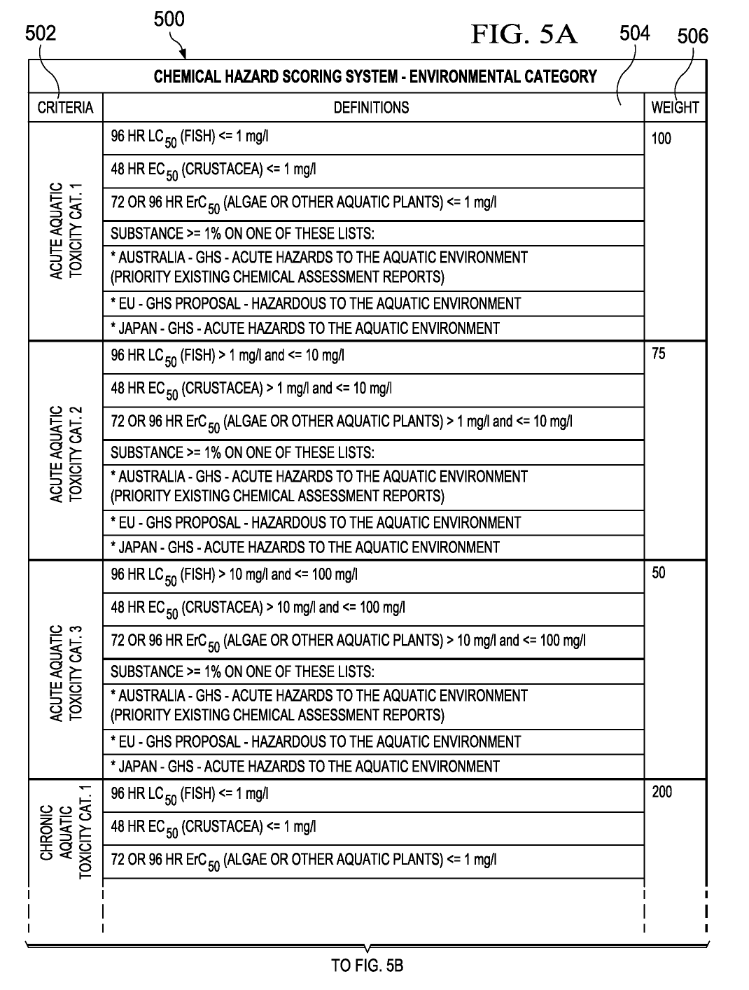

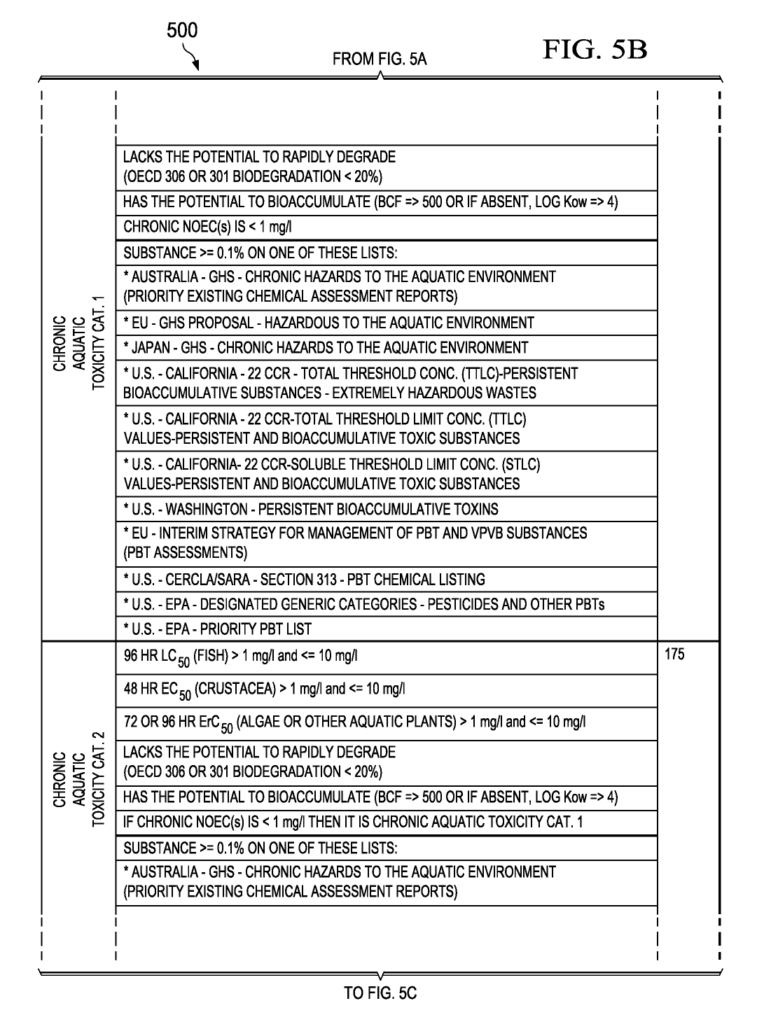

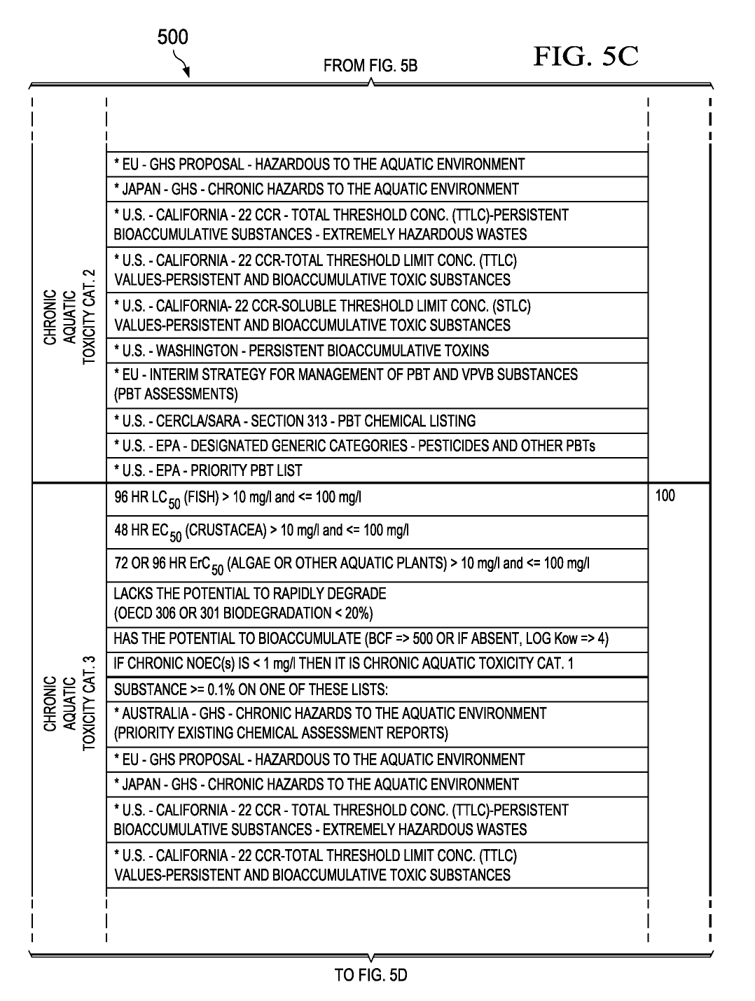

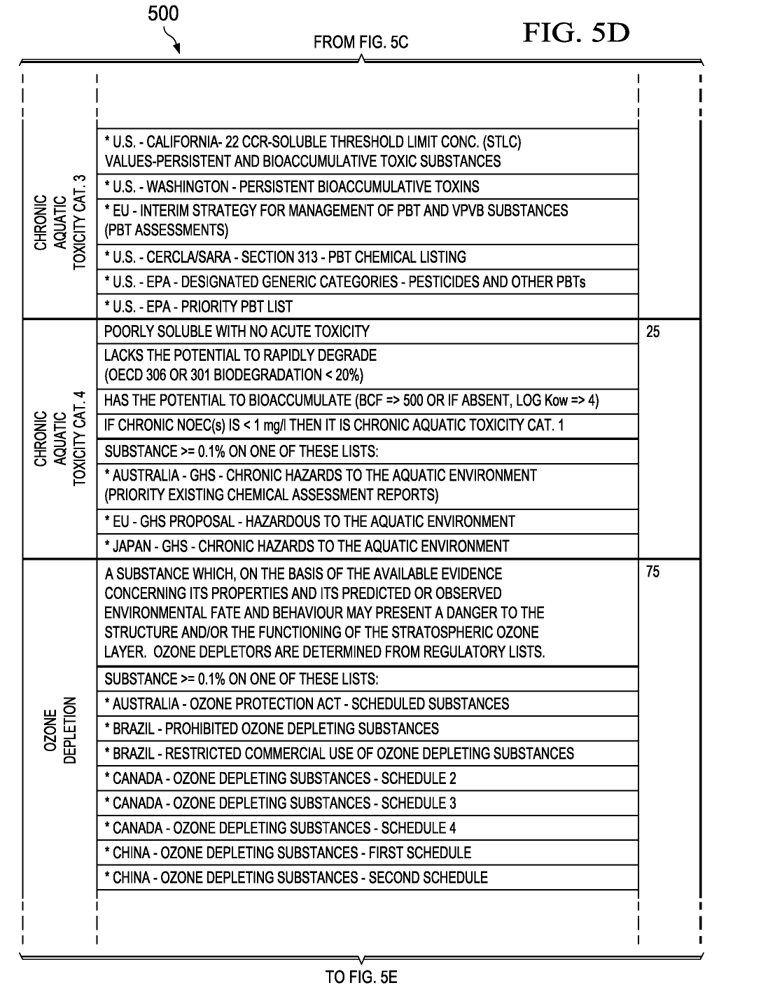

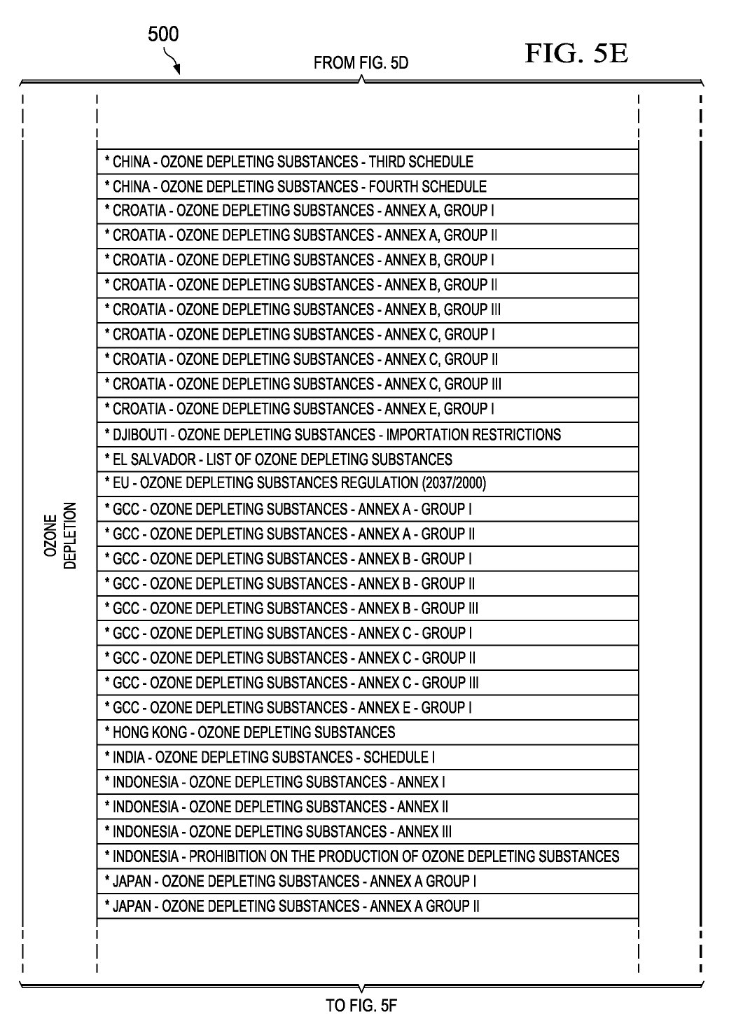

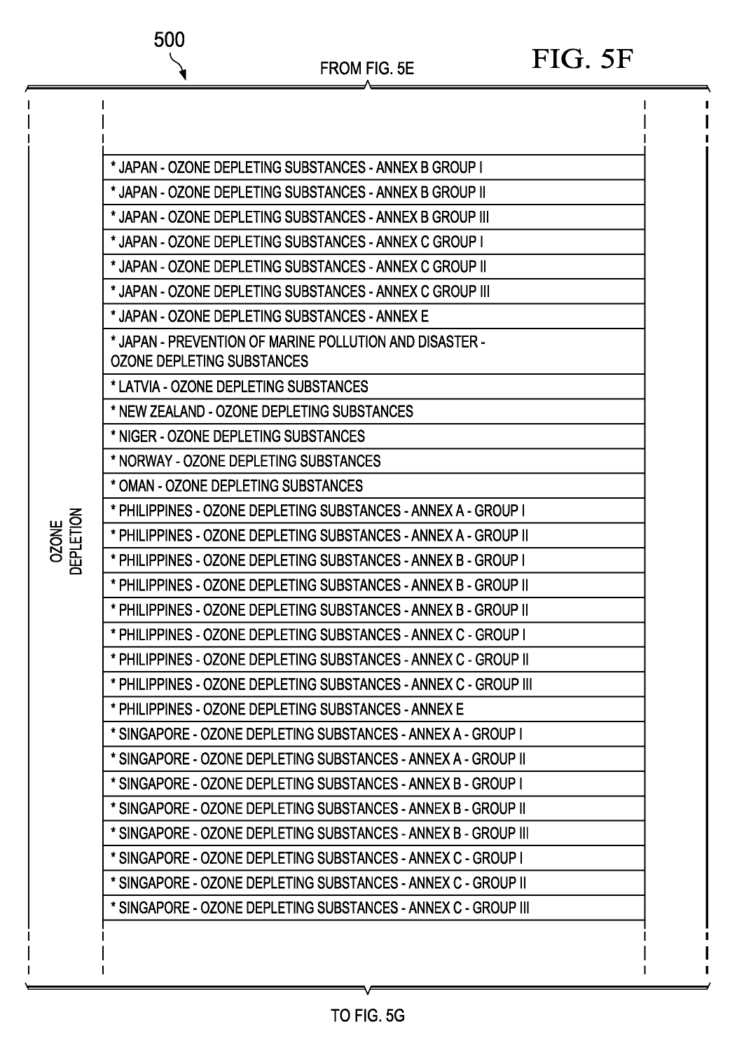

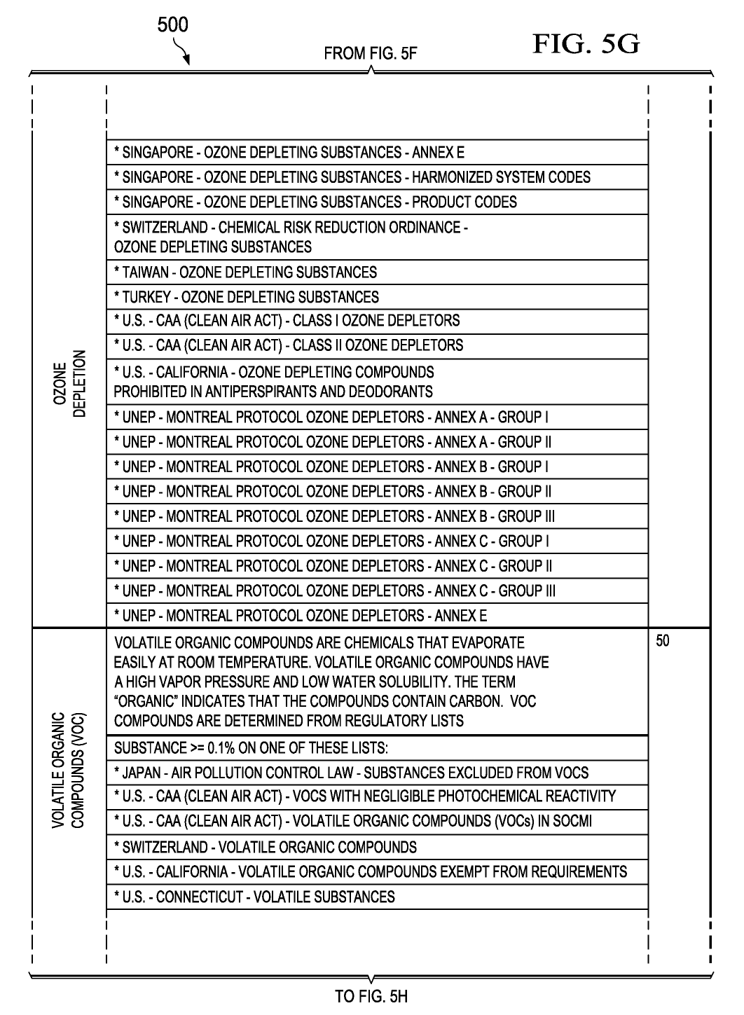

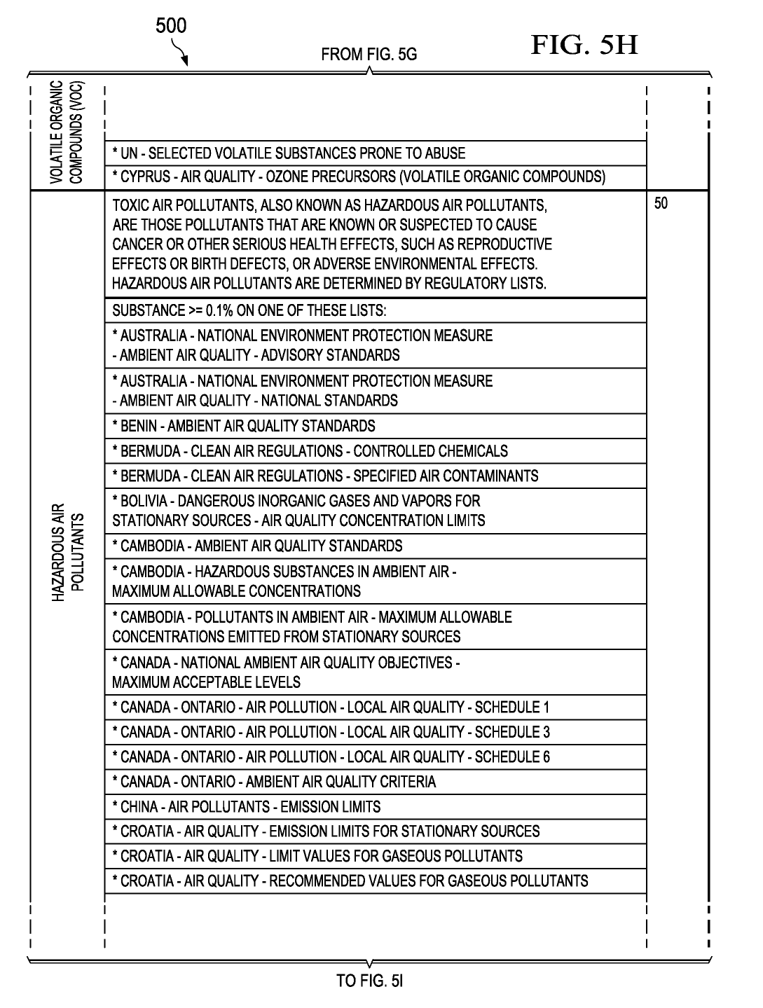

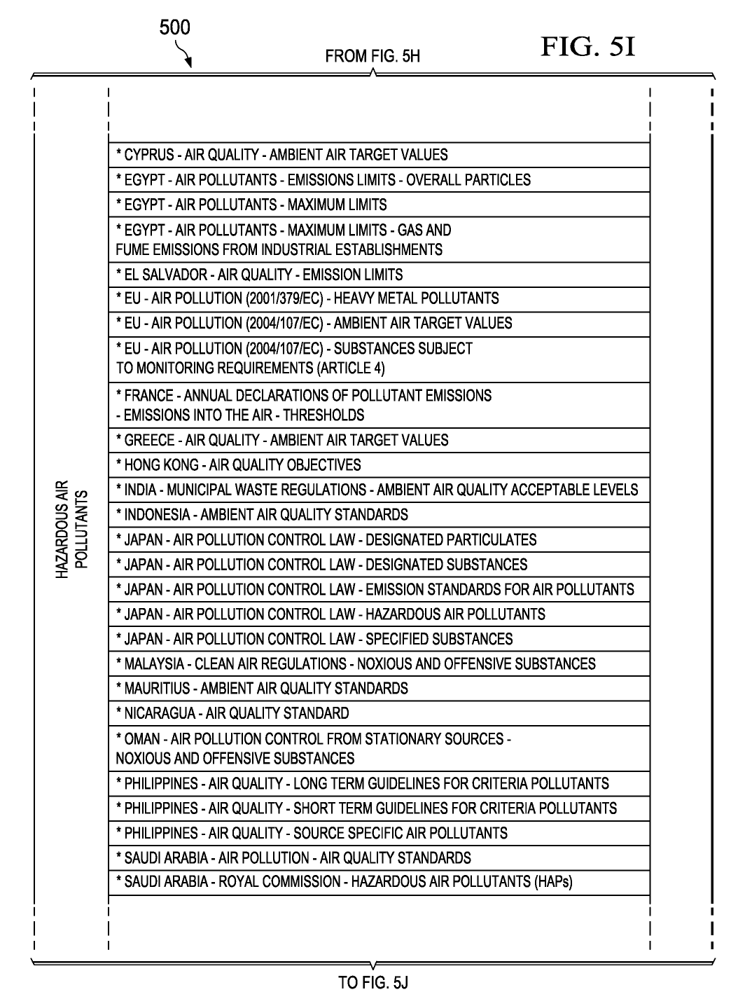

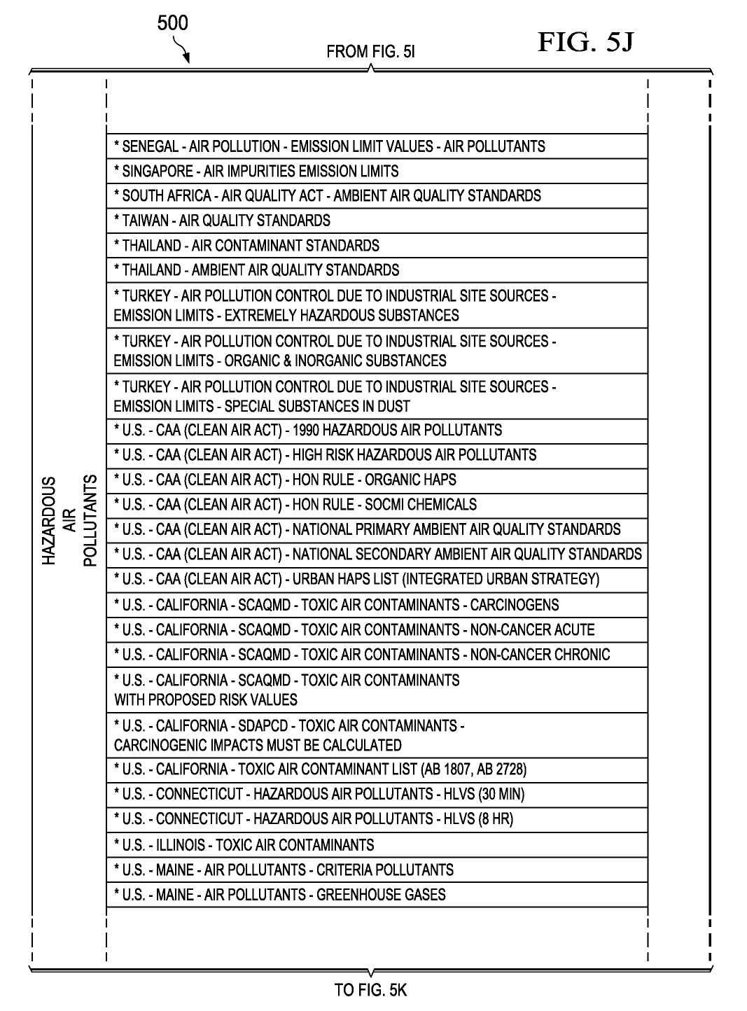

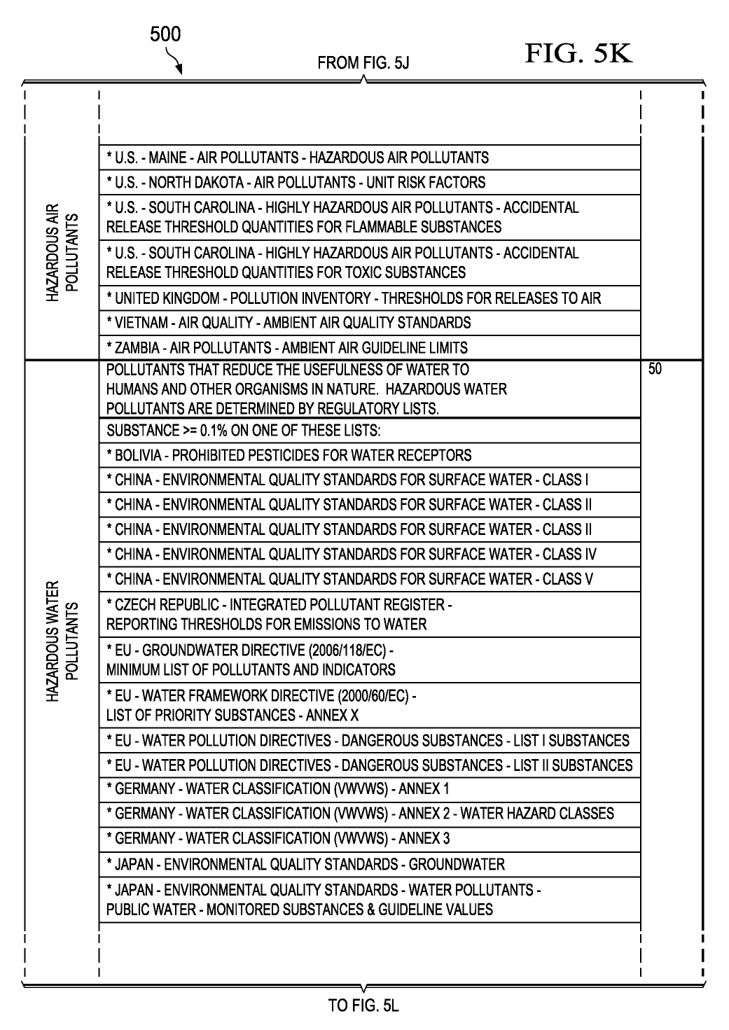

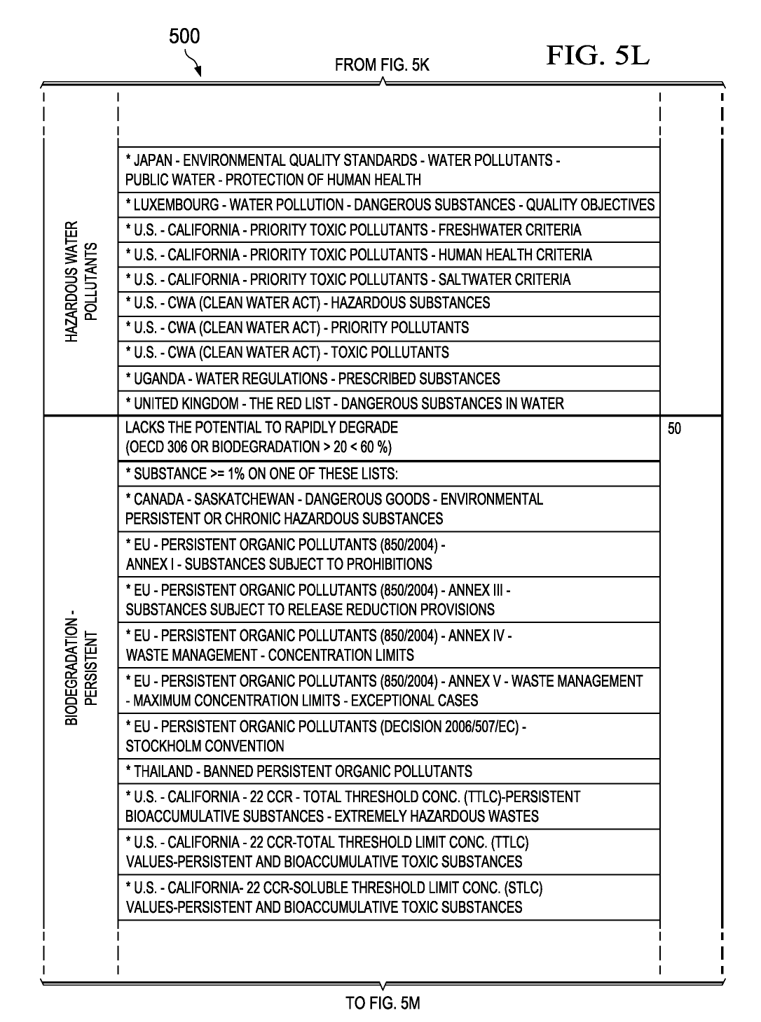

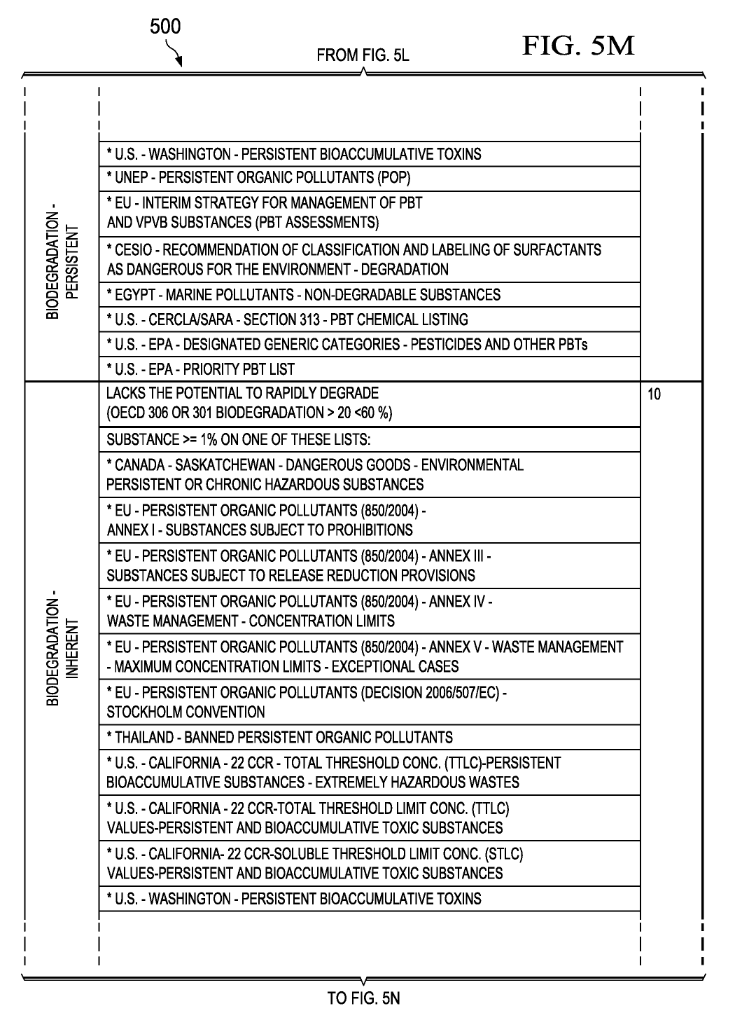

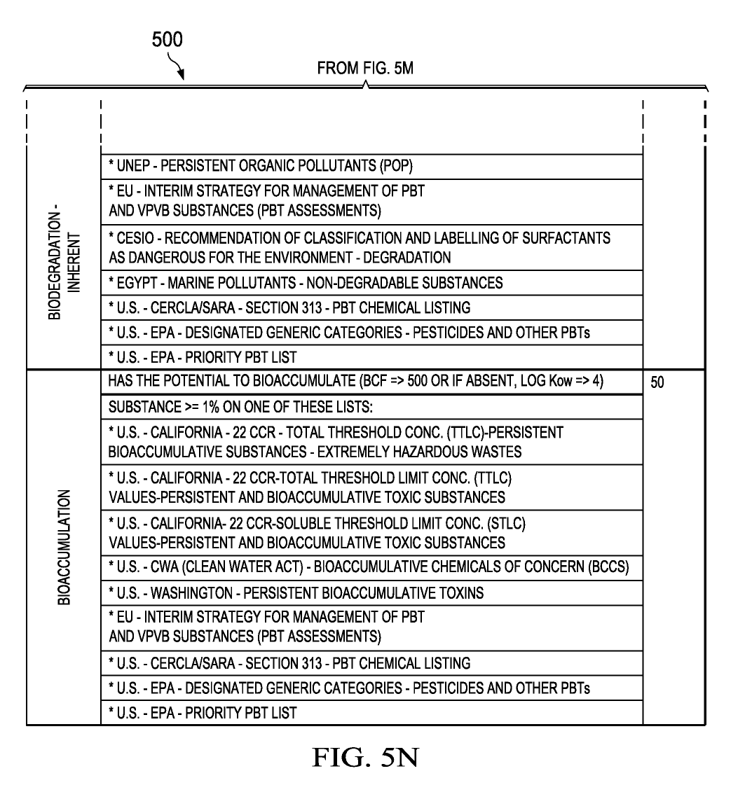

The GUI 105 comprises a graphical user interface operable to, for example, allow the user of the client to interface with at least a portion of the platform for any suitable purpose, such as viewing large chemical or product barcode data sets. Generally, the GUI 105 provides the particular user with an efficient and user-friendly presentation of financial data provided by or communicated within the system. Example data displays are shown in FIGS. 5-18. The GUI 105 may comprise a plurality of customizable frames or views having interactive fields, pull-down lists, and buttons operated by the user. For example, the GUI 105 may include sliders or other controls that allow user adjustment of the graphical representation of the data (such as component amounts and types as well as animation, zooming and fly through and so on). The GUI 105 is often configurable, supports a combination of tables and graphs (bar, line, pie, status dials, etc.), and is able to build real-time portals, where tabs are delineated by key characteristics (e.g. site or micro-site). The GUI 105 is further operable to generate or request historical or other transactional reports. Generally, historical reports provide critical information on what has happened including static or canned reports that require no input from the user and dynamic reports that quickly gather run-time information to generate the report. Therefore, the GUI contemplates any suitable graphical user interface, whether thick or thin, such as a combination of a generic web browser, intelligent engine, and command line interface (CLI) that processes information in the platform and efficiently presents the results to the user visually. The server can accept data from the client via the web browser (e.g., Microsoft Internet Explorer or Mozilla Firefox) and return the appropriate HTML, PHP, or XML responses to the underlying engine using the network.

As illustrated in representative FIGS. 5-18, the GUI 105 can present information in various forms. For example, throughout a session, the user can view information in tables, spreadsheets, graphically and/or otherwise. In this way, the user enters information and requests such as products meeting certain specifications or otherwise suitable for a job. The user may view the resulting suitable products and comprehensive hazard information associated with the suitable products. A suitable product (or chemical for a product) may be the products (or chemicals) meeting the basic or other technical, legal, cost, performance and/or the requirements for a job, or project, and, for example, available for use for the project. Among many other things, this may help the user identify products for use on a job that limit or minimize hazardous impacts, including, for example, environmental health, environmental, and/or physical impacts. Further, using these techniques, it is possible for the user to balance product performance against environmental and health impact.

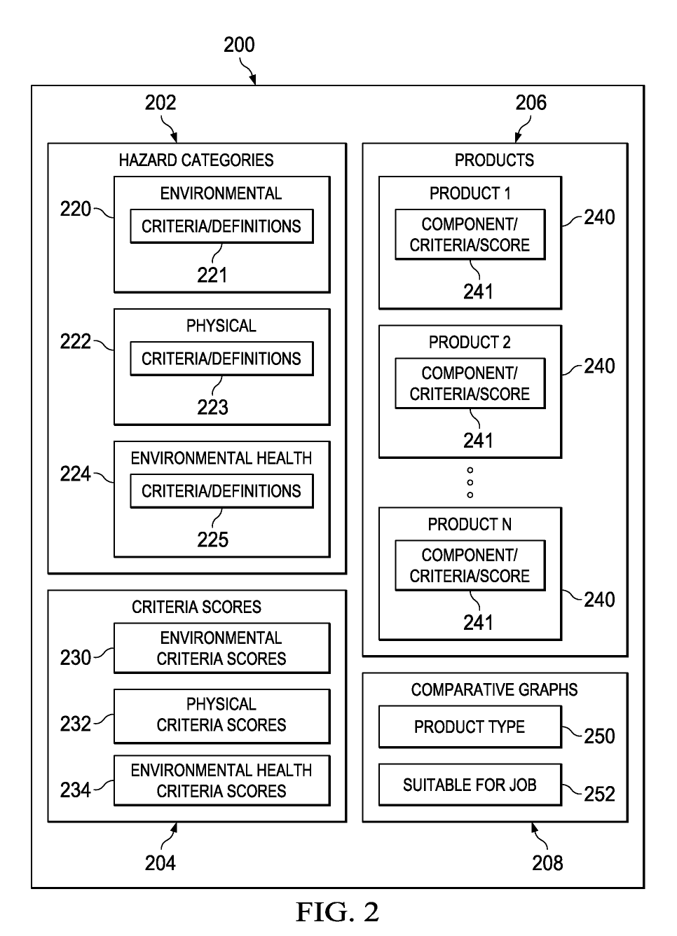

In certain embodiments, the client 104 executes software through a product hazard engine 200 (shown in FIG. 2), which is any software operable to invoke or execute certain described processes and that presents product and/or chemical hazard information in an interface, such as the GUI. For example, the product hazard engine 200 may represent a thick client that, for instance, can be downloaded for free or for a fee; this thick client would often include a number of connections to the backend server and other data repositories. In another example, the product hazard engine 200 may represent an applet or other client-side intelligence embodied within a web page or other similar thin client. Regardless of the particular implementation, “software” or “computer readable instructions” may include any software, firmware, wired or programmed hardware, or any combination thereof (embodied on or in tangible computer readable media) as appropriate to instruct the respective one or more processors. Indeed, the product hazard engine 200 may be written or described in any appropriate computer language including C, C++, Java, Visual Basic, assembler, Perl, any suitable version of graphics software or APIs, as well as others. It will be understood that the product hazard engine 200 may include any number of sub-modules, such as a business application and third party modules or libraries, or it may instead be a single multi-tasked module that implements the various features and functionality through various objects, methods, or other processes. For example, the product hazard engine 200 may include or invoke a metric computer or calculator module. This metric calculator module allows the user to manipulate the data received from the remote source within his local programming environment. The product hazard engine 200 may also provide a program or macro editor that offers the user the ability to further customize his or her experience. Further, while described as internal to the client or the server, respectively, one or more processes associated with the product hazard engine 200 may be stored, referenced, or executed remotely from that device. For example, a portion of the product hazard engine 200 may be a local library or process, while another portion of the product hazard engine 200 may be an object bundled for processing at a remote client. Thus the client may also include, reference, or execute an agent to assist in data collection and presentation. The agent may be any script, library, object, executable, service, daemon, or other process. In another example, the majority of processes or modules may reside - or processing takes place—on the client. Moreover, the product hazard engine 200 may be a child or sub-module of another relatively local software module or enterprise application (not illustrated) without departing from the scope of this disclosure. Such configurations may use modules such as those illustrated in FIG. 2 or other modules with similar functionality as appropriate.

Specifically, FIG. 2 illustrates an example configuration or schematic of the product hazard engine 200. As noted above, such a configuration is an example for illustrative purposes. The illustrated product hazard engine 200 includes a number of modules such as a hazard categories module 202, criteria scores module 204, products module 206 and comparative graphs module 208. The hazard categories module 202 and criteria scores module 204 may be stored as part of the chemical hazard database 126 or otherwise. The products module 206 and the comparative graphs module 208 may be stored as part of the product database 128 or otherwise.

Using some or all of the foregoing example components and configurations, the server 120 (or server bank) can retrieve data from multiple data sources based on a (software or user-directed) request from a client 104. In this instance, each of the one or more data sources may be stored in an enterprise-wide repository as one or more tables in a relational database described in terms of SQL statements or scripts. In another embodiment, the stored data may be formatted, stored, or defined as various data structures in text files, eXtensible Markup Language (XML) documents, Virtual Storage Access Method (VSAM) files, flat files, BTree files, comma-separated-value (CSV) files, internal variables, or one or more libraries. In short, the data may comprise one table or file or a plurality of tables or files stored on one computer or across a plurality of computers in any appropriate format. Often, the data can be fetched and cached in real time and then stored in the respective database. For example, the server-oriented database may be refreshed or otherwise intelligently updated from other remote data sources, such as six times a day via XML over File Transfer Protocol (FTP). These other remote data sources may comprise third parties that expose API sets or web services, perhaps via subscription, that provide the data to the server. This data can be fundamental information that doesn't change over the course of one day. For changing data it may be imported directly into the server's memory or (at least a subset) communicated directly to the client 104. In certain situations, the server 120 may fold data streams into memory and key to towards an ISIN field. In this way, each client 104 is able to easily access the data. Such access can be further enhanced through use of GZIP textual communications through GZIP plug-ins, which are often already present at clients 104 and also allow clients 104 to add their own data streams. Once sent to the client, it is expected that certain clients 104 will cache the information (via HTTP or offline repository) such that request information may be locally obtained, perhaps using a hashed table, thereby reducing process time. In this example, each data item communicated from the server 104 may include a cache header with a timestamp and cache validity flag or length. When warranted, server 102 may force a cache deletion or purge from the client 105.

FIG. 2 illustrates an example configuration of the product hazard engine 200 in accordance with one embodiment of the present disclosure. In this embodiment, the product hazard engine 200 comprises hazard categories module 202, criteria scores module 204, products module 206, and comparative graphs module 208. Other and/or different modules may be used in the products hazard engine 200. As described above, the products hazard engine 200 may be a distributed engine or may be implemented on a stand alone computer.

Referring to FIG. 2, hazard categories module 202 includes one or more hazard categories. In one embodiment, the hazard categories may comprise a environmental hazard category 220, a physical category 222, and an environmental health hazard category 224. Other embodiments may comprised other, different or a lesser number of hazard categories.

The environmental hazard category 220 comprises a plurality of criteria and associated definitions 221. The environmental hazard category 220 may account for environmental hazards from chemical substances that can cause short term or long term adverse effects to the surrounding environment when released into the air, soil or water (marine, fresh water, drinking water). The adverse effects can involve the surrounding environment or plants, animals or human health and life. The environmental hazards category 220 may include one, more, or all of the following criteria for water, air, soil, sustainability and hazardous waste. For example, water criteria may include (or account for) acute aquatic toxicity (Cat. 1, 2, and 3), chronic aquatic toxicity (Cat. 1, 2, 3, and 4), hazardous water pollutants, biodegradation (persistent and inherent), and bioaccumulation. Air criteria may include hazardous air pollutants, ozone depletion, volatile organic compounds, biodegradation (persistent and inherent), and bioaccumulation. Soil criteria may include ecotoxicity, biodegradation (persistent and inherent), and bioaccumulation. Sustainability criteria may include energy used to produce substance and/or product (carbon dioxide units), waste produced in manufacturer of substance and/or product, water use for producing substance and/or product, and amount of product required for end use. Hazardous waste criteria may include listed waste, toxic waste, corrosive waste, and flammable waste.

In a particular embodiment, the environmental hazards category 220 may comprise the environmental criteria 502 and associated definitions 504 illustrated by the environment category chart 500 of FIG. 5. The criteria 502 is met if the definition 504 associated with the criteria 502 is met, which may be done by meeting any part of the definition, meeting a major basis of the definition and/or meeting several minor bases of the definition. In other embodiments, the full definition 504 may need to be met for some or all criteria 502. The definition 504 may include that of the United Nations' Globally Harmonized System of Classification and Labeling of Chemicals (GHS), of the United States, of Europe, of Japan, of Australia, and/or other governmental bodies or nations. Also, as shown in FIG. 5, a weight 506 of the criteria may be provided in the chart 500. The weight 506 is a maximum impact of the associated criteria for the category. The weight may be determined empirically, based on available data and standards and/or professional judgment. In the illustrated embodiment, the highest impact may be set to 200 for the greatest hazard. For example, for persistent or bio-cumulative hazards, other suitable relative ranges and scoring may be used.

The physical hazards 222 may include criteria and definitions 223. The physical hazard category 222 may account for physical hazards from chemical substances that may cause adverse physical effects to humans, equipment, facilities or the environment. The physical hazards category 222 may include one, more or all of the criteria for explosives, compressed gasses, flammable liquids, flammable solids, oxidizers, corrosives and radioactivity. For example, explosives criteria may include explosive, and pyrotechnic. Compressed gasses criteria may include gases under pressure (non-flammable), flammable gas, and oxidizing gas. Flammable liquids criteria may include flammable liquid (Cat. 1, 2, 3, and 4). Flammable solids criteria may include flammable solid, pyrophoric (liquids and solids), self-reactive substance, self-heating substance, and substances that emit flammable gases in contact with water. Oxidizers criteria may include oxidizer (liquid or solid), and organic peroxide. Corrosive criteria may include corrosive to metals.

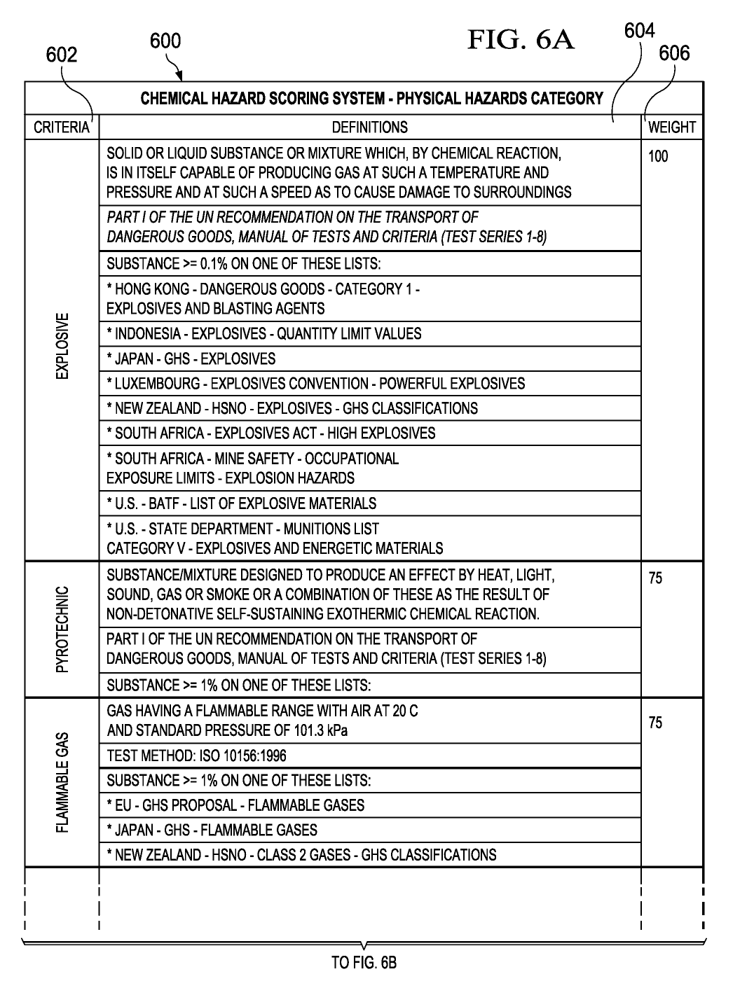

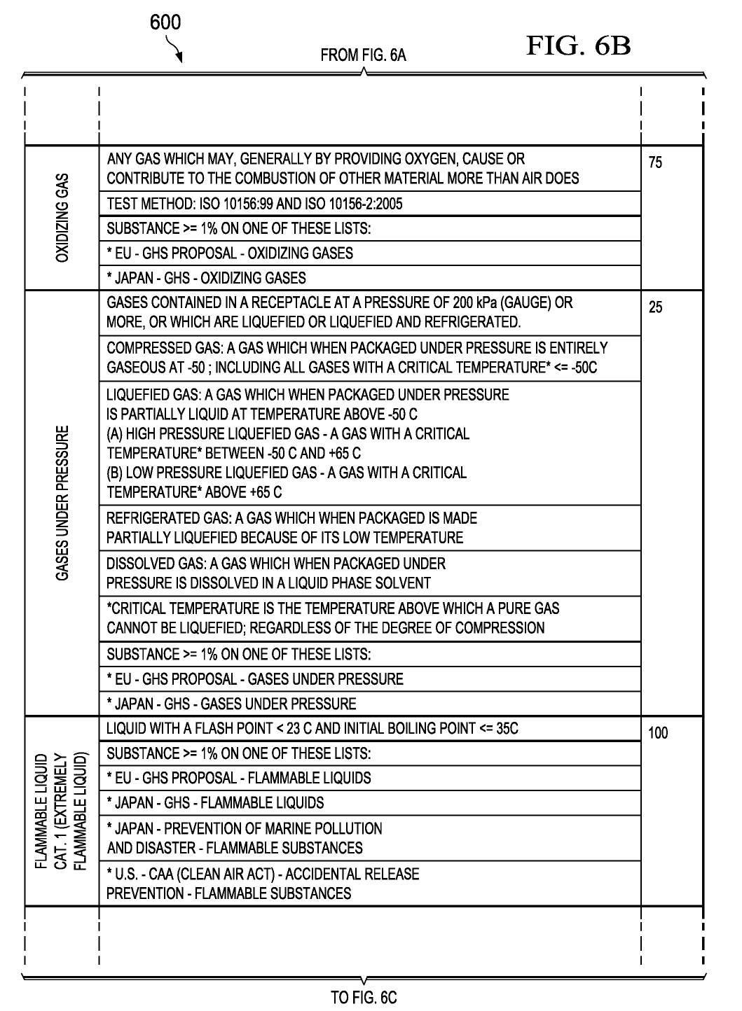

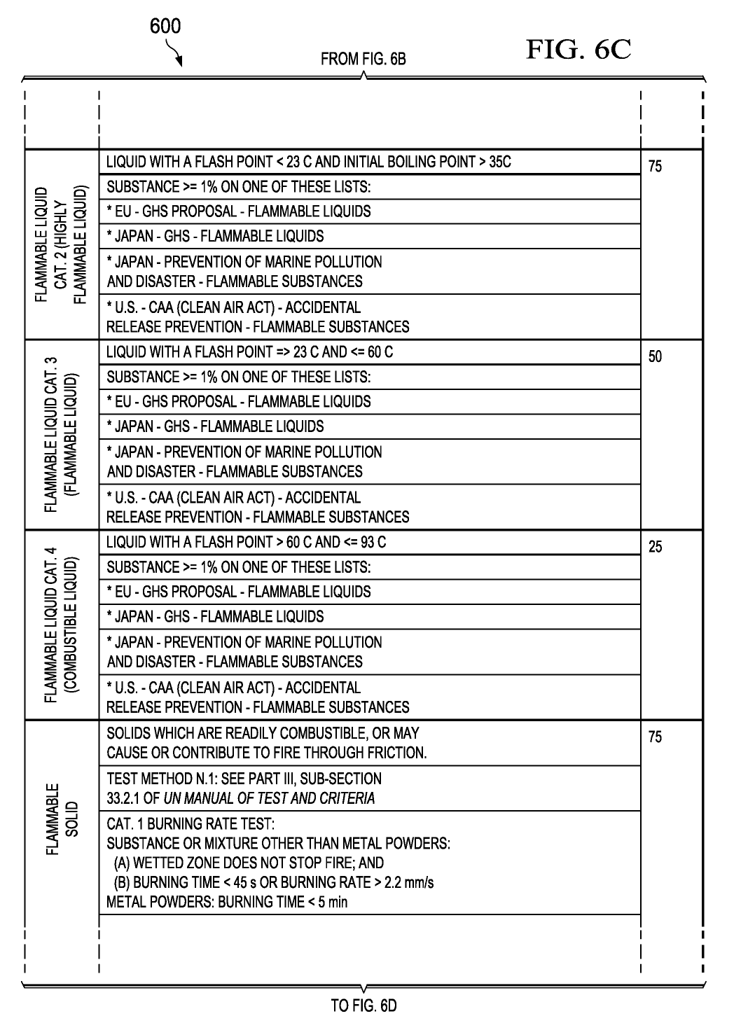

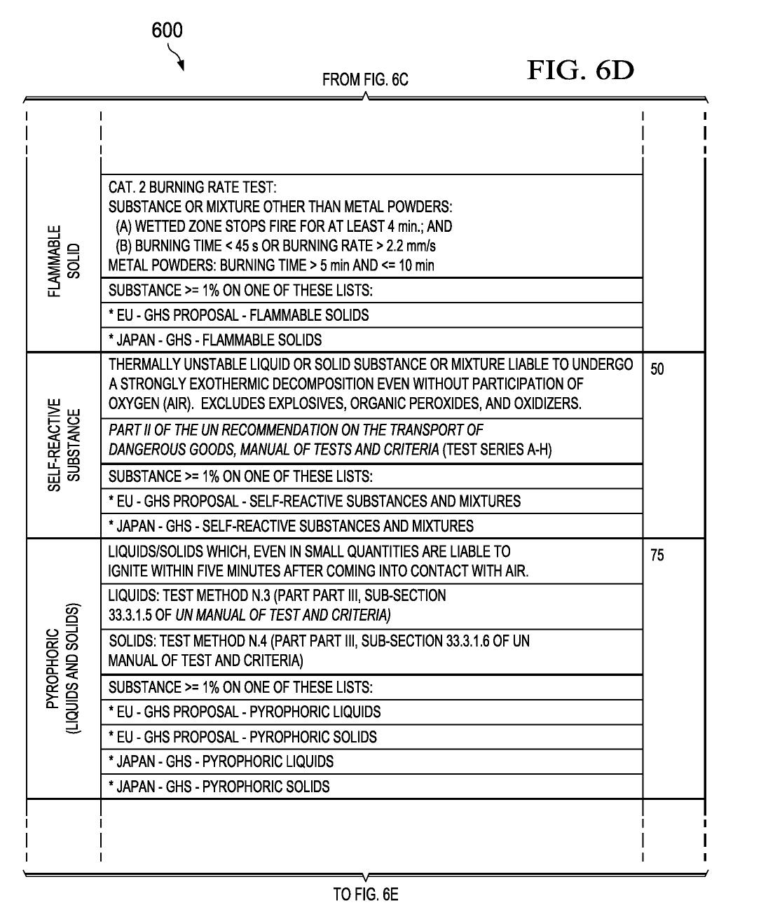

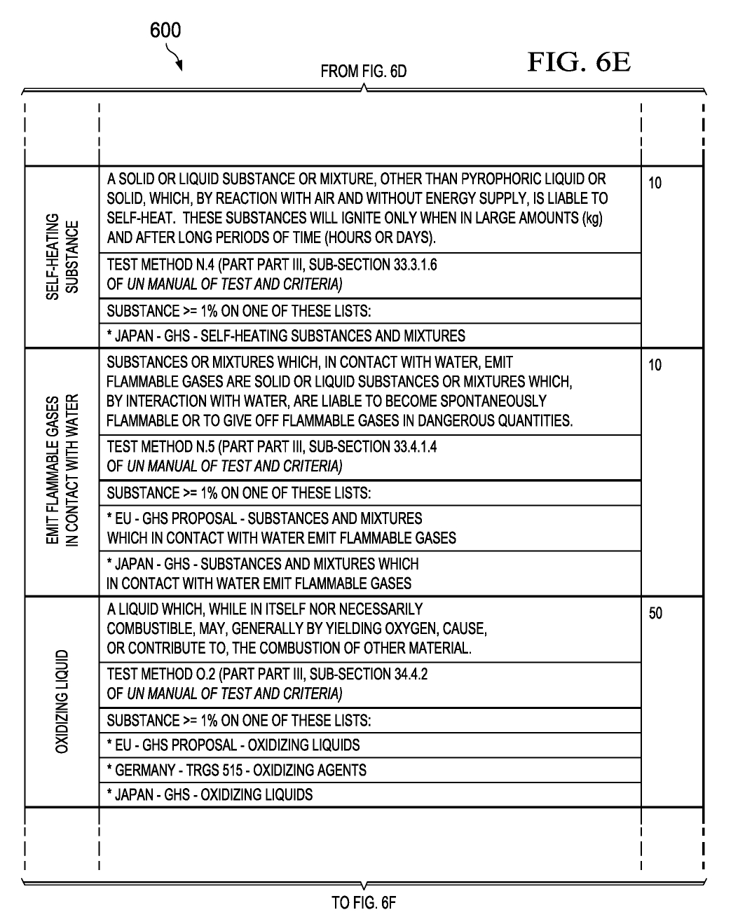

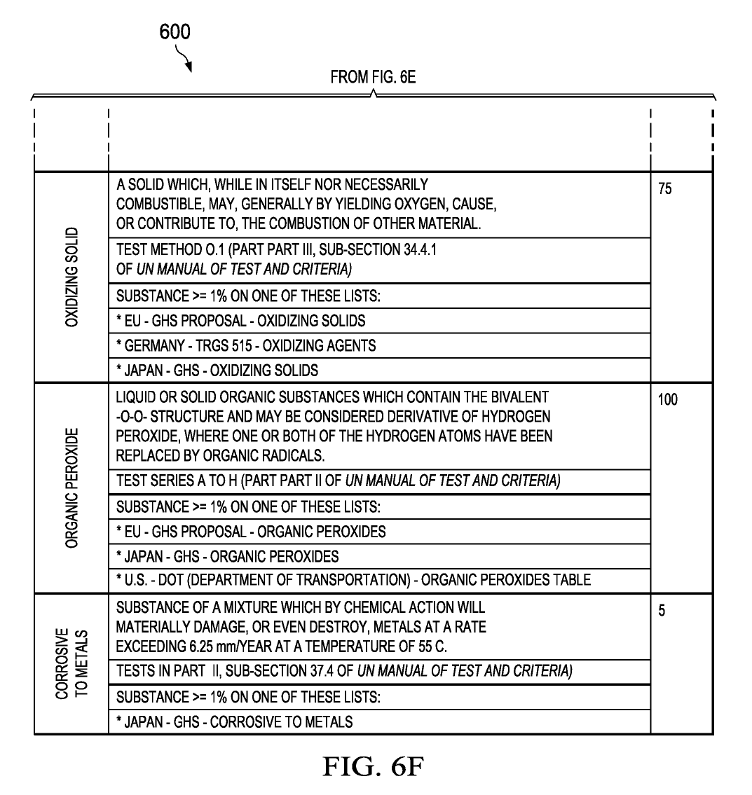

In a particular embodiment, the physical hazards category 222 may comprise the physical criteria 602 and the associated definitions 604 illustrated by the physical category chart 600 of FIG. 6. Thus, as with the environmental hazards, a physical hazard criteria 602 may be met if the definition 604 associated with the criteria 602 is met. As also shown in FIG. 6, the weight 606 of the criteria may also be provided in the chart 600. The weight 606 a maximum physical impact of the criteria.

The environmental health category 224 includes criteria and definitions 225. The environmental heath category 224 may account for environmental health hazards from chemical substances that may cause adverse effects to human health from short term or long term exposures. The environmental health hazards category 223 may include one, more or all of the criteria for carcinogen/mutagen, reproductive hazards, toxicity, eye/skin, and aspiration. For example, carcinogen/mutagen/reproductive hazards criteria may include carcinogen (Cat. 1 and 2), mutagens, and reproductive toxins. For example, toxicity criteria may include acute toxicity (Cat. 1, 2, 3, and 4), endocrine disruptors, acute target organ toxicity (effect organ or organ systems such as kidneys, liver, etc.), and chronic target organ toxicity (effect organ or organ systems such as kidneys, liver, etc.). For example, eye/skin criteria may include corrosivity (Cat. 1 and 2), and sensitizers. For example, aspiration criteria may include aspiration (when swallowed can aspirate into lungs and cause damage). Within and outside the environmental health category 224 and other hazard categories, criteria may or may not be mutually exclusive.

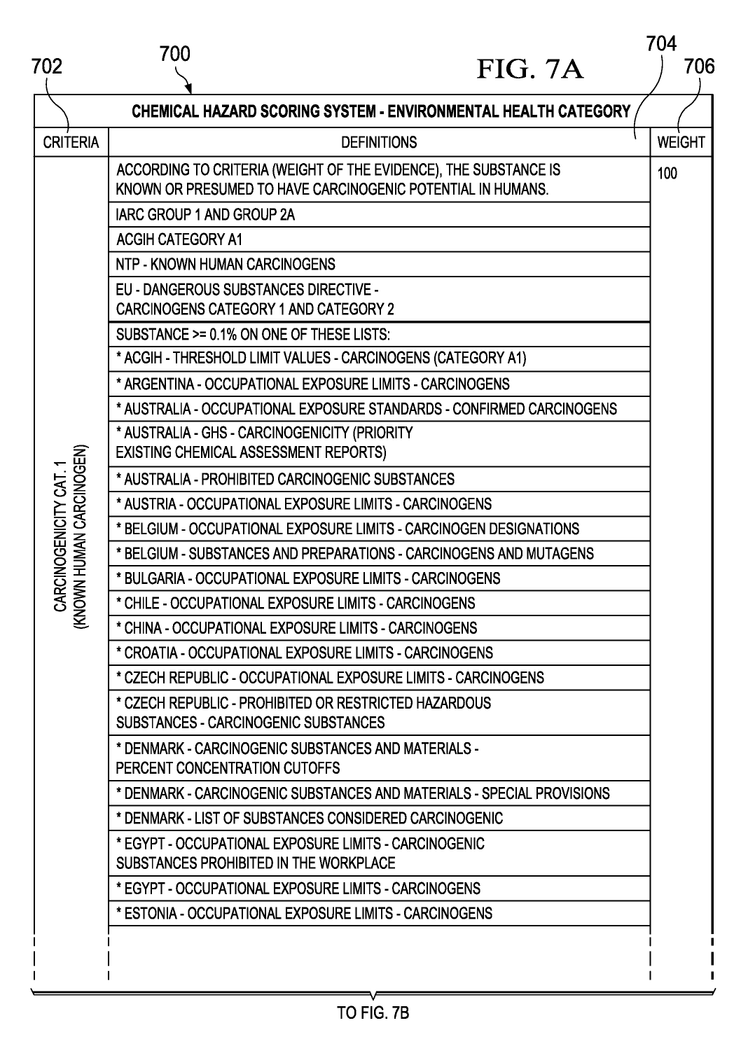

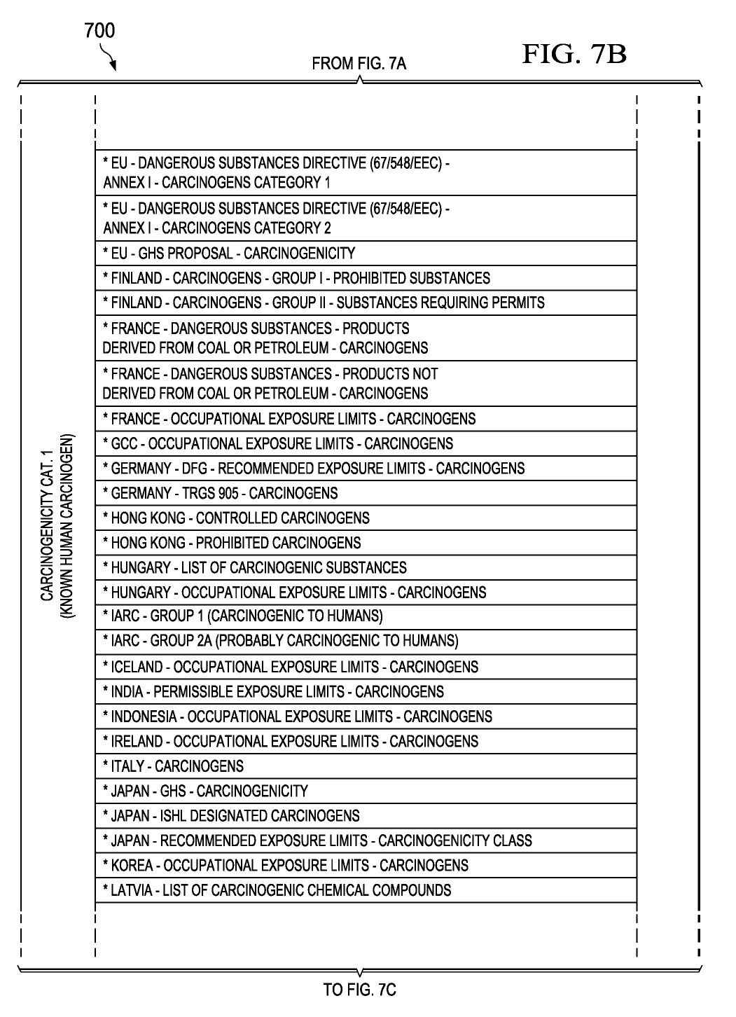

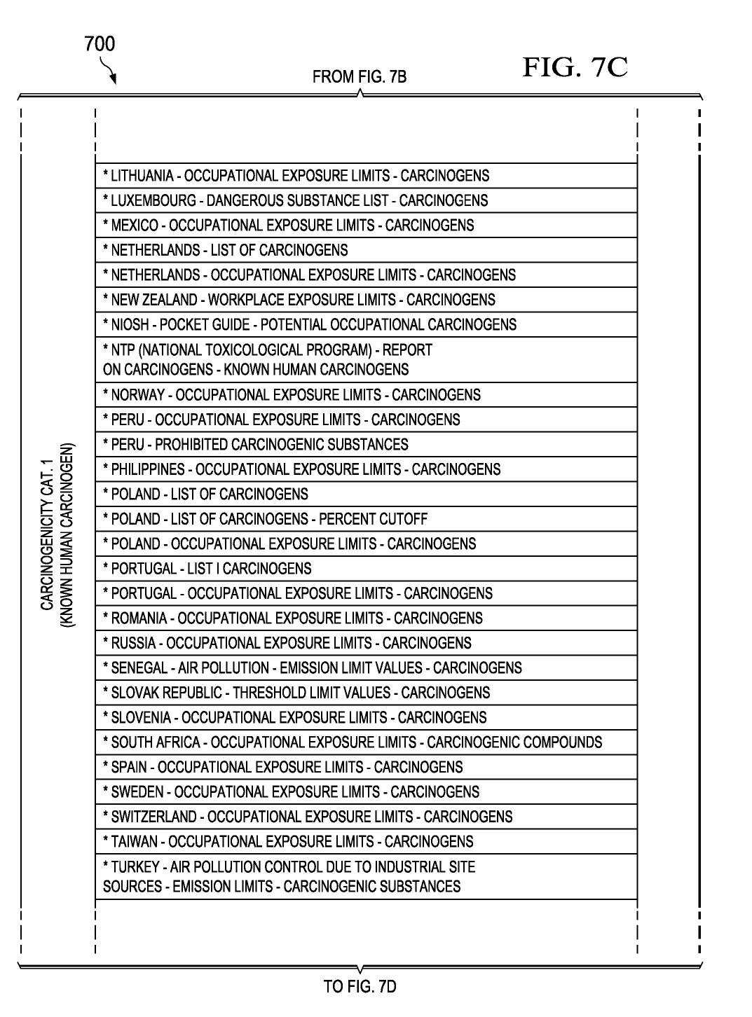

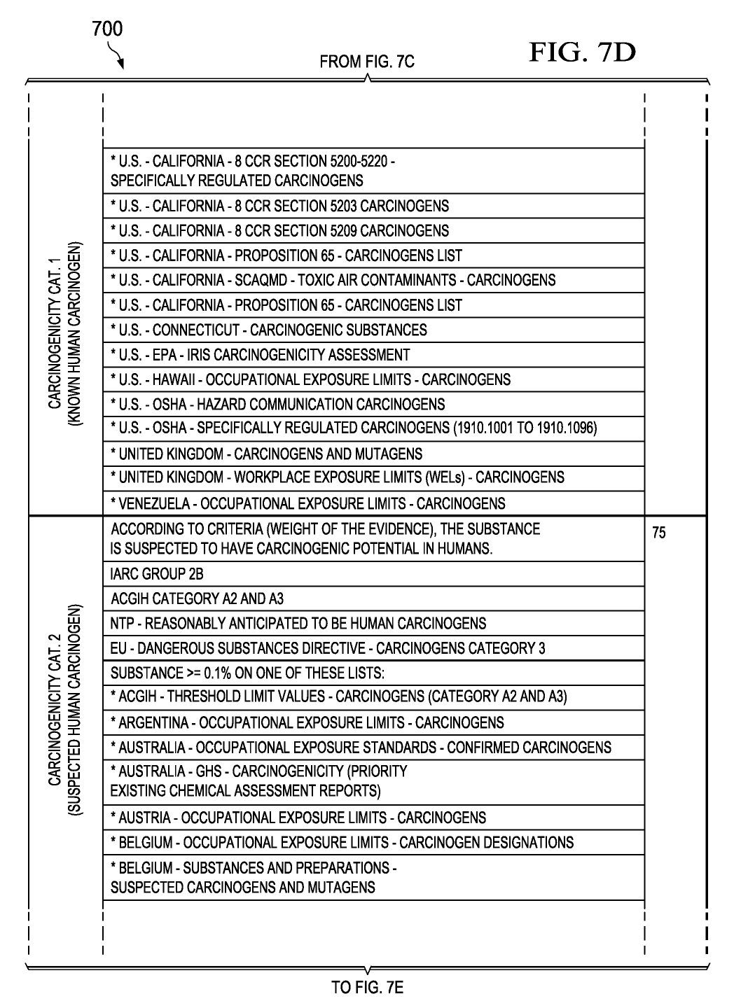

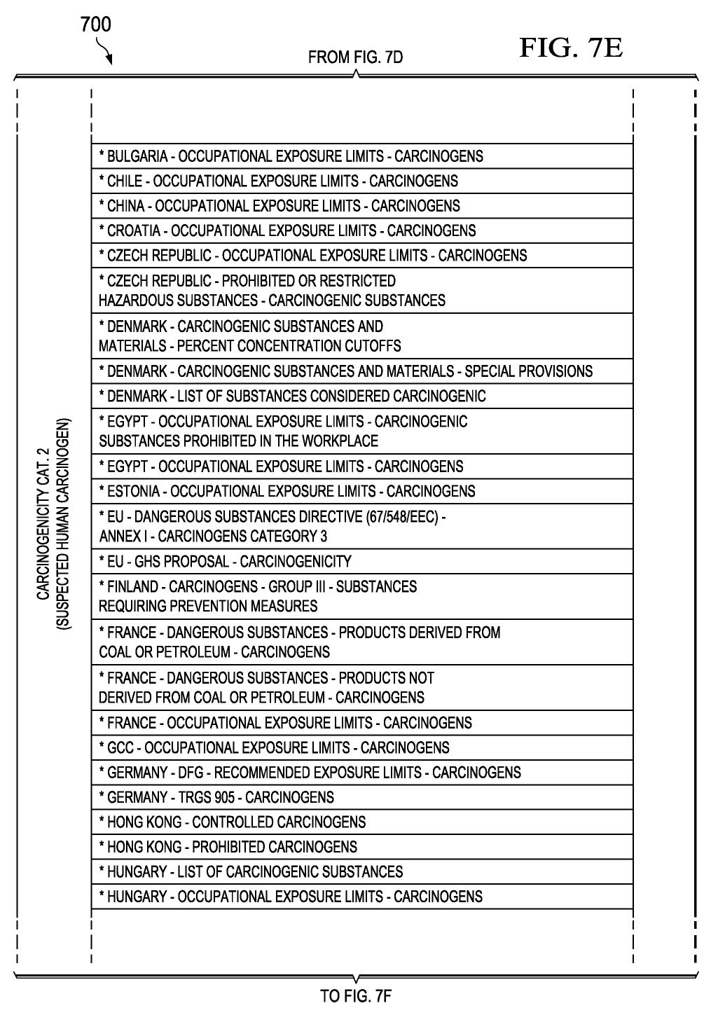

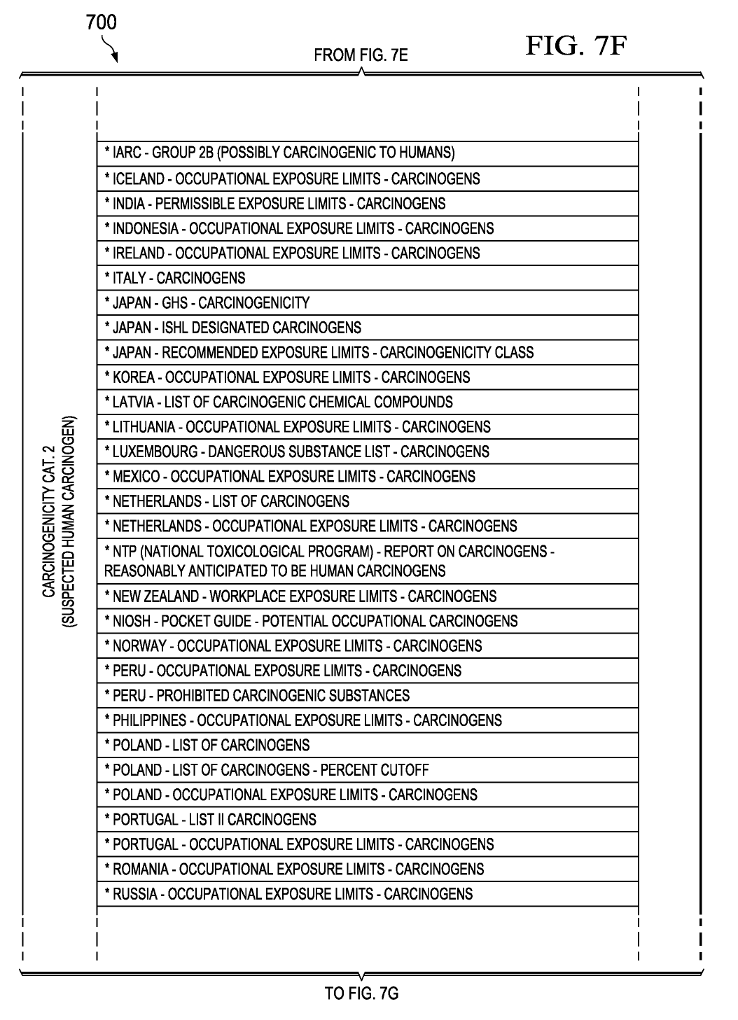

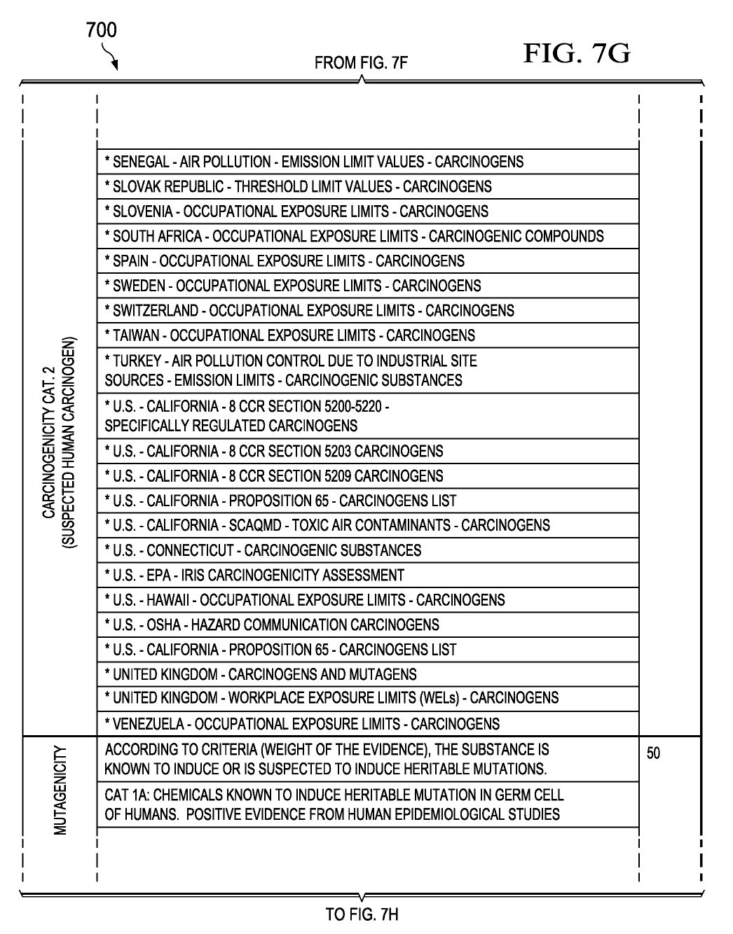

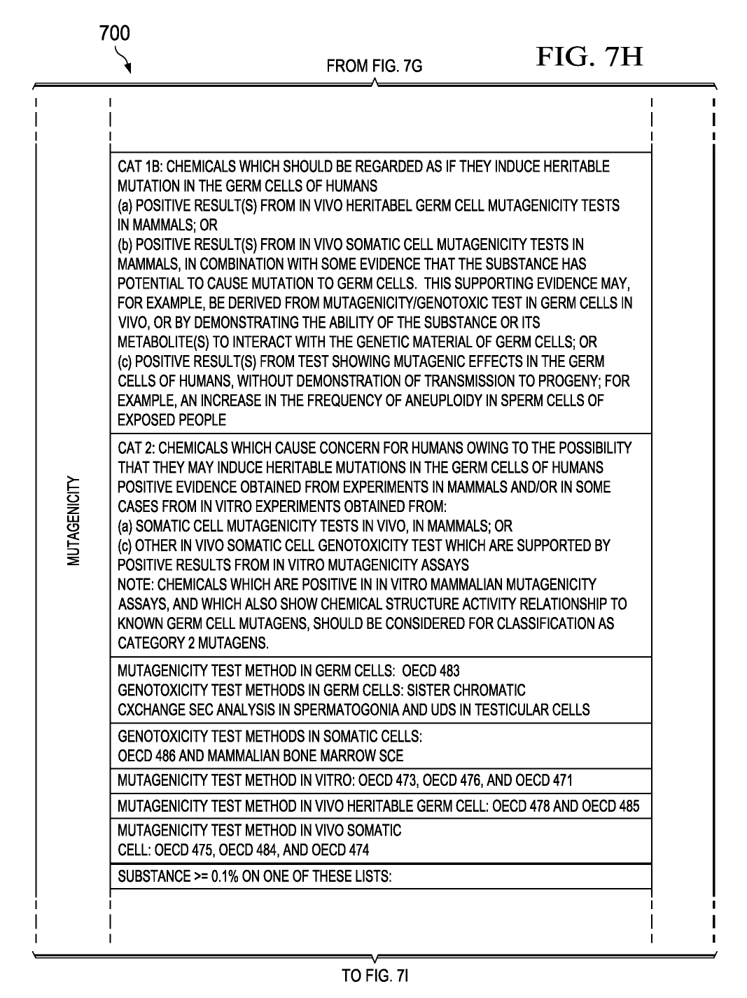

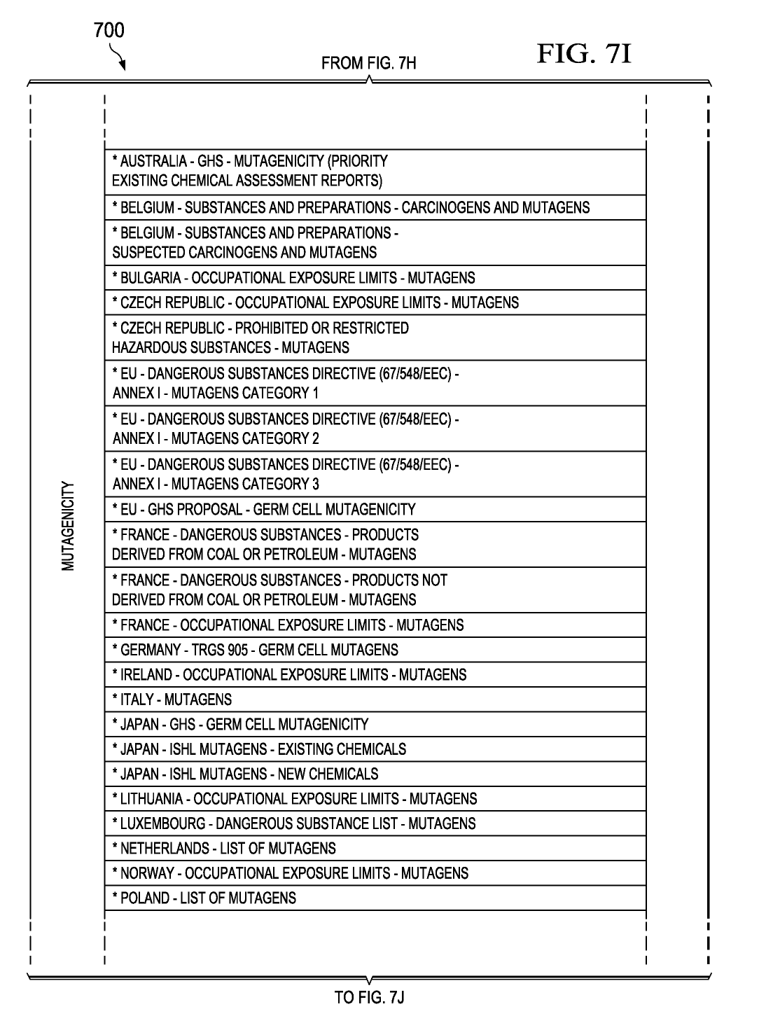

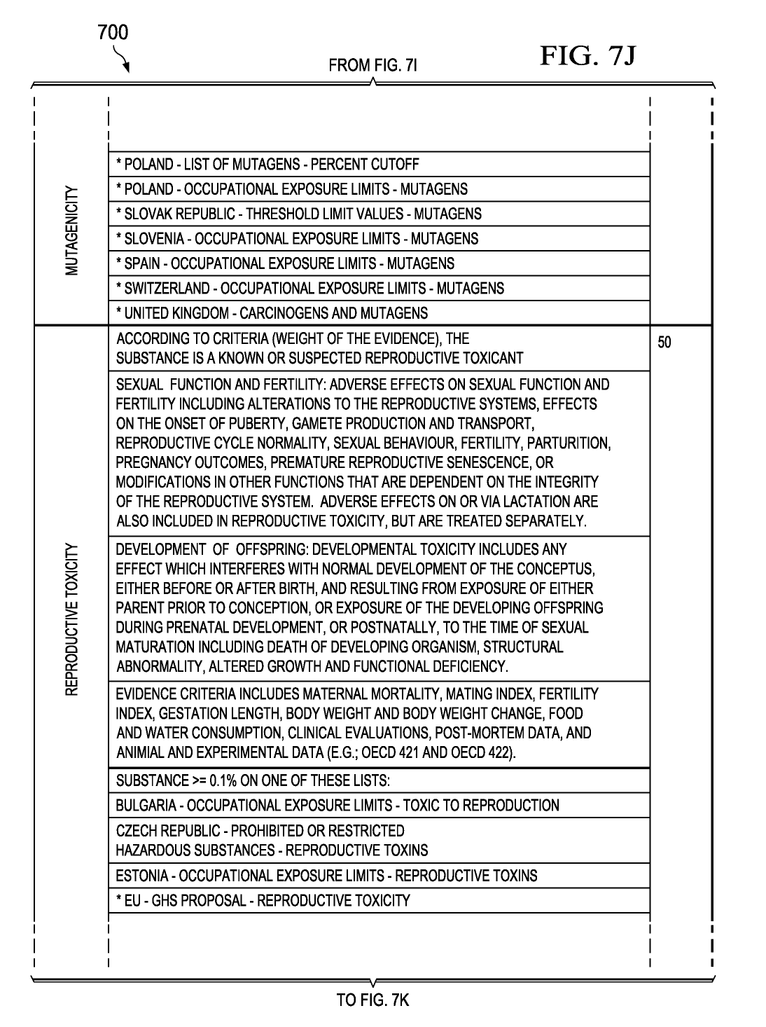

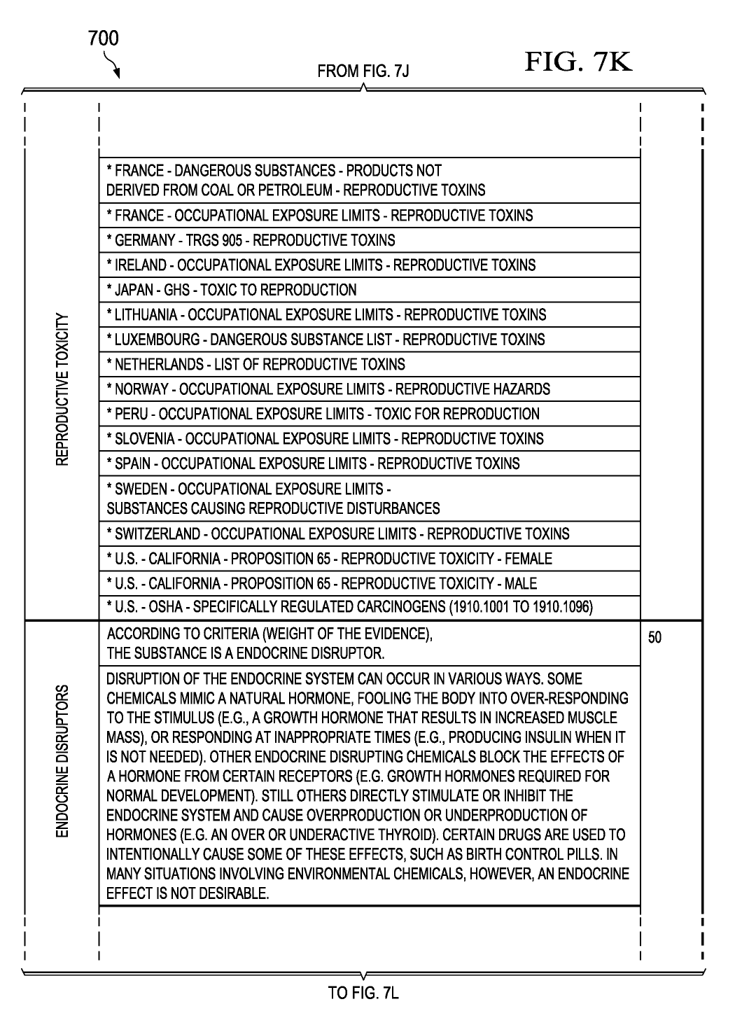

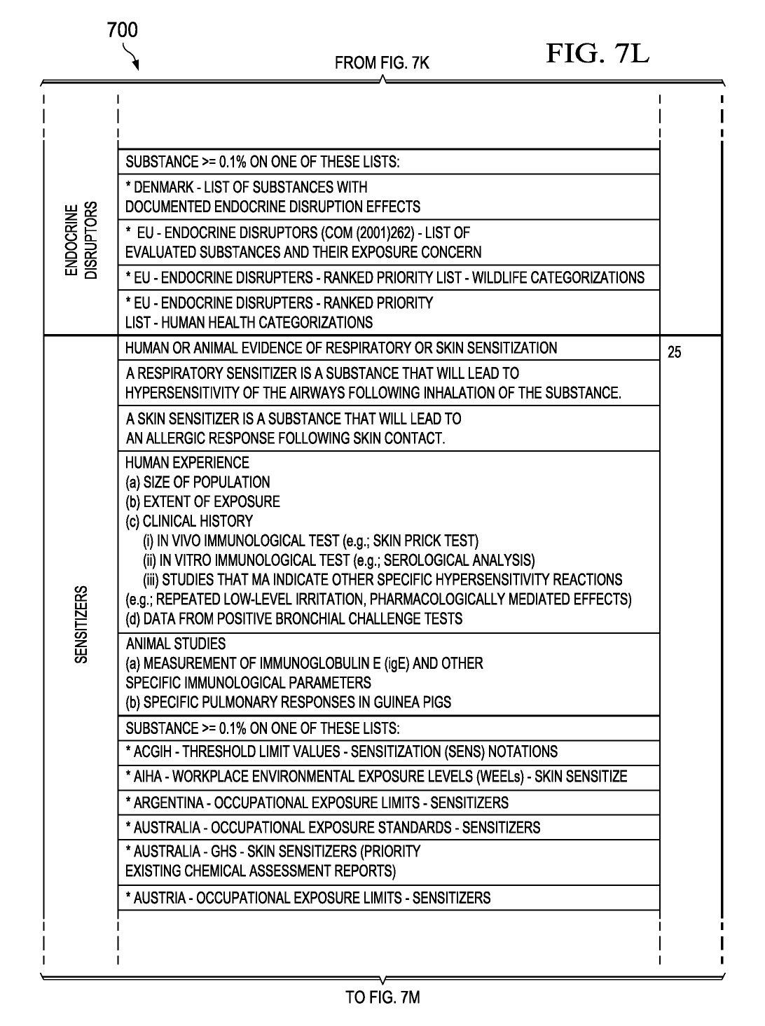

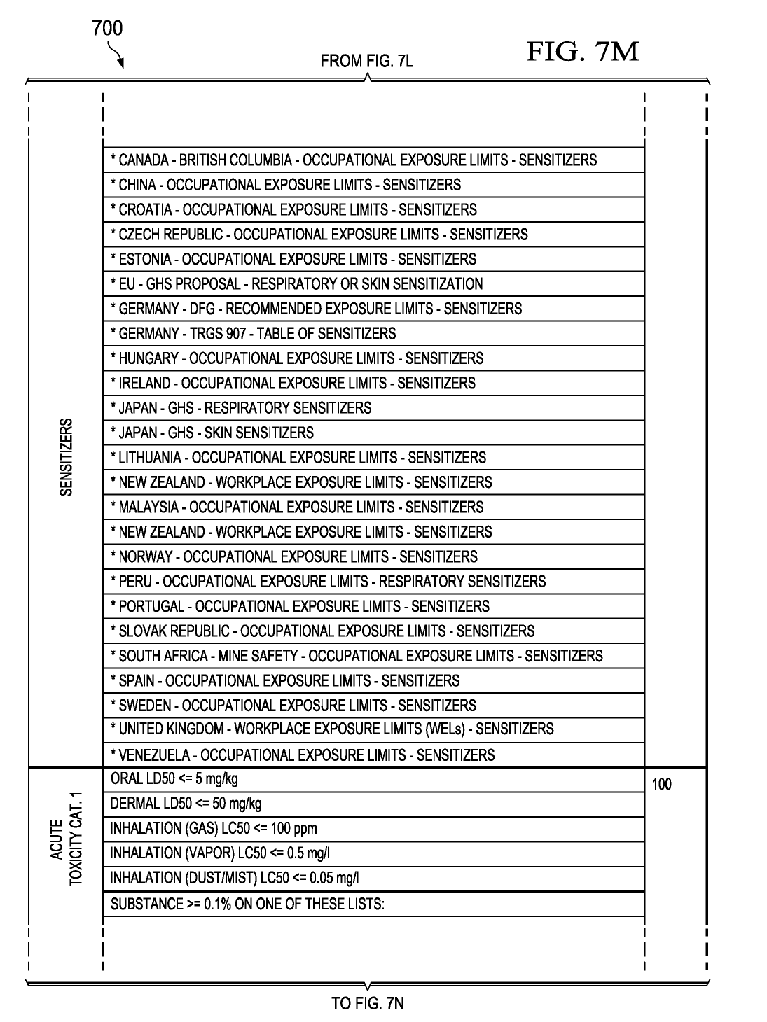

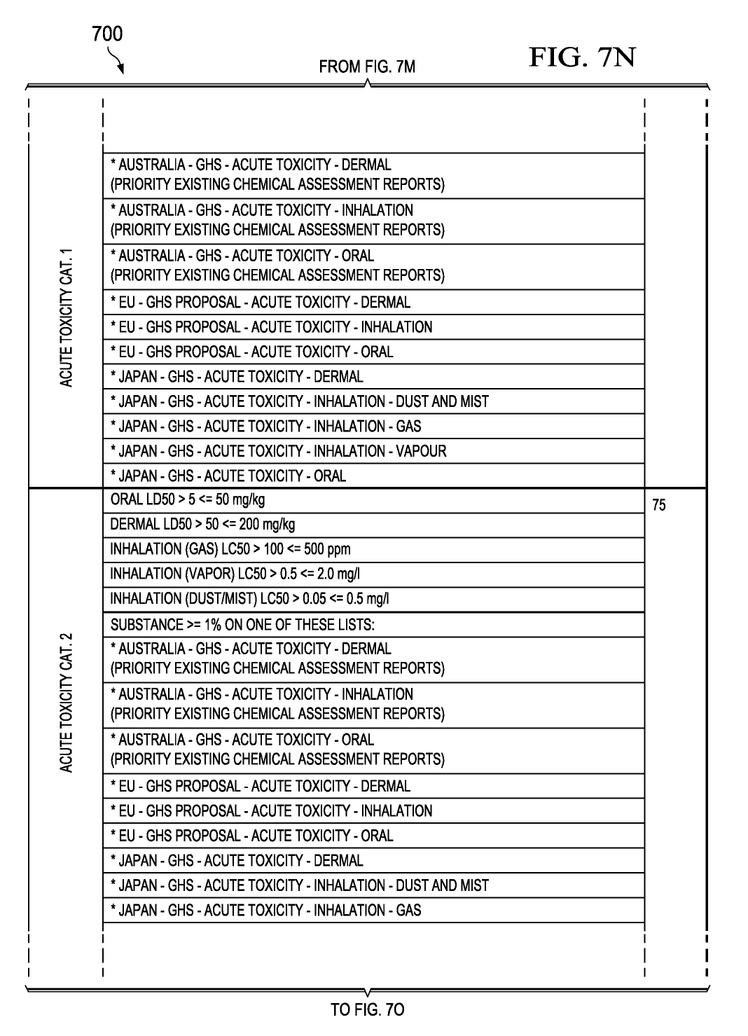

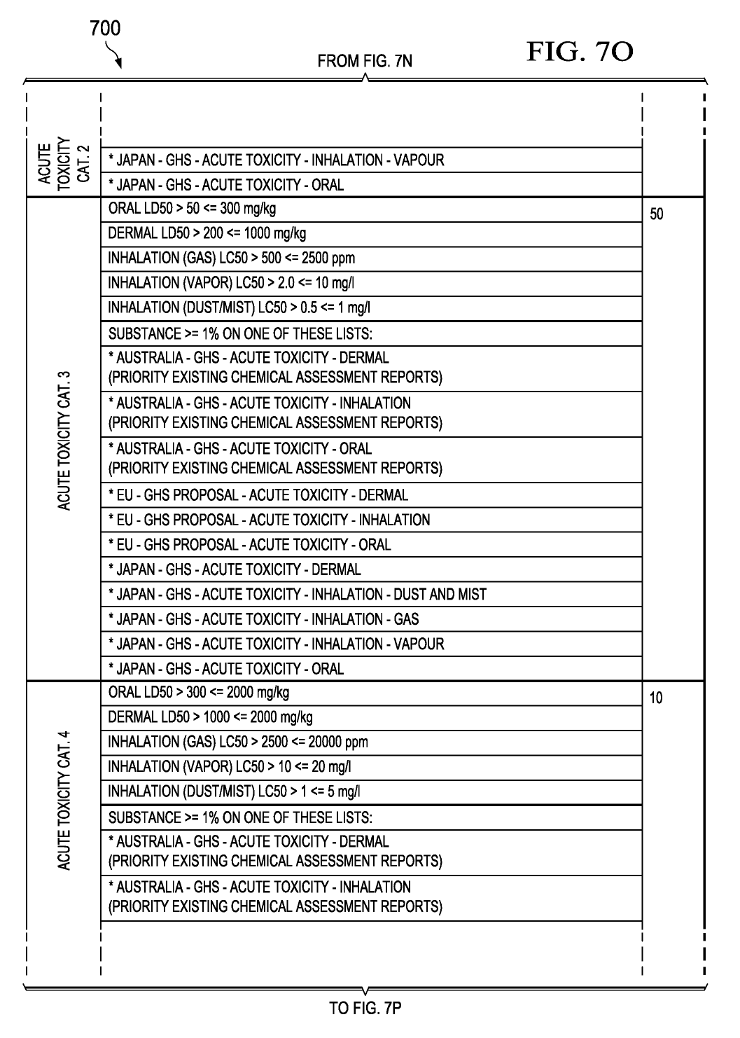

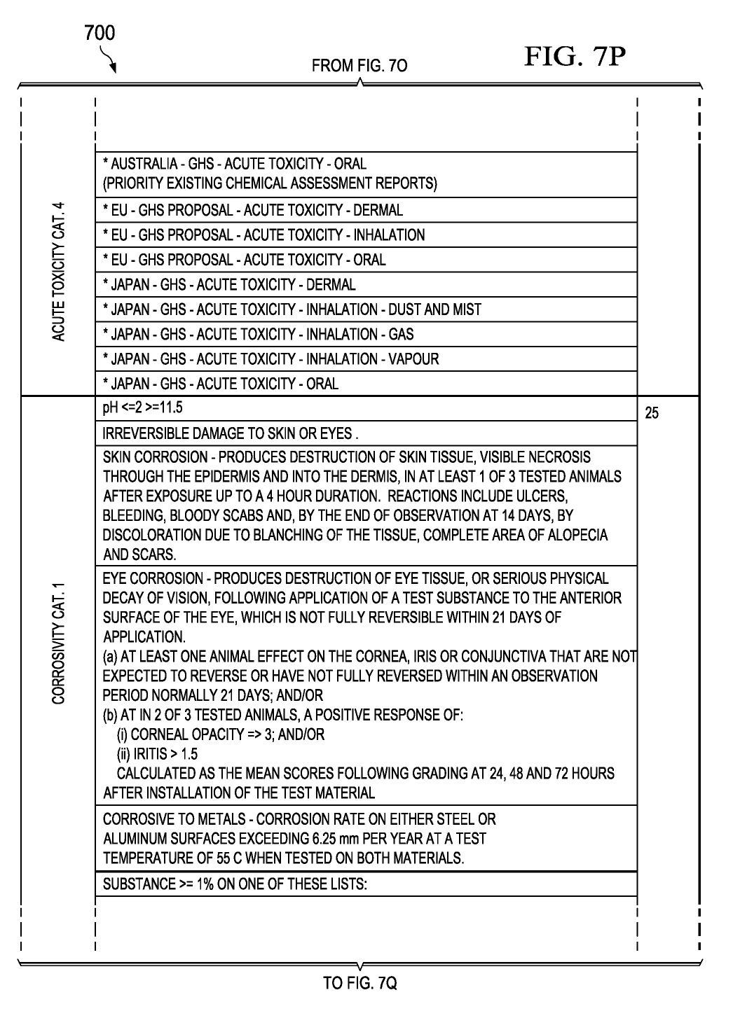

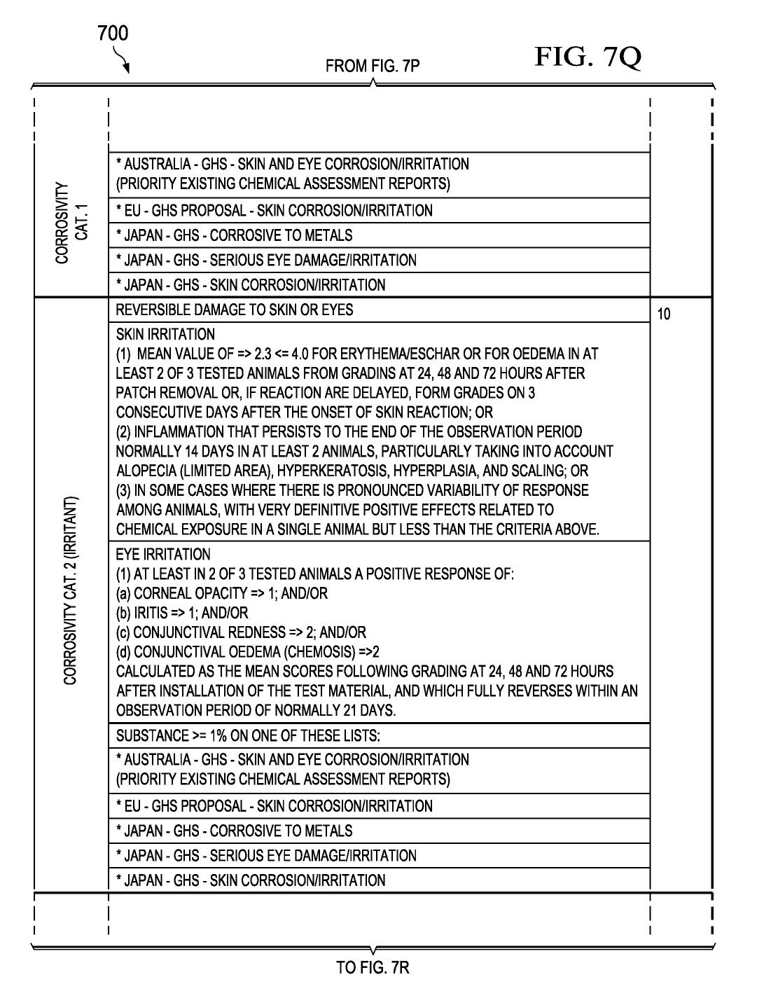

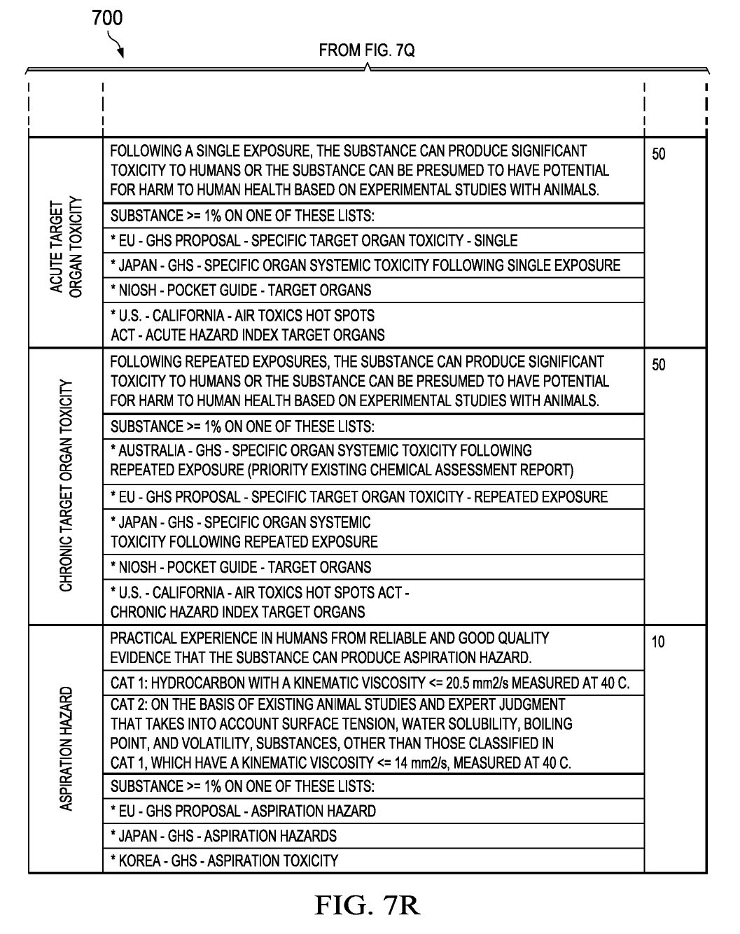

In a particular embodiment, the environment health hazards category 224 may comprise the environmental health criteria 702 and associated definitions 704 illustrated by the environmental health chart 700 of FIG. 7. An environmental health criteria 702 may be met if the definition 704 associated with the criteria 702 is met. As also shown in FIG. 7, a weight 706 of the environmental health criterion 702 may also be provided in the chart 700. The weight 706 is a maximum impact of the criteria on environmental health.

Referring back to FIG. 2, the criteria scores module 204 includes scores for each criteria in a hazards category. For example, criteria scores module 204 may include environmental criteria scores 230, physical criteria scores 232 and environmental health criteria scores 234. The scores may be defined across a percentage range of a component in a product or otherwise. For example, a single score may be assessed if a product includes any amount of a component meeting the criteria. If a range is used, the score across the range may be reduced from the maximum weight as a function of how dilution reduces the hazard. This may be determined based on professional judgment, empirically or extrapolated, for example using algorithms or curves correlating weight or the weighting metric to impact from available data.

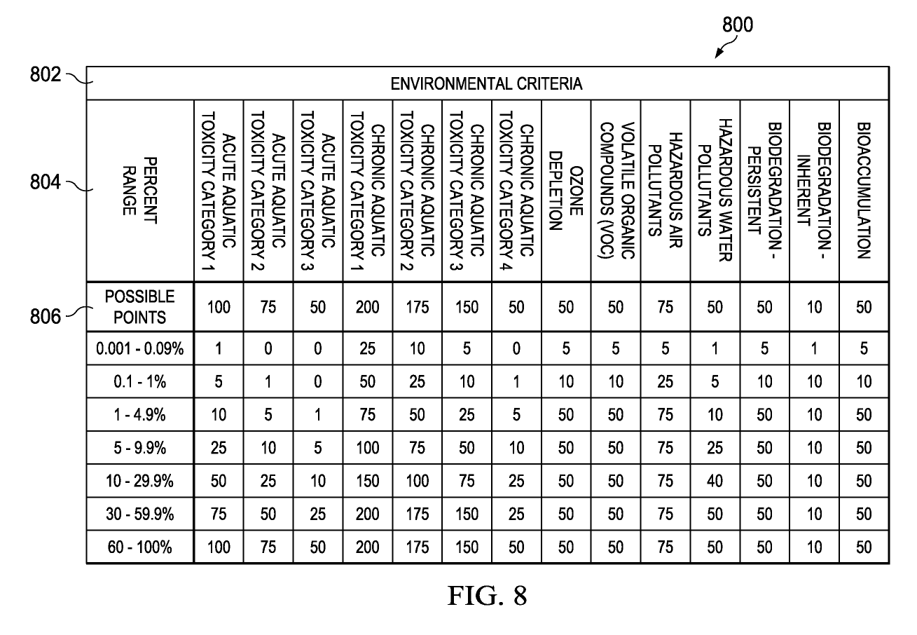

An exemplary environmental criteria score chart 800 comprising environmental criteria scores 230 is illustrated in FIG. 8. The chart 800 includes environmental criteria 802, a percentage range 804, and weight 806, or maximum possible points or score for criteria 802. The percentage range may comprise the percentage of the component by weight or may be otherwise suitable based. For example, could be based on weight by volume. In other embodiments, may be otherwise weighted. For example, may be weighted based on amount of product or component needed and/or used for a project in combination with, or not, percentage range of components. The range 804 may be continuous, substantially continuous and/or subdivided into several discreet sub-ranges. For example, the range 804 may be sub-divided into a 0.001-0.09 percent range, a 0.1-0.9 percent range, a 1-4.9 percent range, a 5-9.9 percent range, a 10-29.9 percent range, a 30-59.9 percent range, and 60-100 percent range. For each sub-range within the percentage range 804, a score is provided based on impact of the criteria at the associated percentage range. Thus, the score or impact may increase as the percentage of a component falling within the criteria increases in a product. In other embodiments, a higher score may denote a lower hazard. For example, the calculated scores may be subtracted from an optimum or other score(s) or number(s) to arrive at the indicated scores.

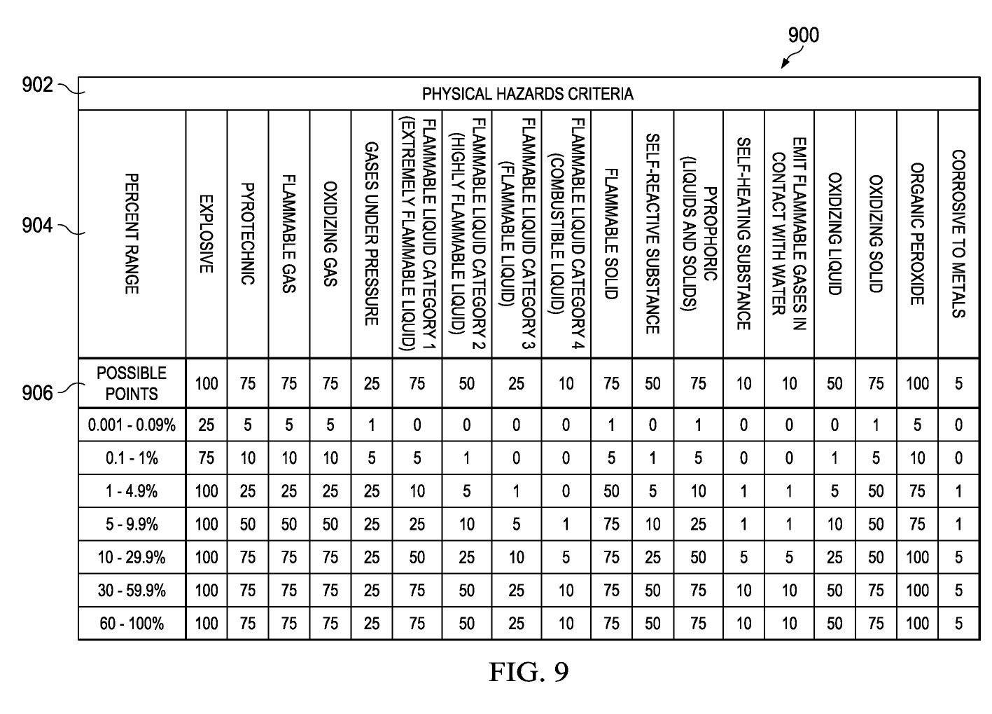

An exemplary physical criteria score chart 900 comprising physical criteria scores 232 is illustrated in FIG. 9. The chart 900 includes physical criteria 902, a percentage range 904, and weight 906, or maximum possible points or score for criteria 902. As above, the percentage range may comprise the percentage of the component by weight or volume or may be otherwise suitably determined. In the illustrated embodiment, the range 904 may be sub-divided into a 0.001-0.09 percent range, a 0.1-0.9 percent range, a 1-4.9 percent range, a 5-9.9 percent range, a 10-29.9 percent range, a 30-59.9 percent range, and 60-100 percent range. For each sub-range within the percentage range 904, a score is provided based on impact of the criteria at the associated percentage range.

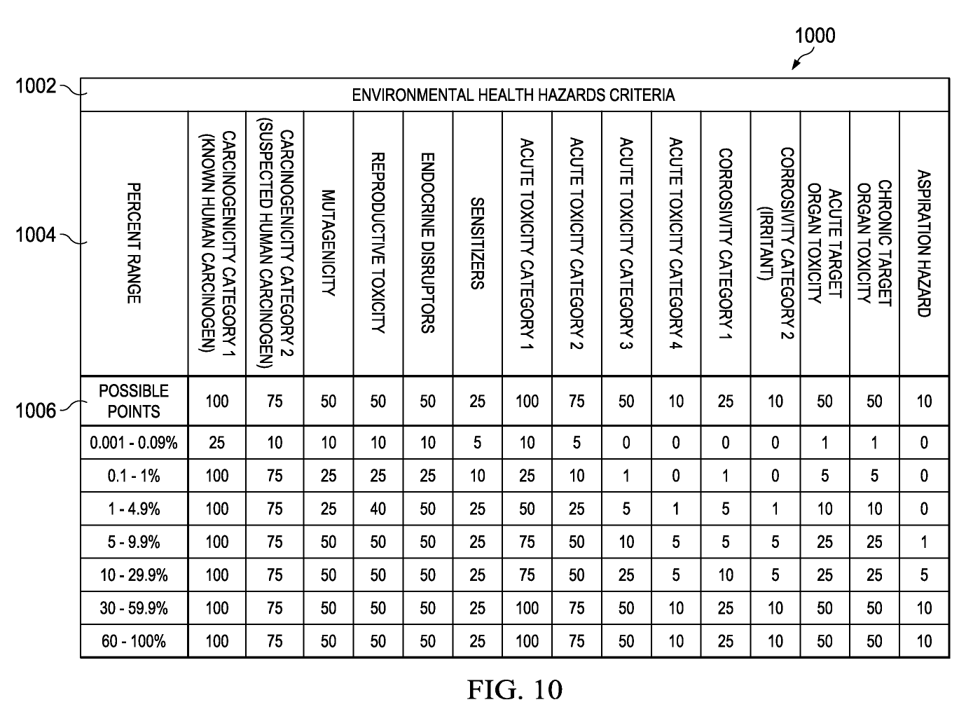

An exemplary environmental health criteria chart 1000 comprising environmental health criteria scores 234 is illustrated in FIG. 10. The chart 1000 includes environmental health criteria 1002, a percentage range 1004, and weight 1006, or maximum possible points or score for criteria 1002. As above, the percentage range may comprise the percentage of the component by weight or volume or may be otherwise suitably determined. In the illustrated embodiment, the range 1004 may be sub-divided into a 0.001-0.09 percent range, a 0.1-0.9 percent range, a 1-4.9 percent range, a 5-9.9 percent range, a 10-29.9 percent range, a 30-59.9 percent range, and 60-100 percent range. For each sub-range within the percentage range 1004, a score is provided based on impact of the criteria at the associated percentage range.

Referring back to FIG. 2, products module 206 comprises a plurality of products 240. For each product 240 a list of components, criteria met by the components and associated score 241 is stored. The criteria met by the components may be determined from the criteria and definitions of the hazard categories 220, 222 and 224. The scores may be determined from the criteria scores 230, 232 and 234 of the criteria score module 204. The score for any hazard is, in the illustrated embodiment, weighted based on the percent of the component in the product as the scores stored in the scores module 204 are based on percentage range.

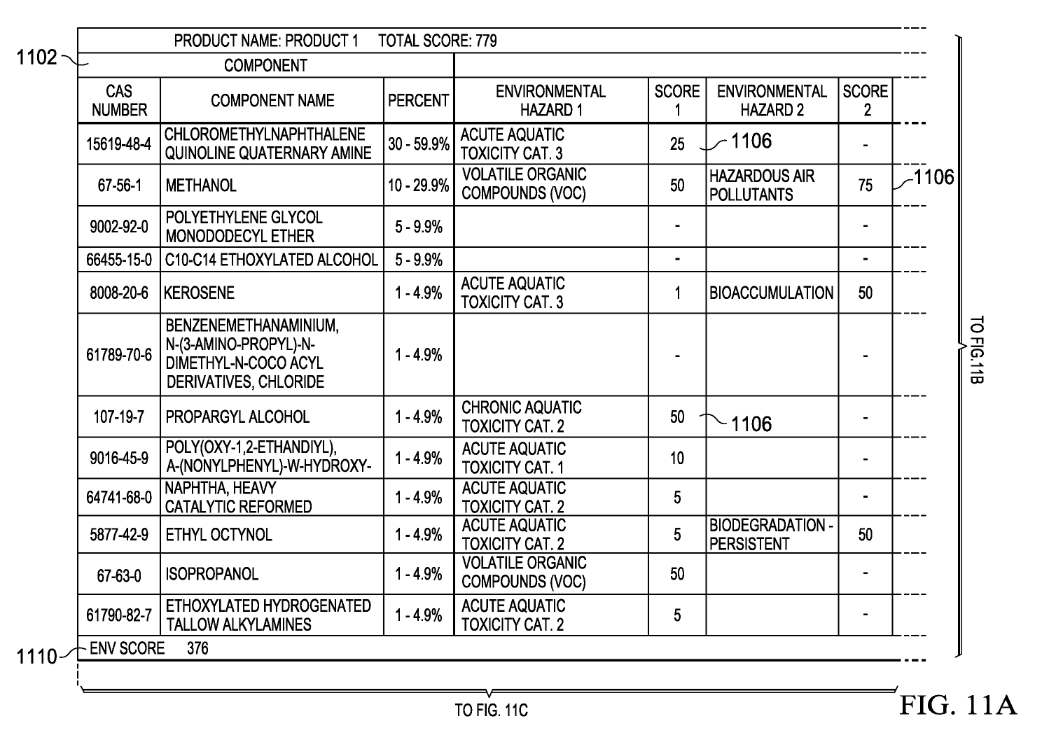

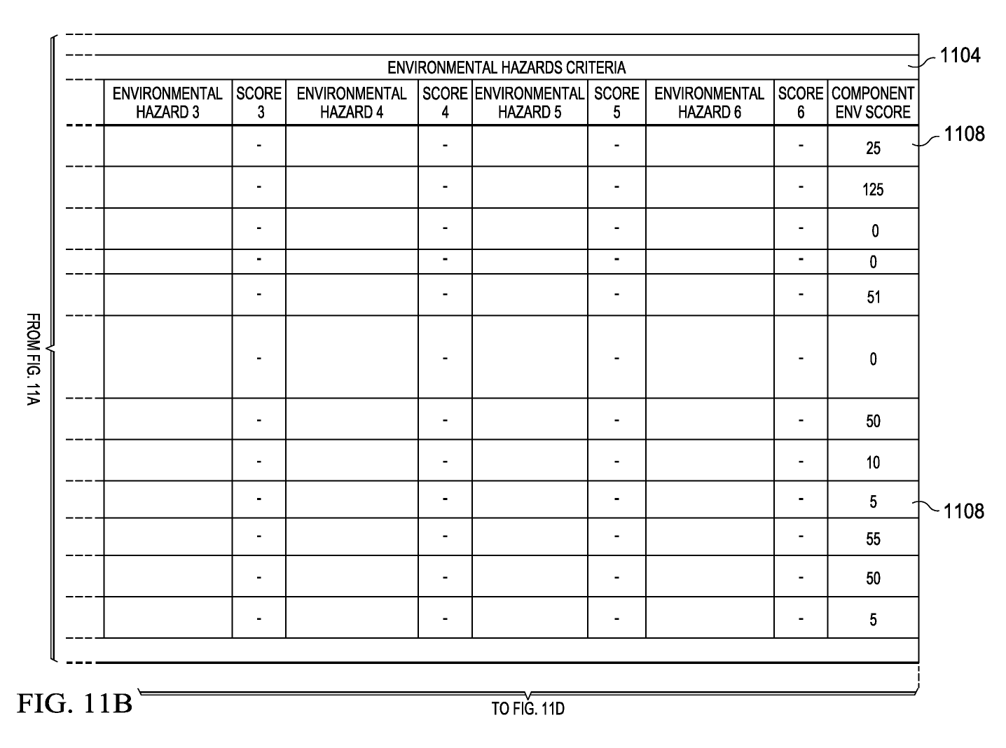

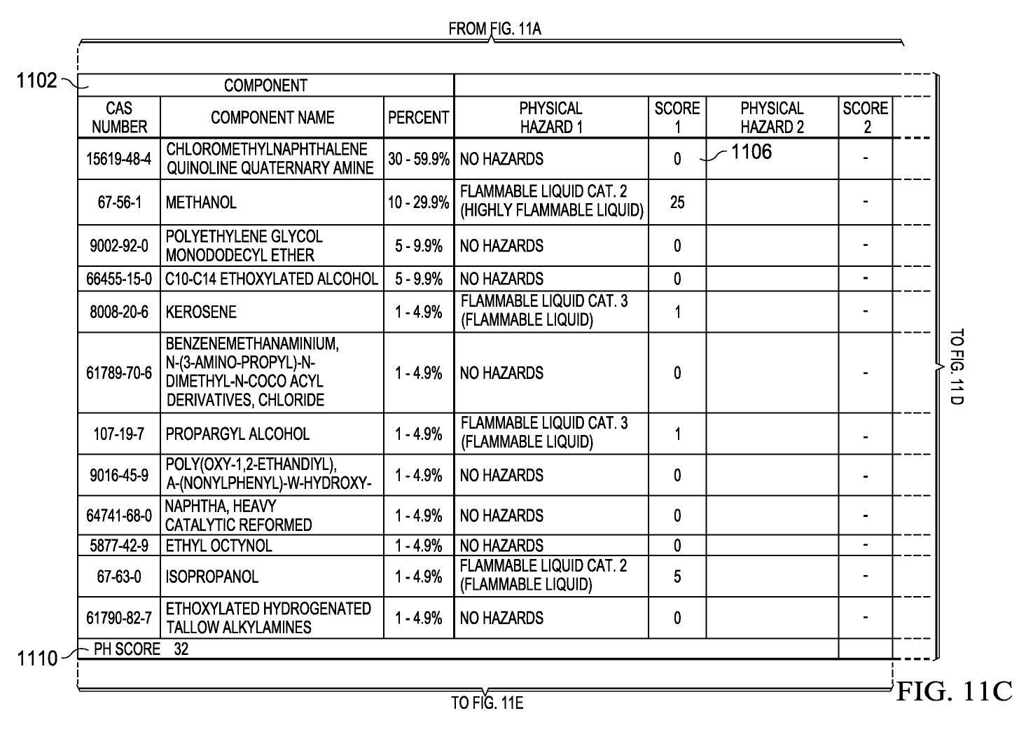

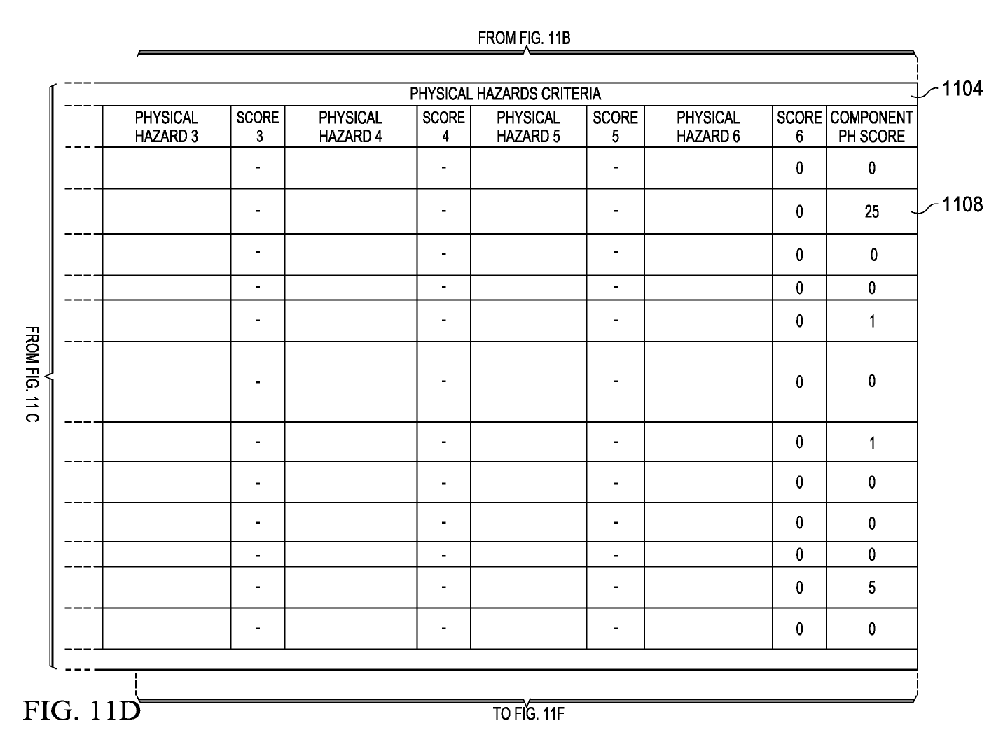

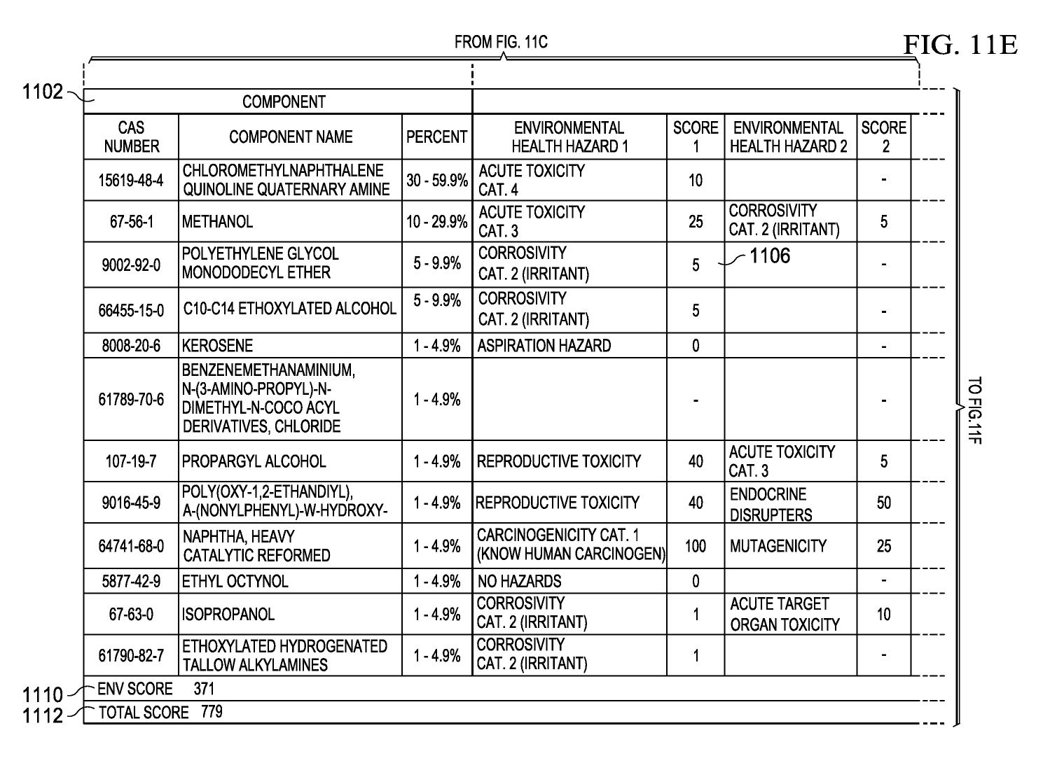

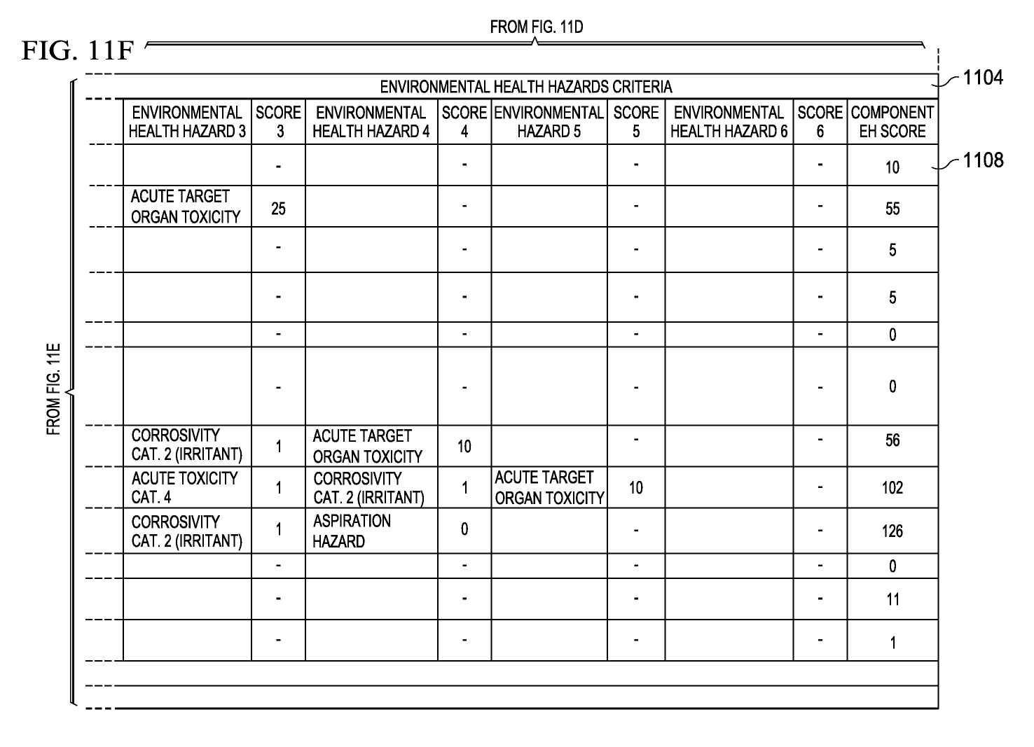

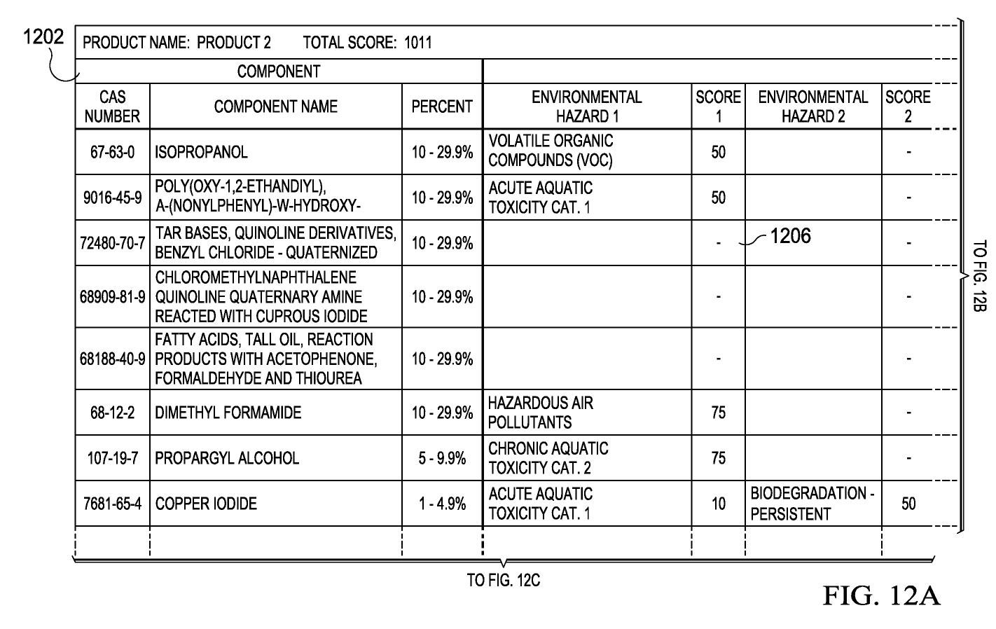

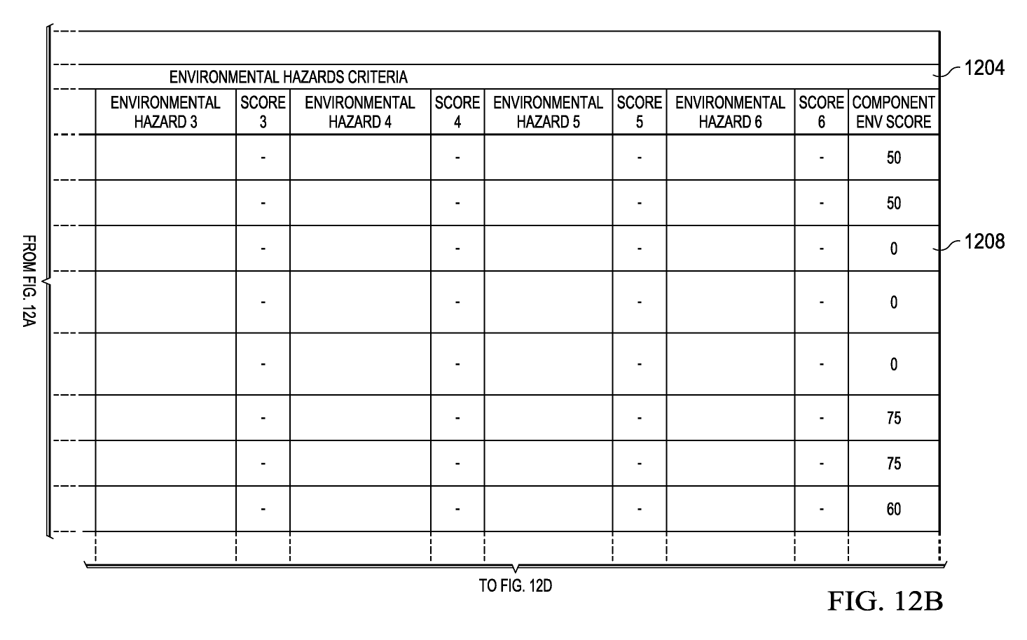

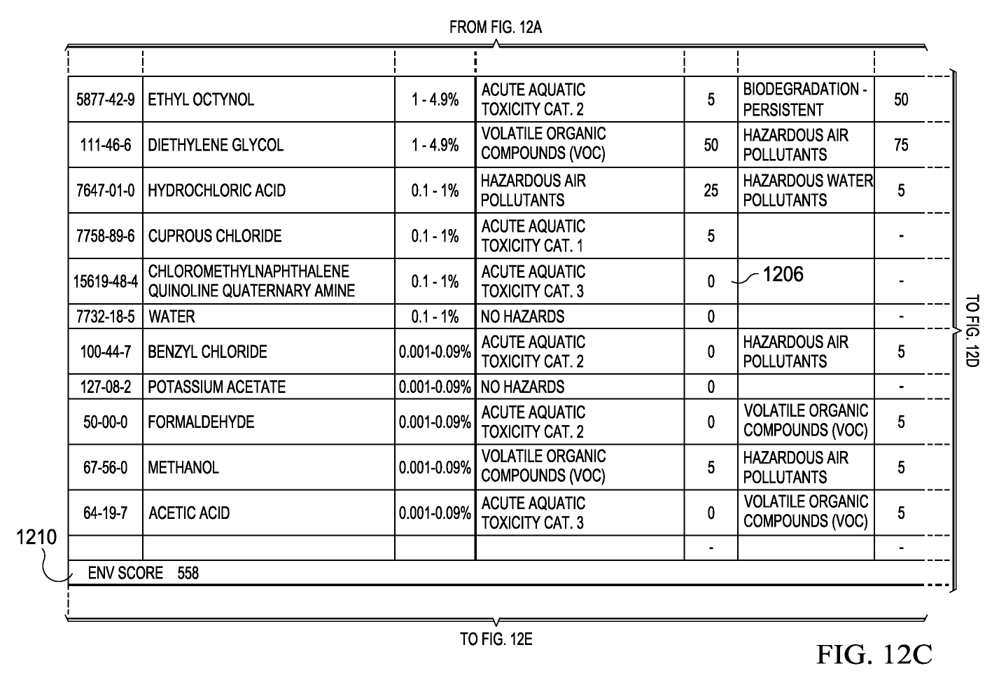

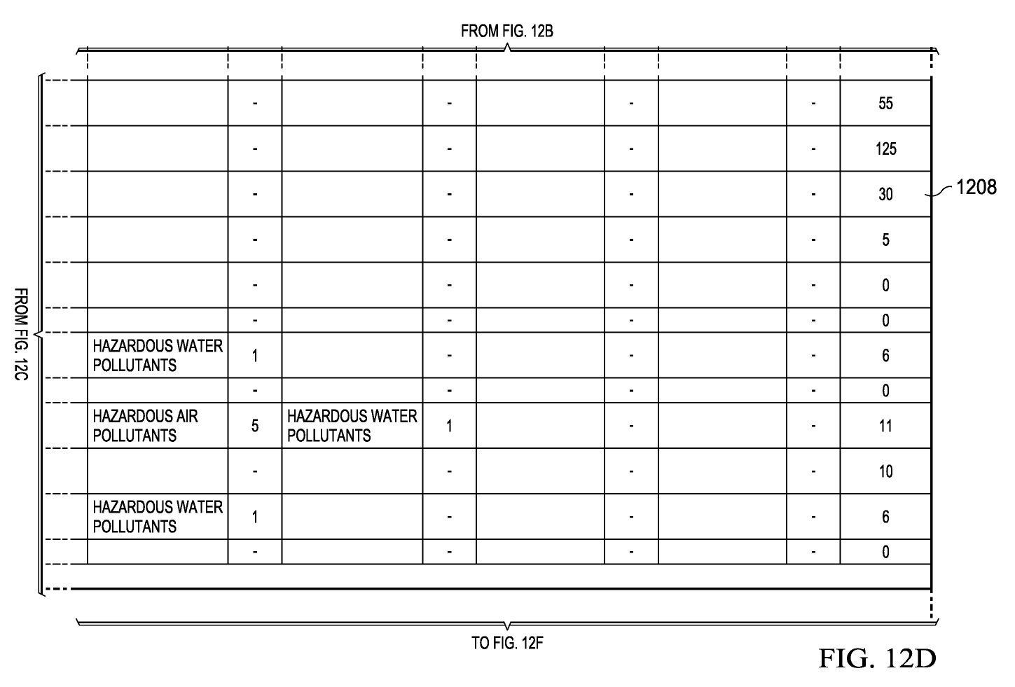

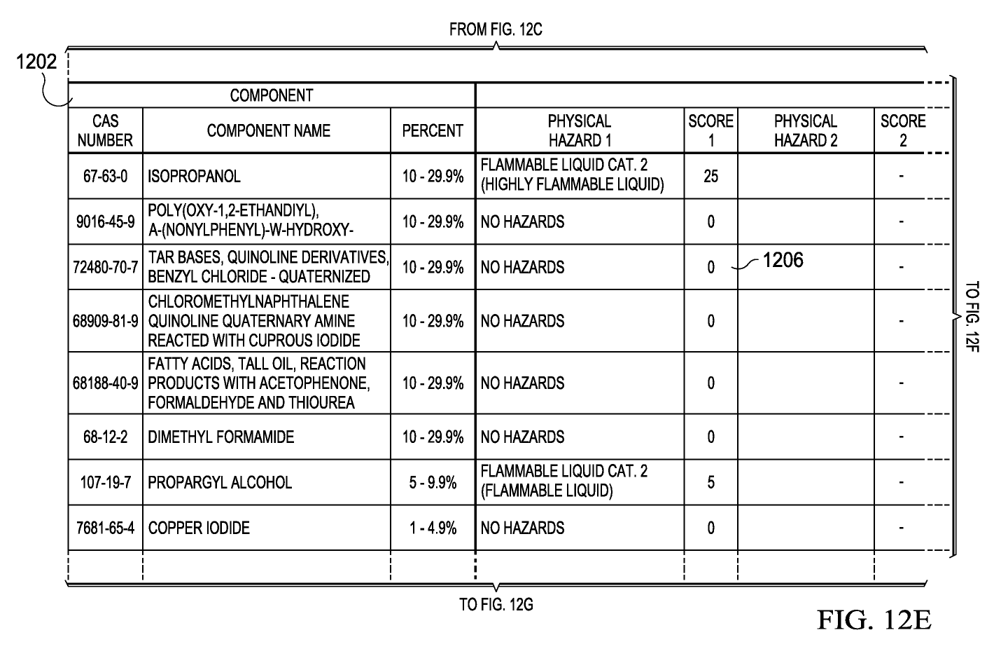

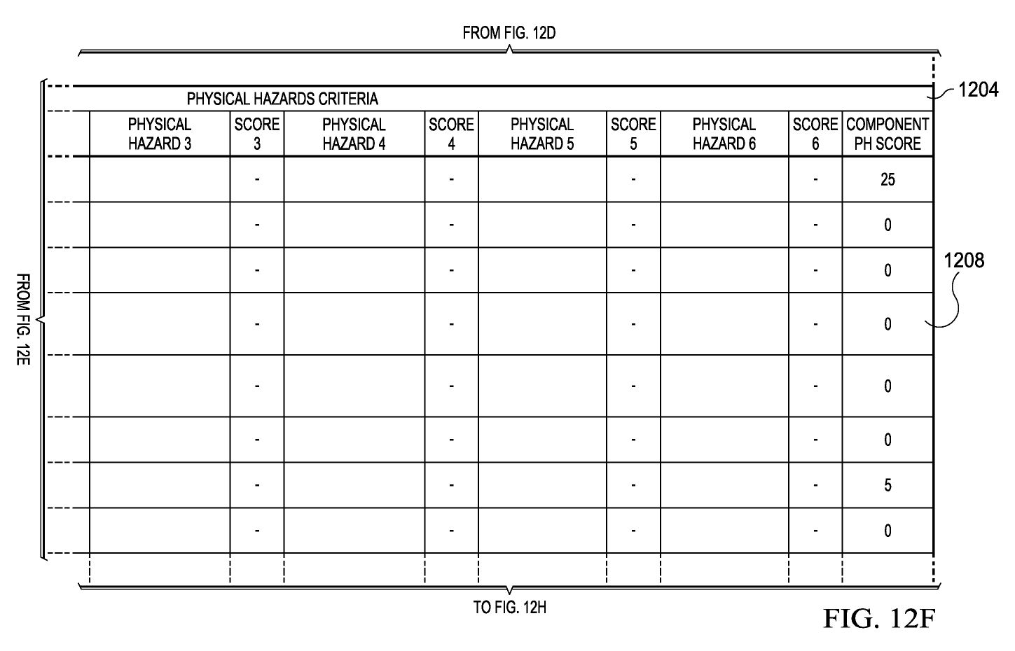

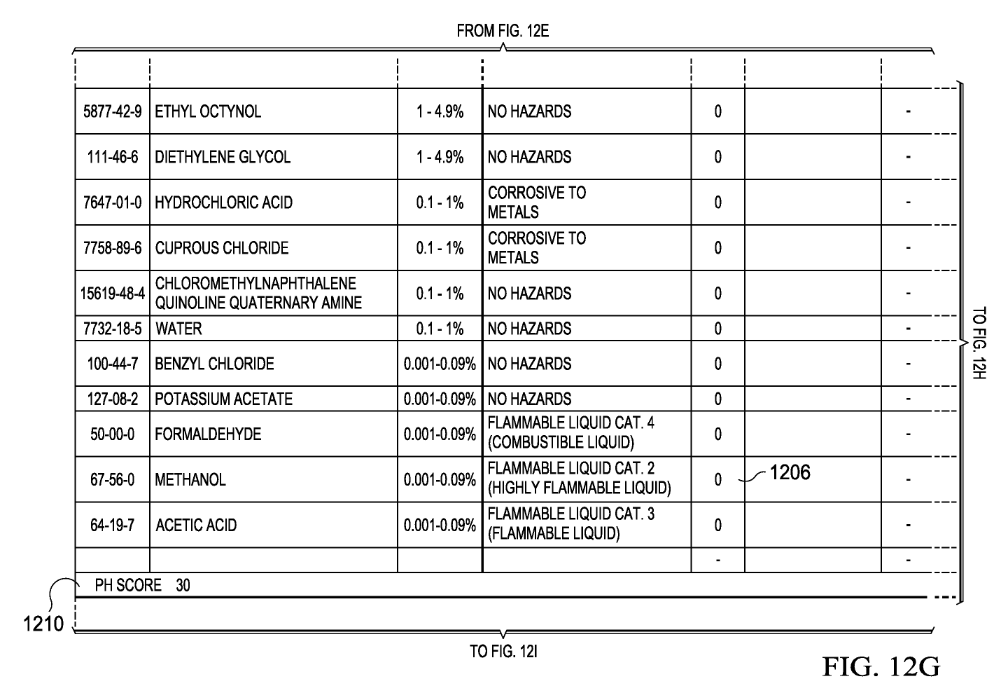

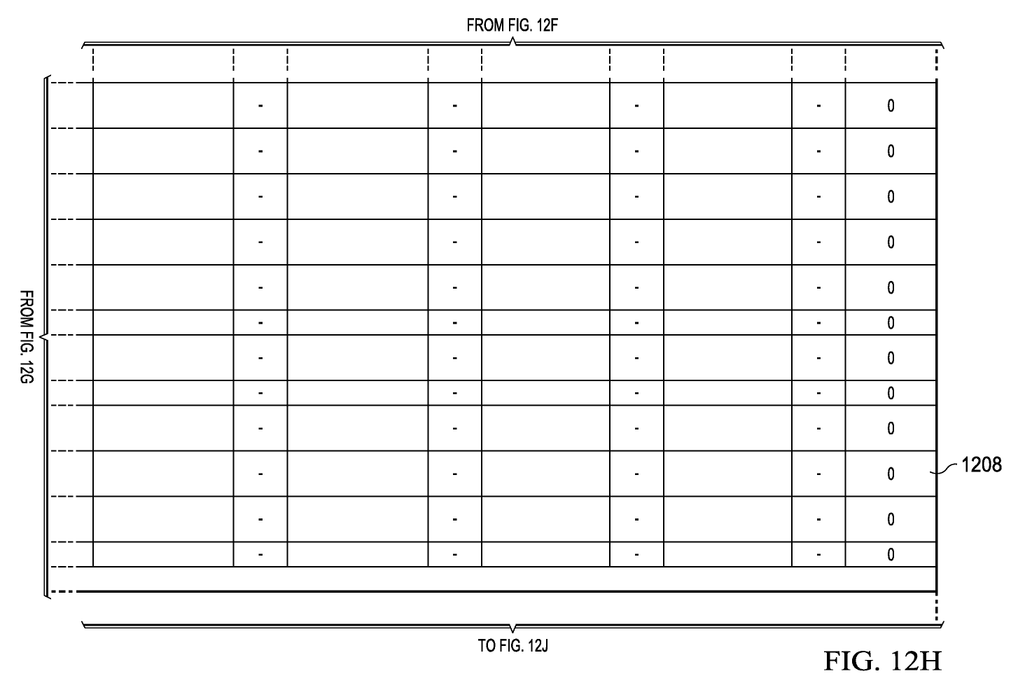

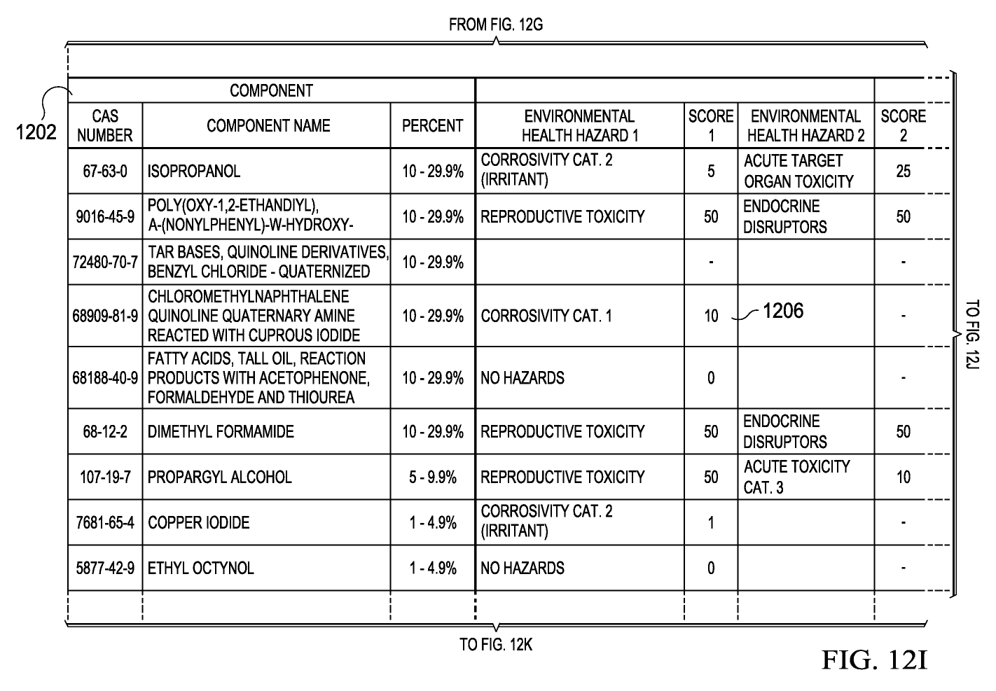

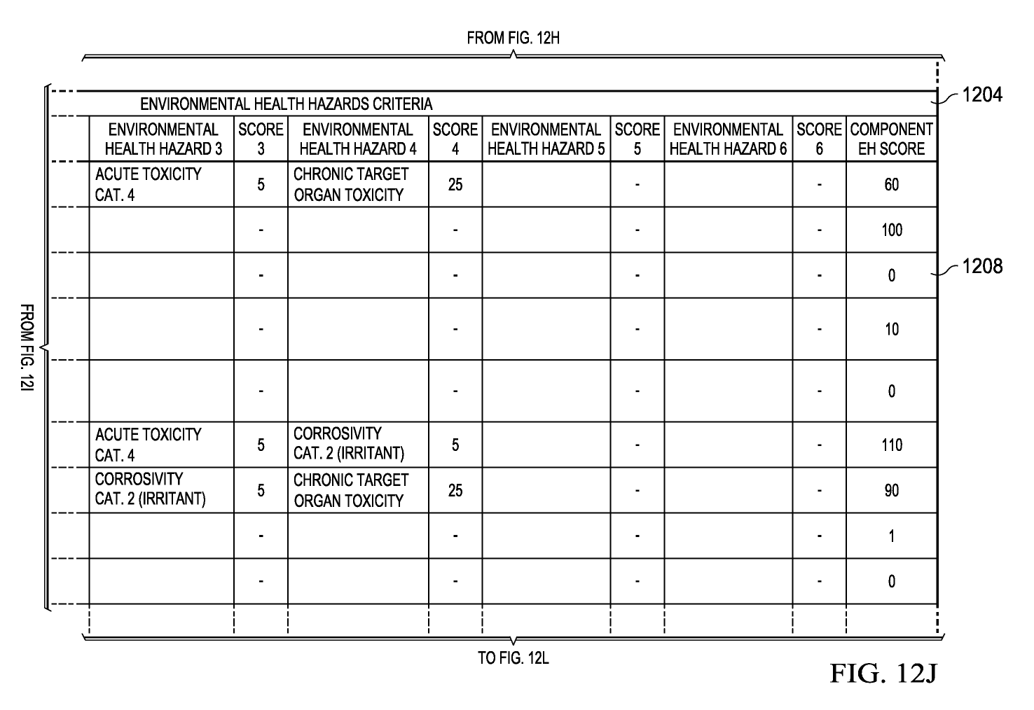

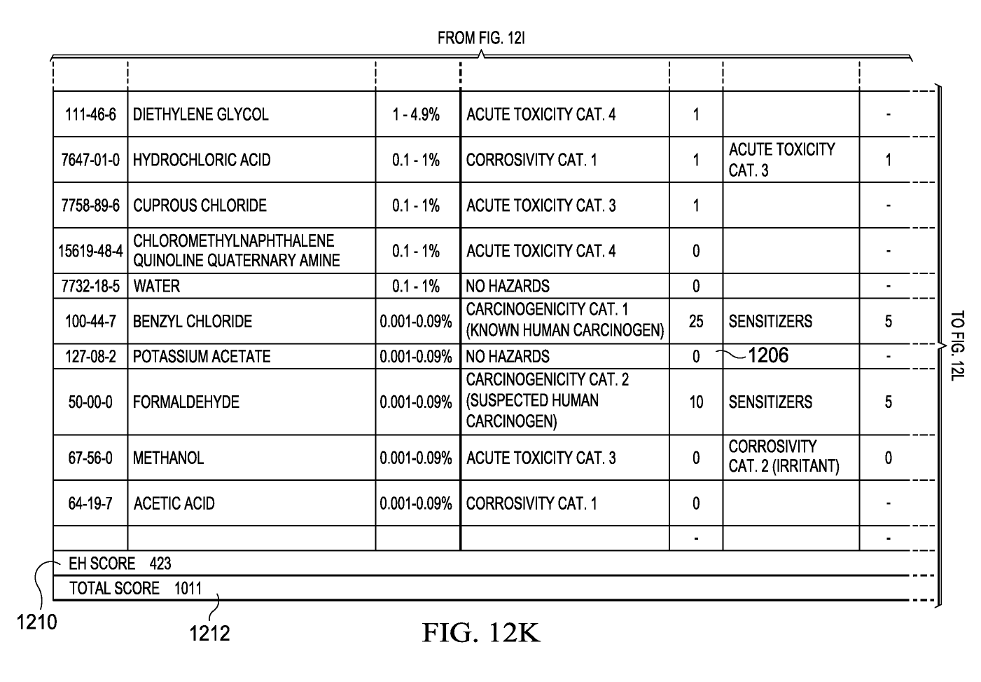

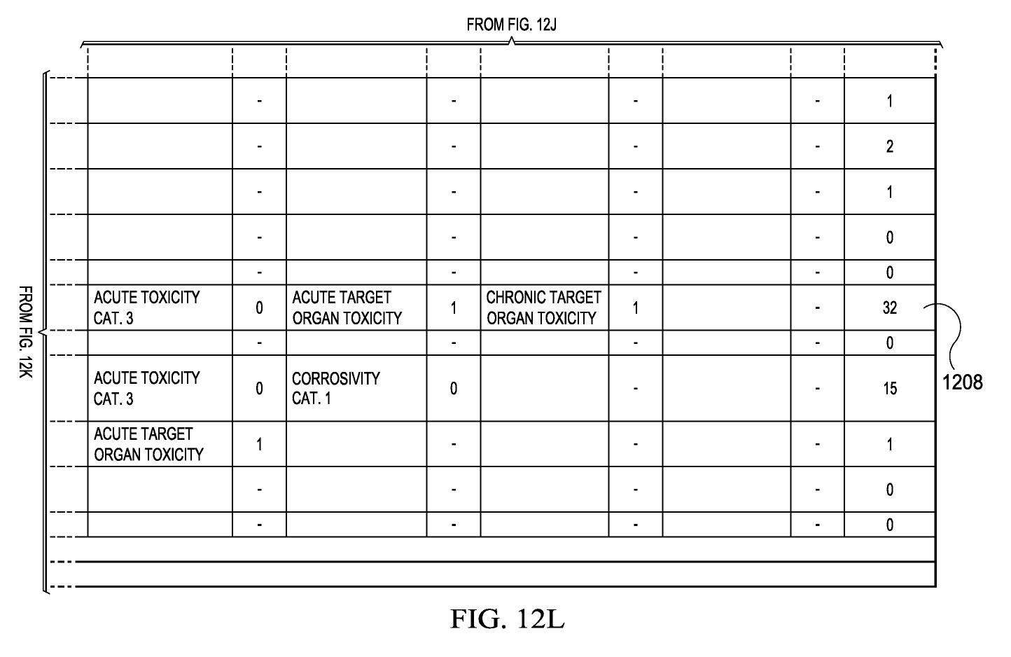

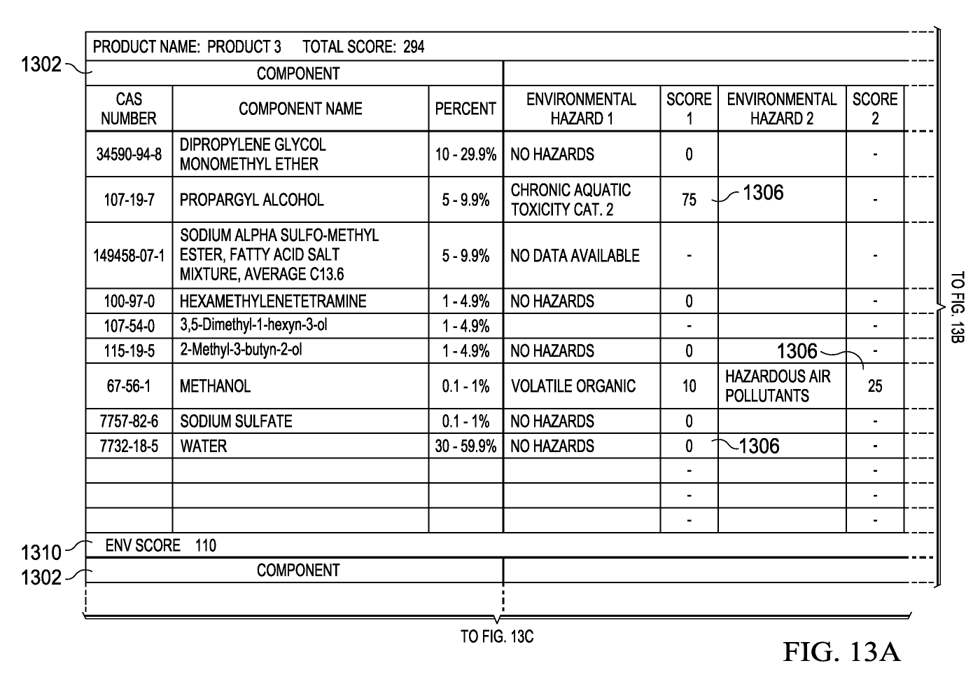

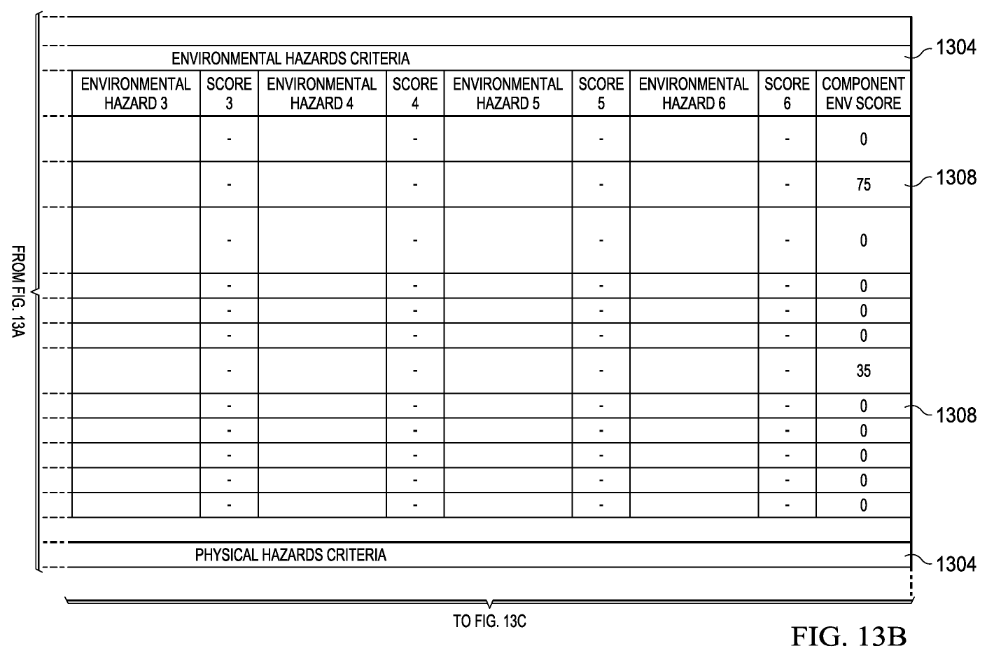

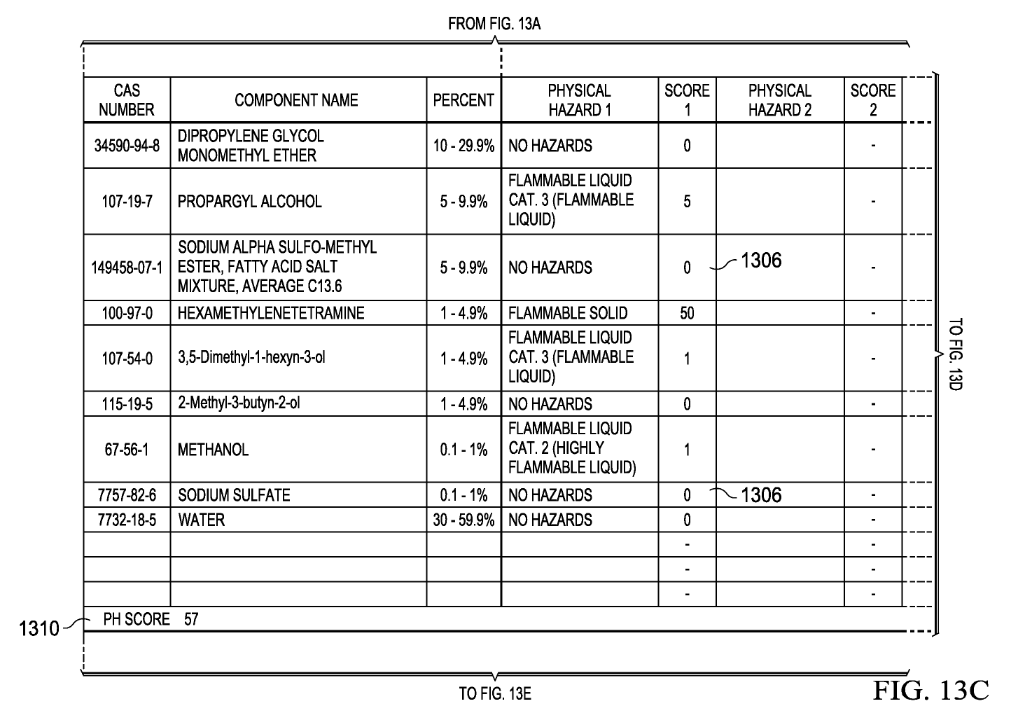

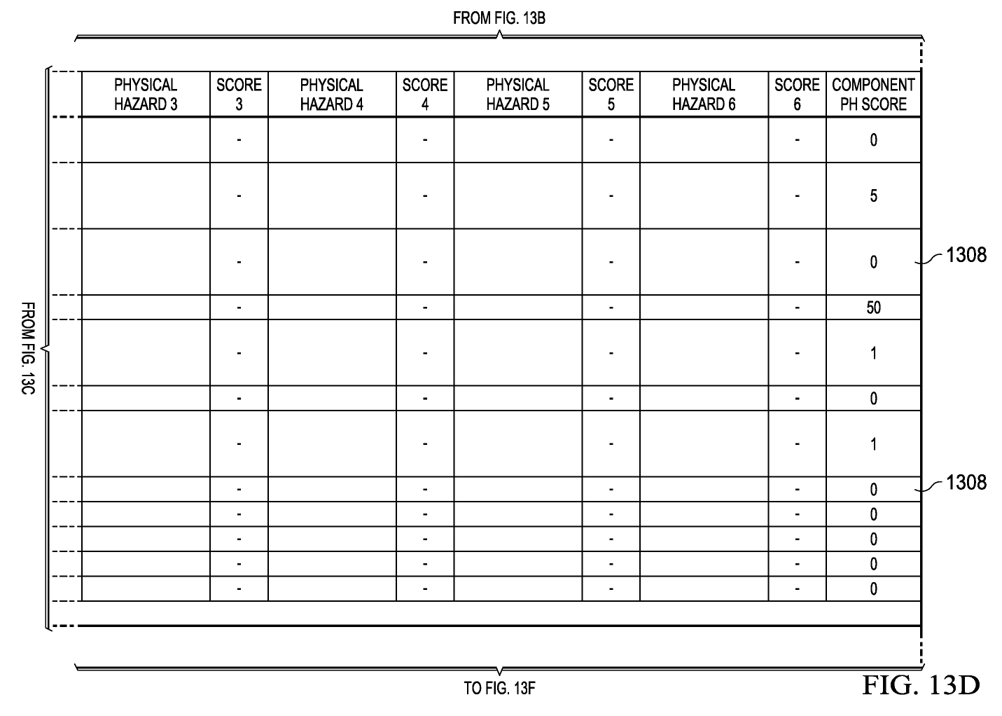

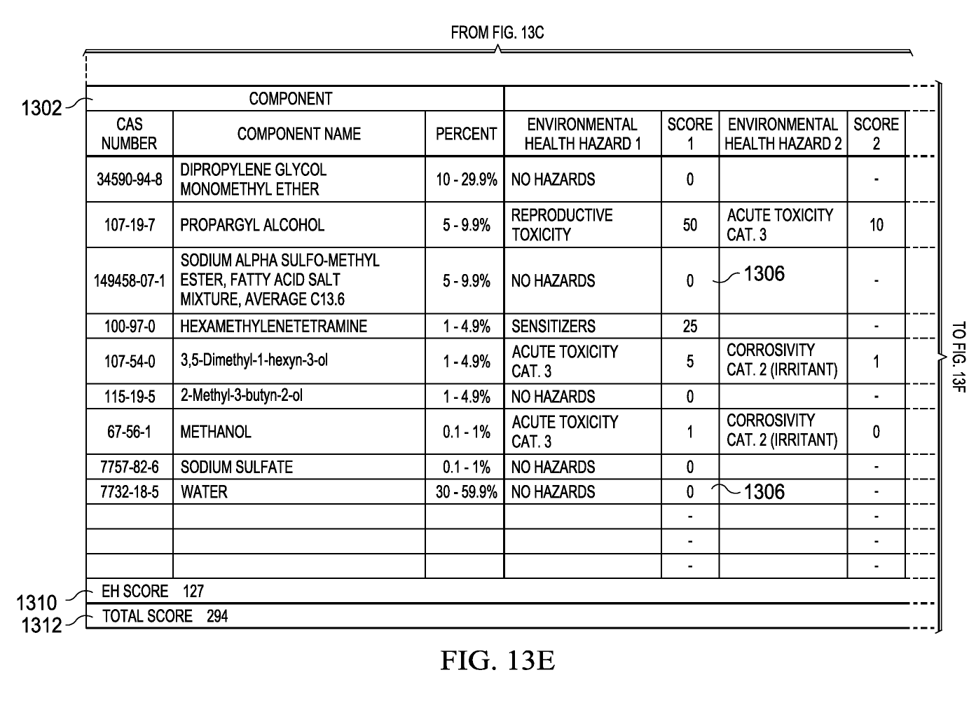

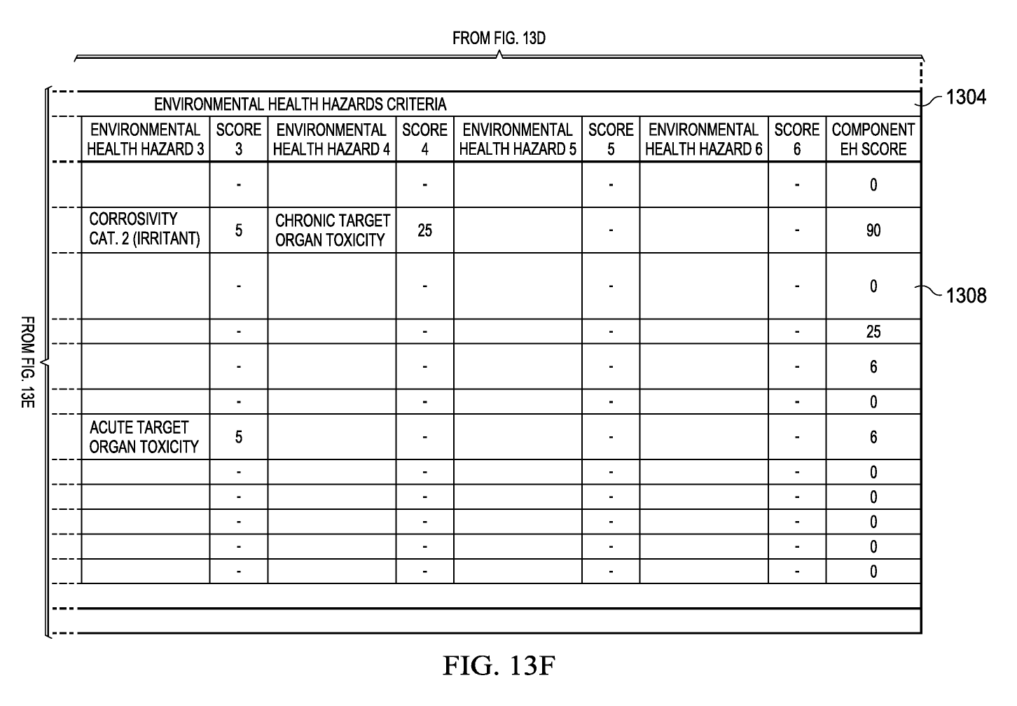

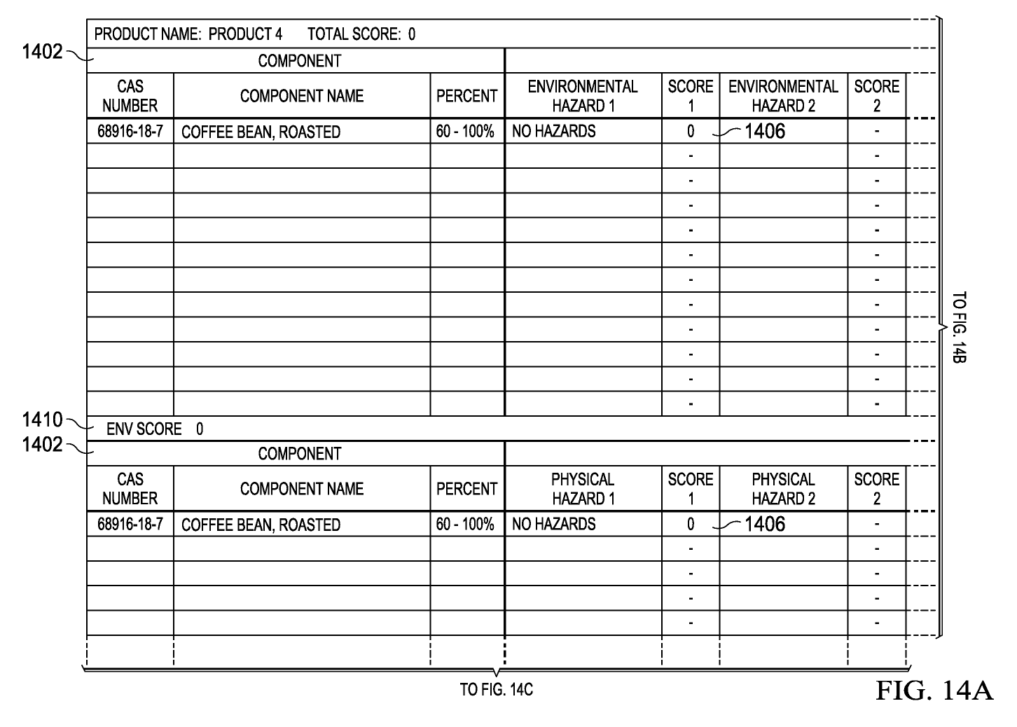

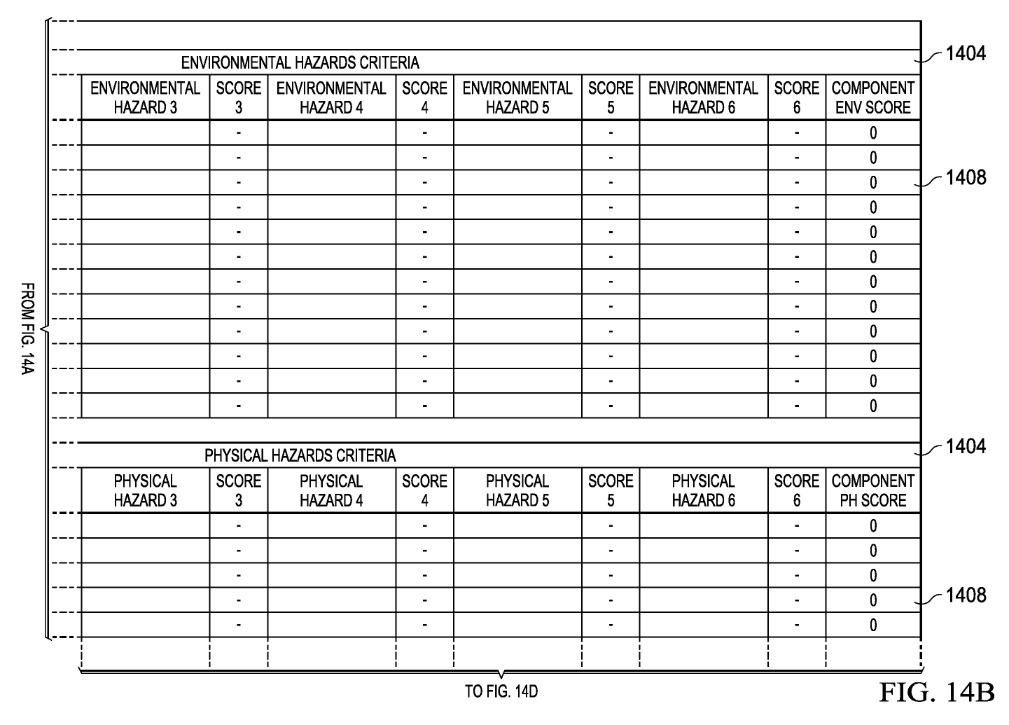

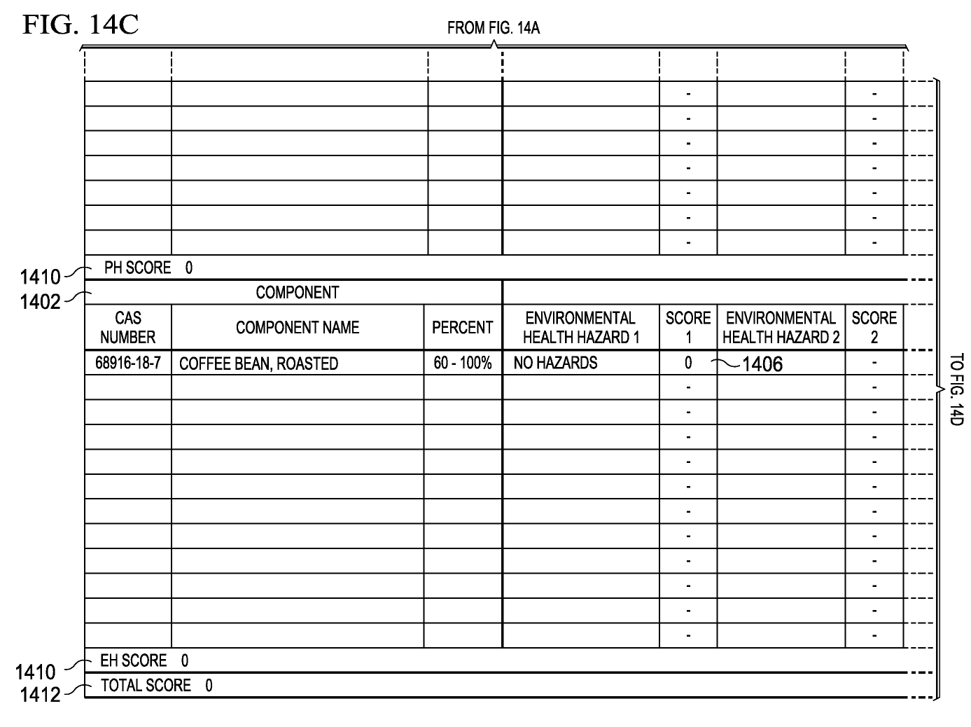

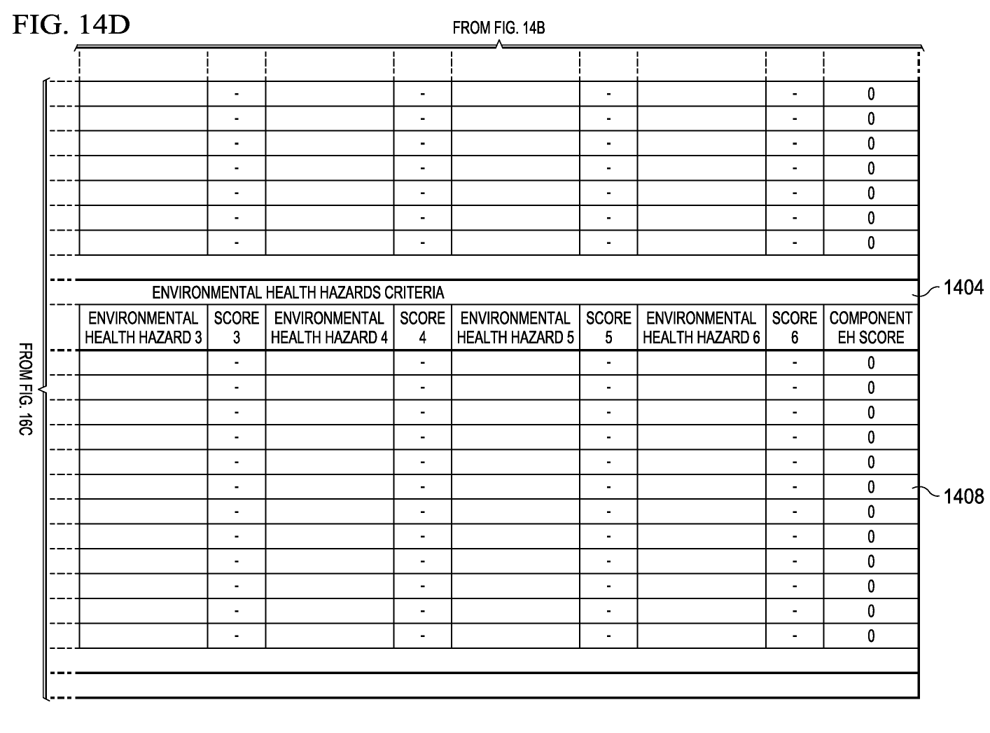

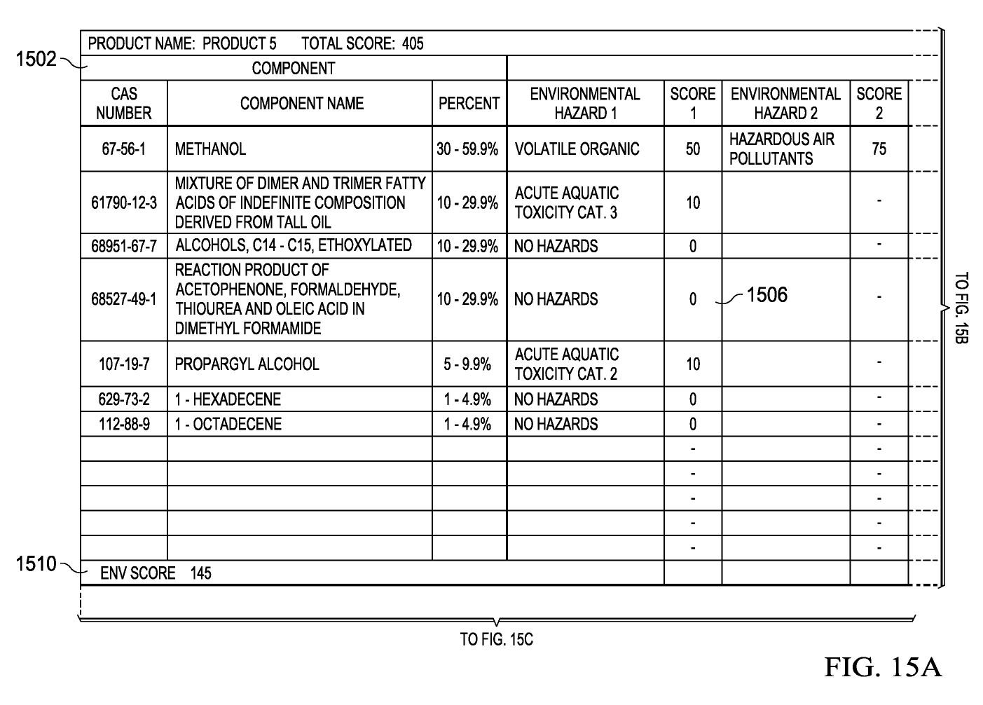

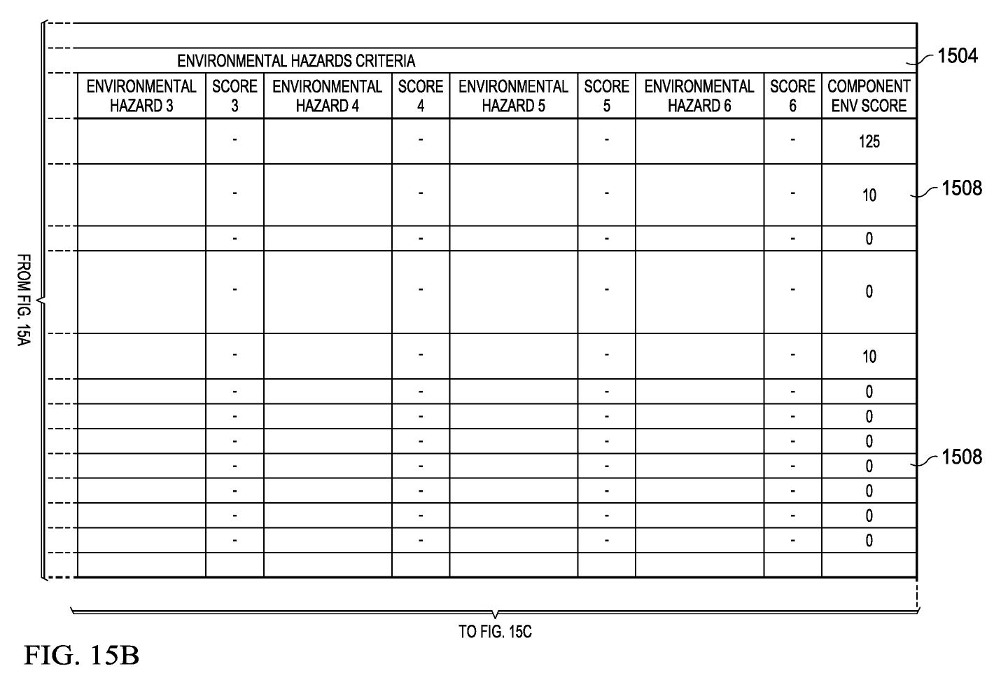

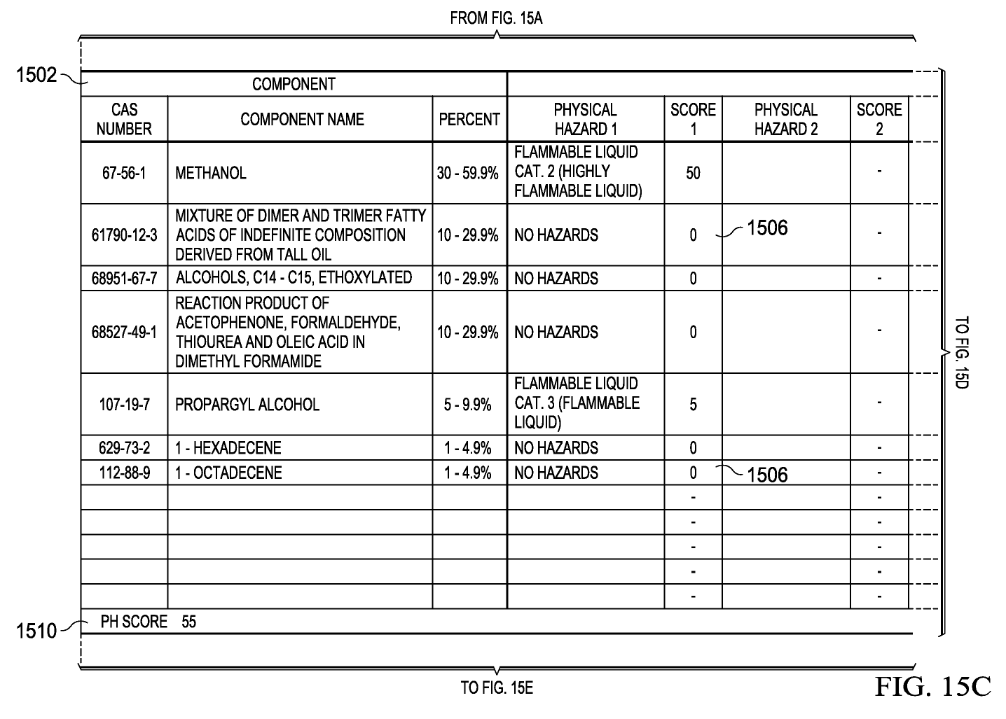

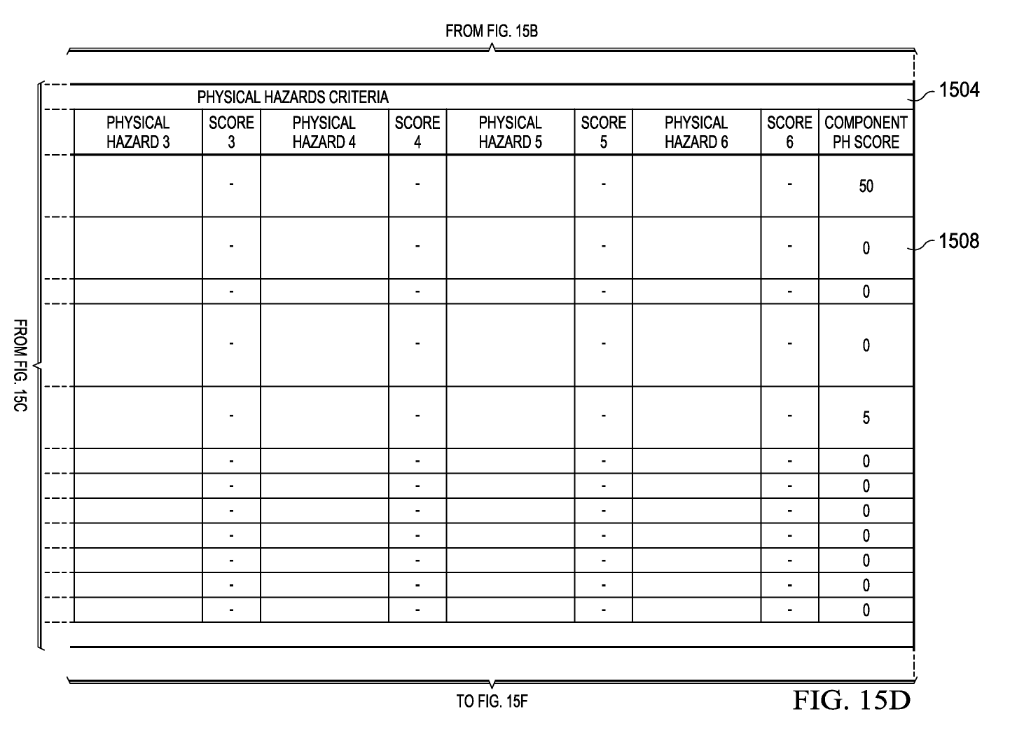

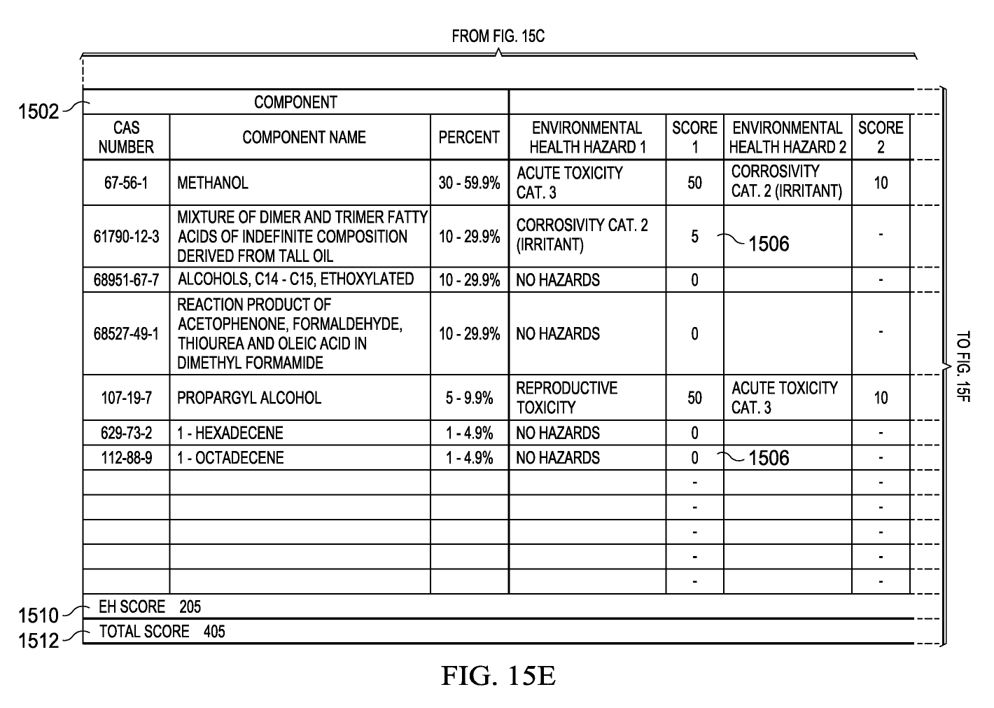

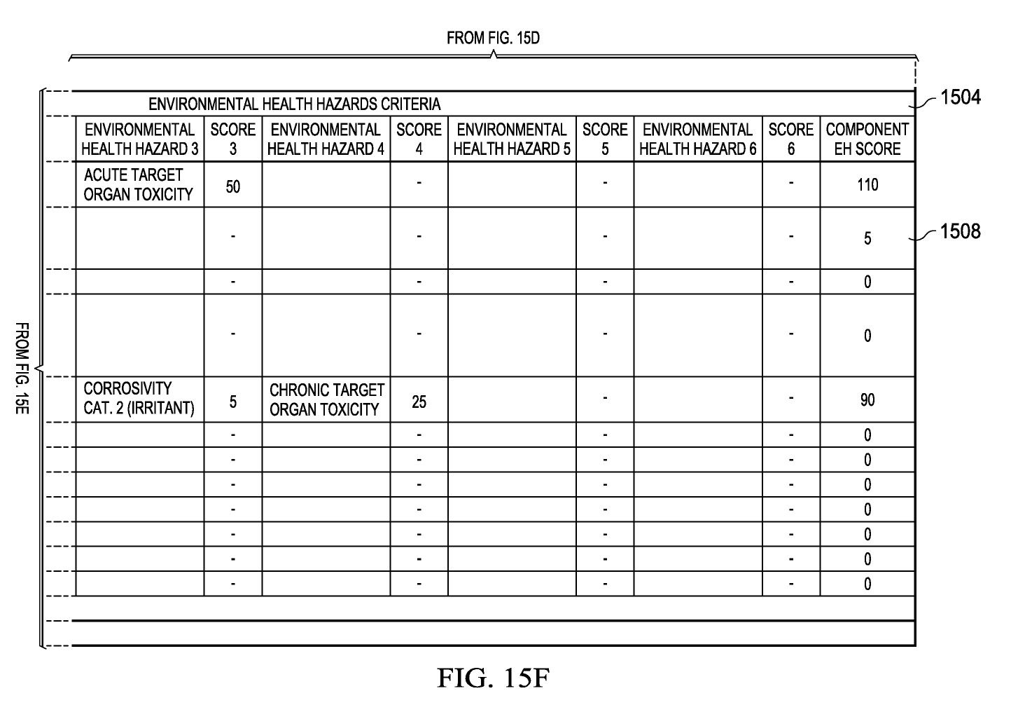

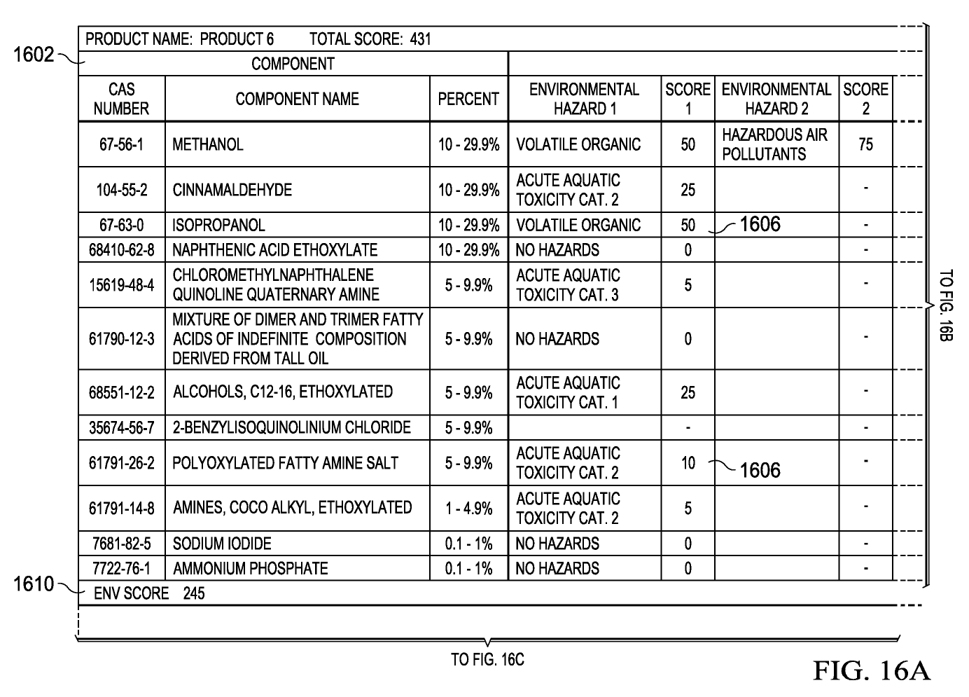

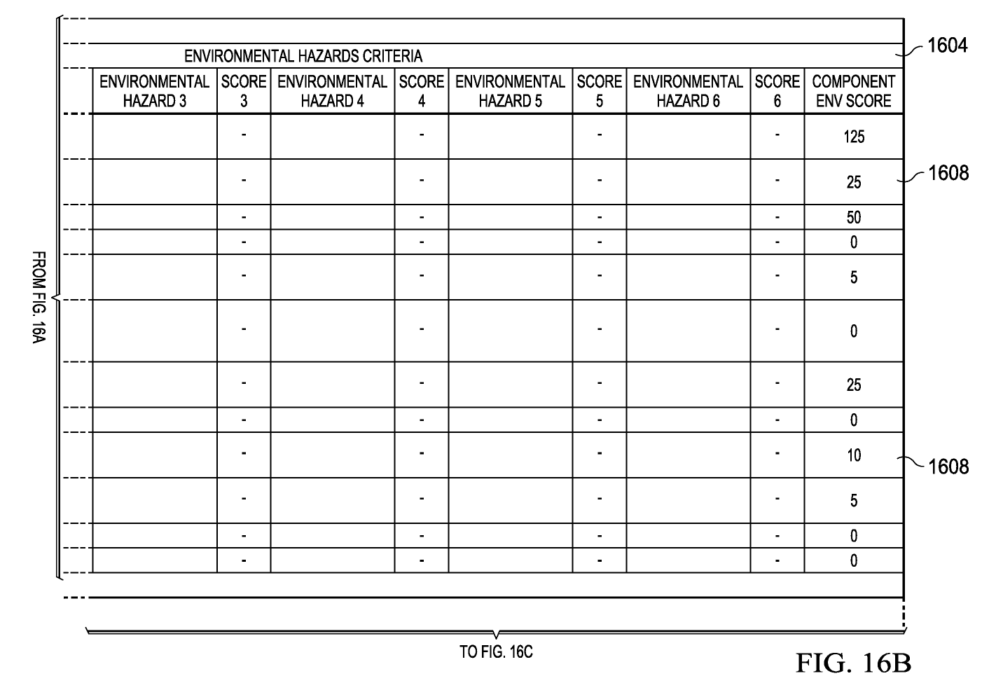

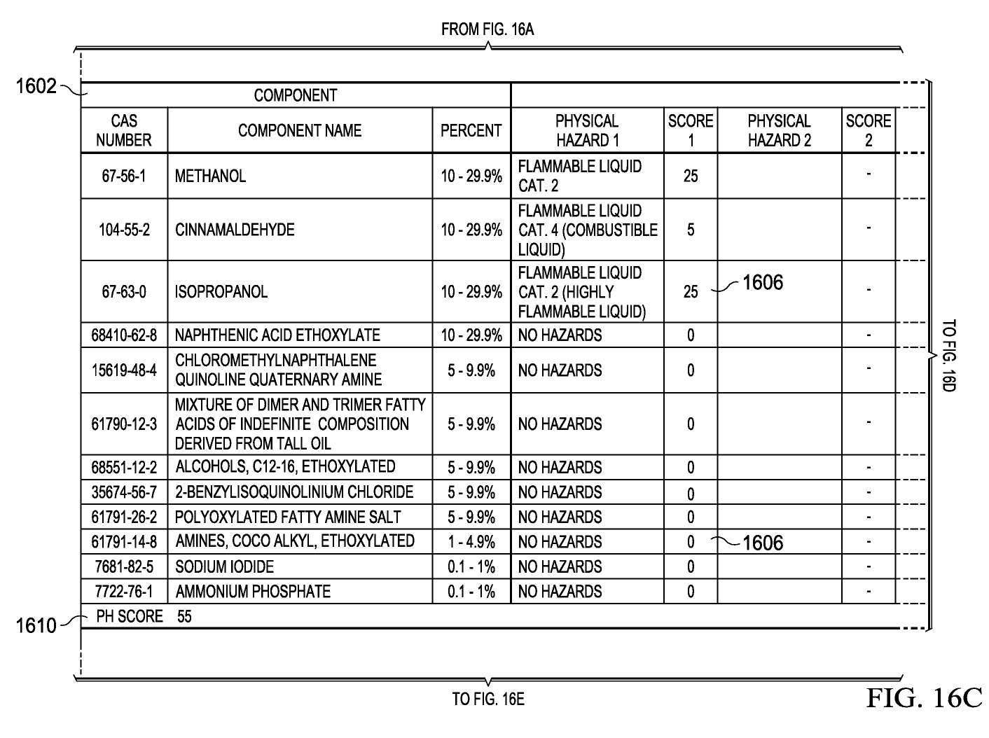

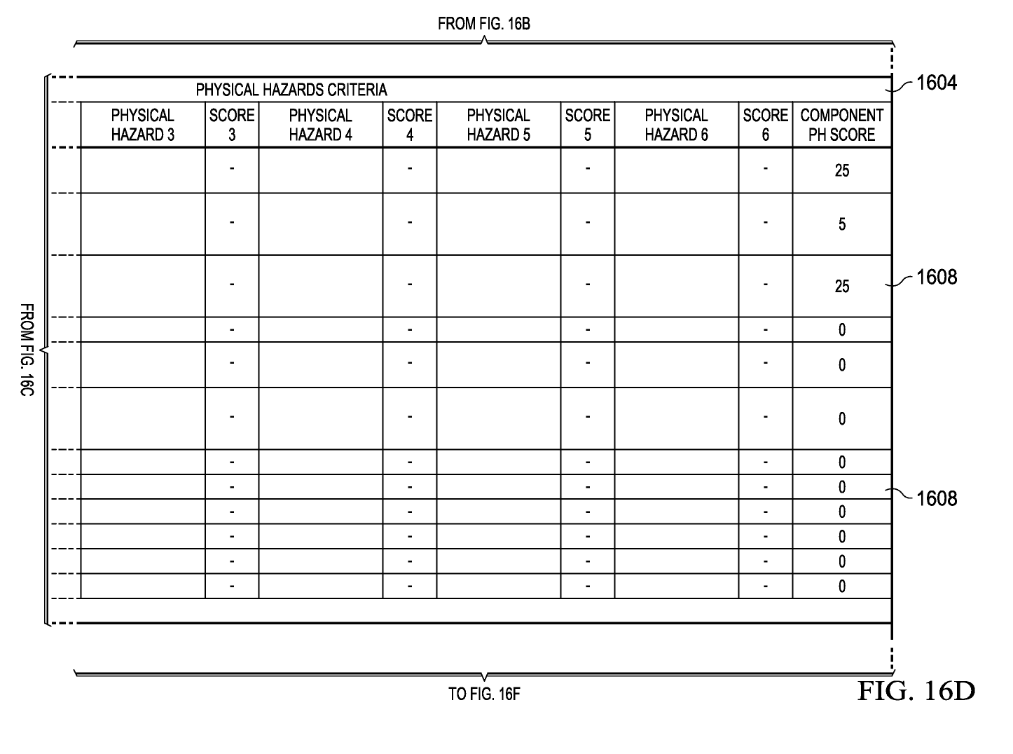

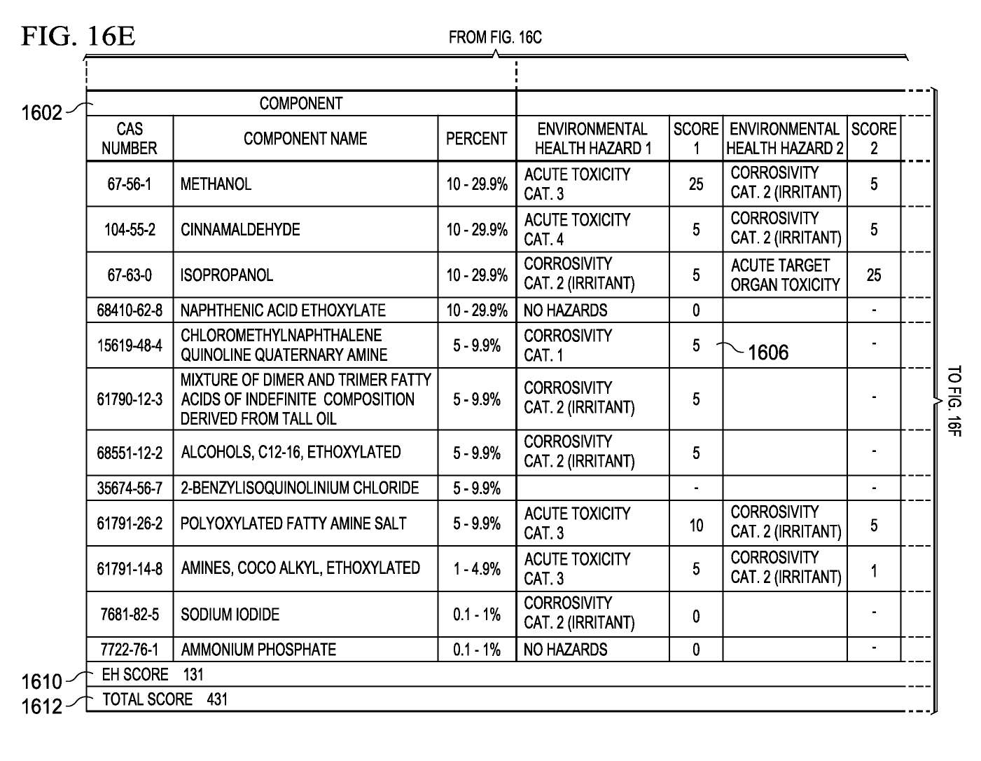

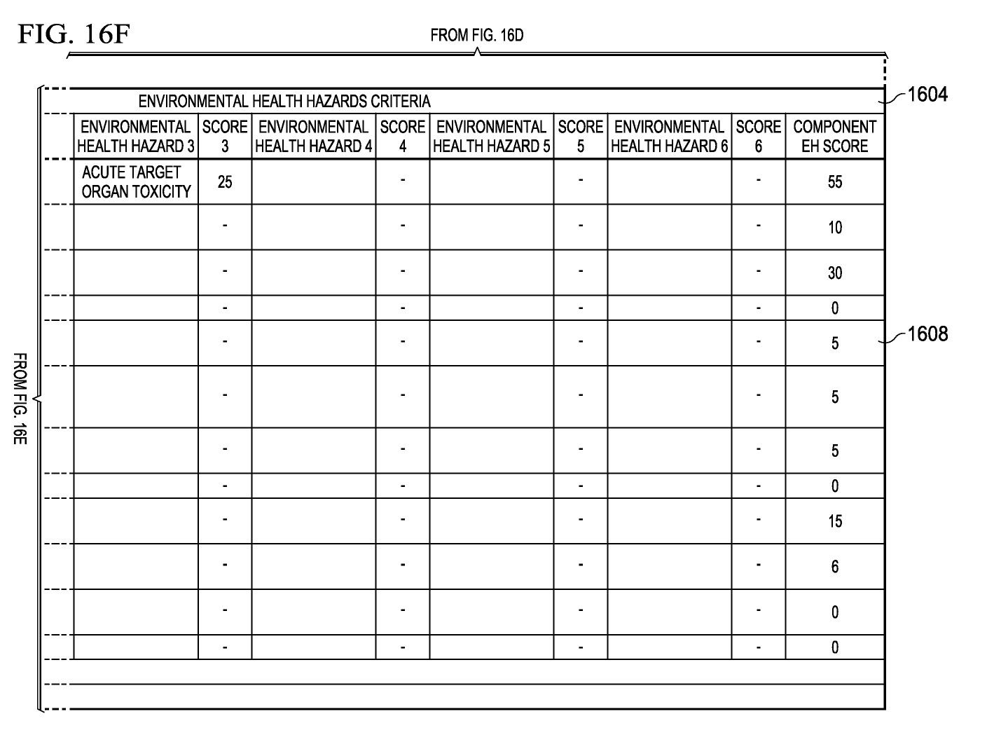

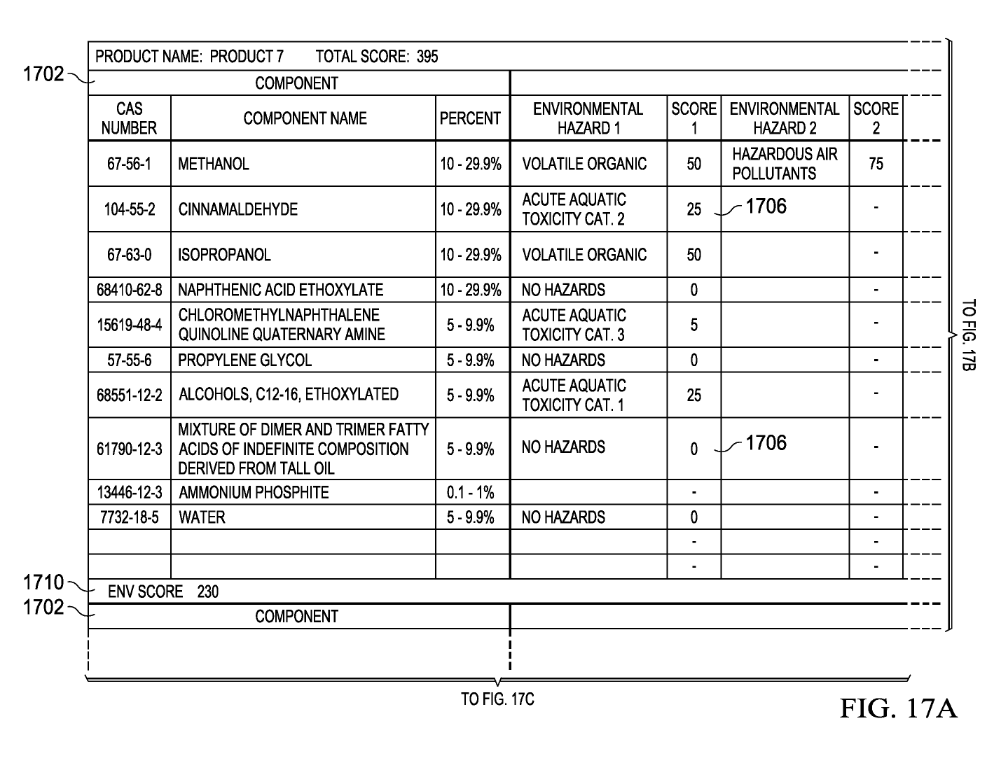

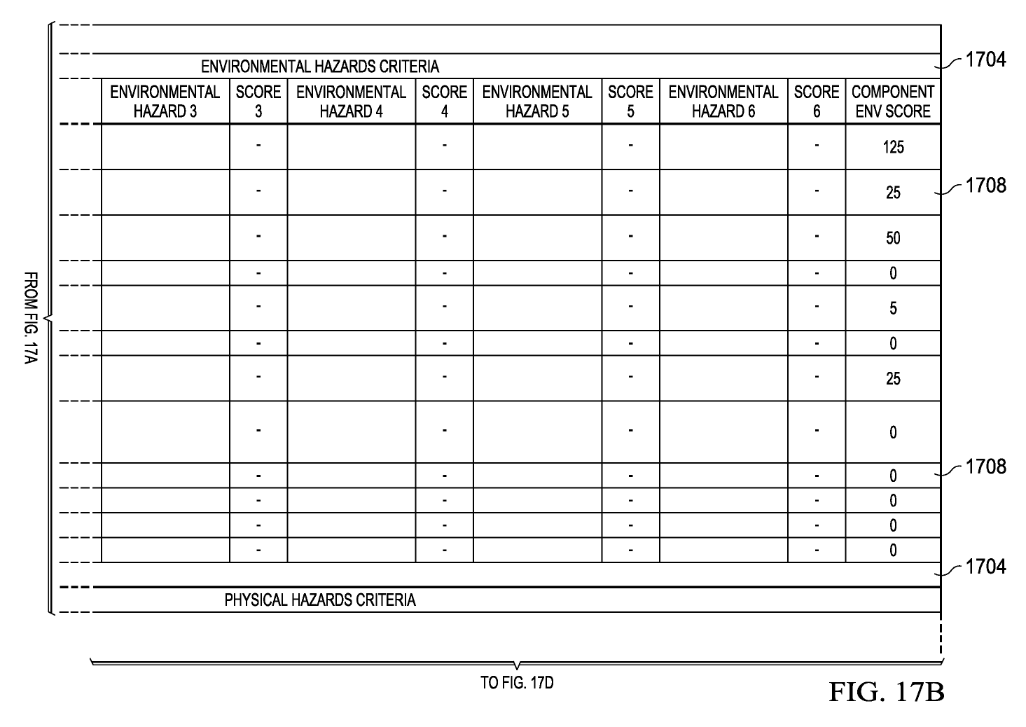

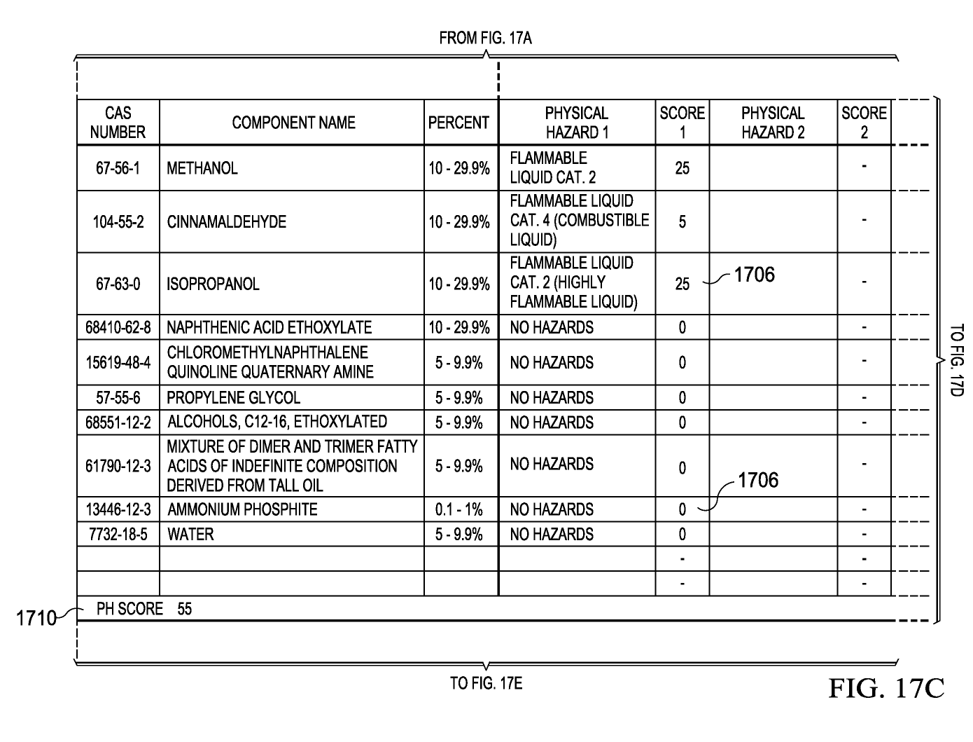

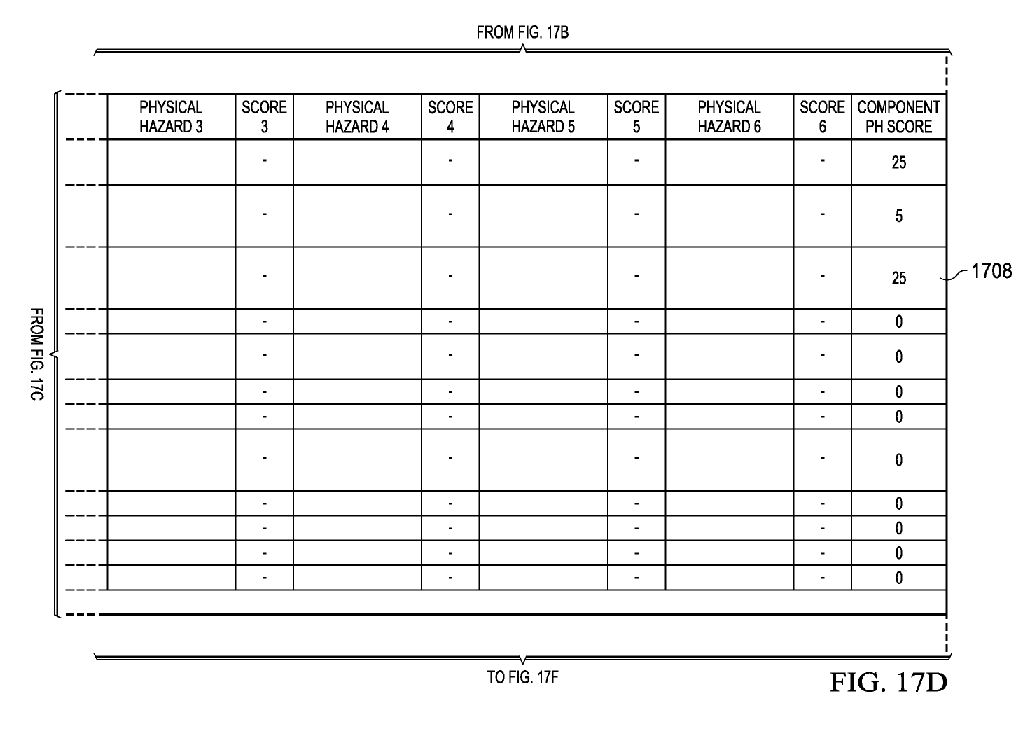

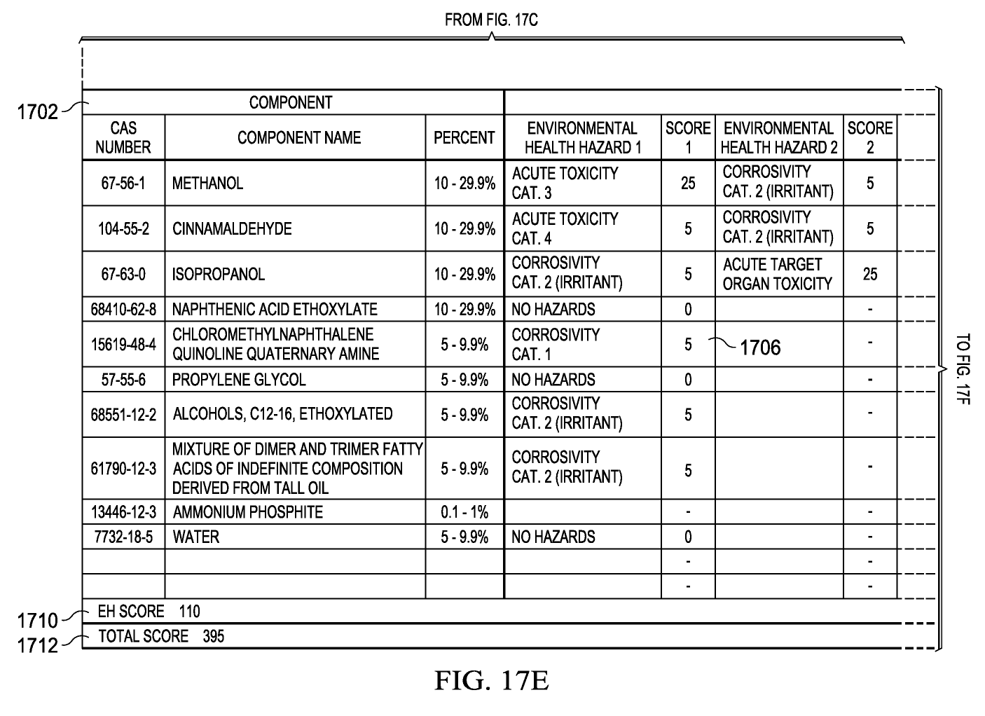

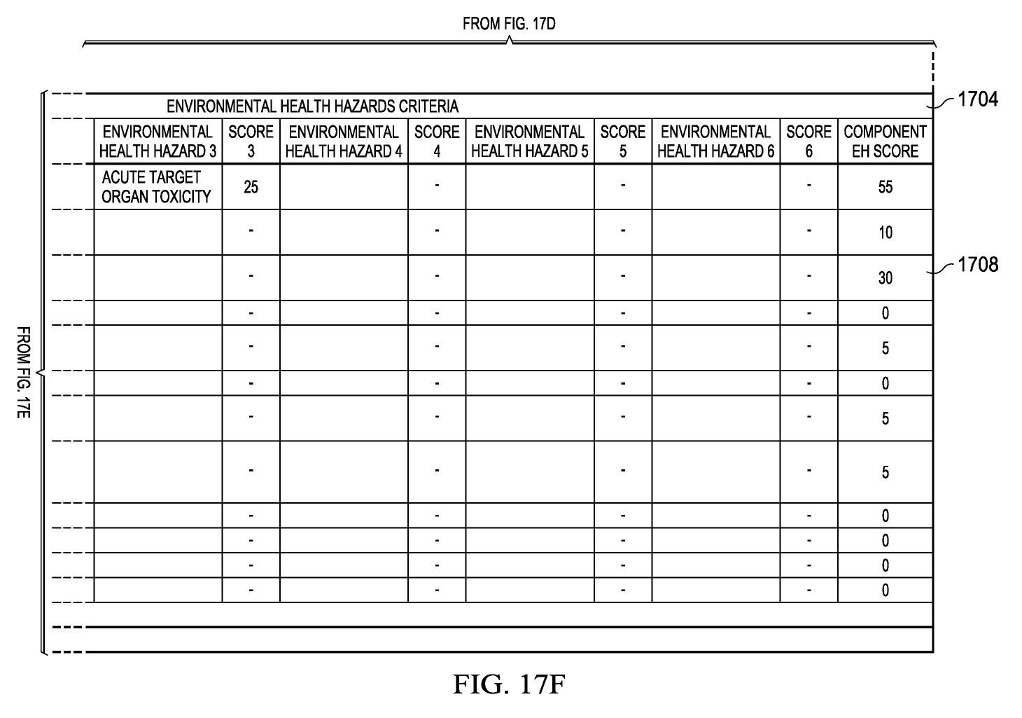

Exemplary product scores for products Product 1, Product 2, Product 3, Product 4, Product 5, Product 6, and Product 7are illustrated in FIGS. 11-17. In particular, FIG. 11 illustrates the components 1102, criteria 1104, criteria hazard score 1106, component hazard score 1108, category hazard score 1110 and product hazard score 1112 for Product 1. FIG. 12 illustrates the components 1202, criteria 1204, criteria hazard score 1206, component hazard score 1208, category hazard score 1210 and product hazard score 1212 for Product 2 FIG. 13 illustrates the components 1302, criteria 1304, criteria hazard score 1306, component hazard score 1308, category hazard score 1310 and product hazard score 1312 for Product 3. FIG. 14 illustrates the components 1402, criteria 1404, criteria hazard score 1406, component hazard score 1408, category hazard score 1410 and product hazard score 1412 for Product 4. FIG. 15 illustrates the components 1502, criteria 1504, criteria hazard score 1506, component hazard score 1508, category hazard score 1510 and product hazard score 1512 for Product 5. FIG. 16 illustrates the components 1602, criteria 1604, criteria hazard score 1606, component hazard score 1608, category hazard score 1610 and product hazard score 1612 for Product 6. FIG. 17 illustrates the components 1702, criteria 1704, criteria hazard score 1706, component hazard score 1708, category hazard score 1710 and product hazard score 1712 for Product 7.

Referring back to FIG. 2, the comparative graphs module 208 may comprise one or more graphs for display to a user on a display. The graphs may be created dynamically on the fly or may be created and stored for later use. In a particular embodiment, the comparative graphs module 208 may comprise product type graphs 250 and/or job suitable graphs 252. The product type graphs 250 may be pre-created and stored for later review and use. The product type may be based on any suitable characteristic. The suitable job graphs 252 may be created dynamically based on filtering of products to determine those that are suitable for a specific job and then displaying the products hazard score for the suitable products. The job suitable graph may be in response to a user request and input. For example, a user may input job requirements or specifications and suitable products identified from products listed in the products module 206 or otherwise.

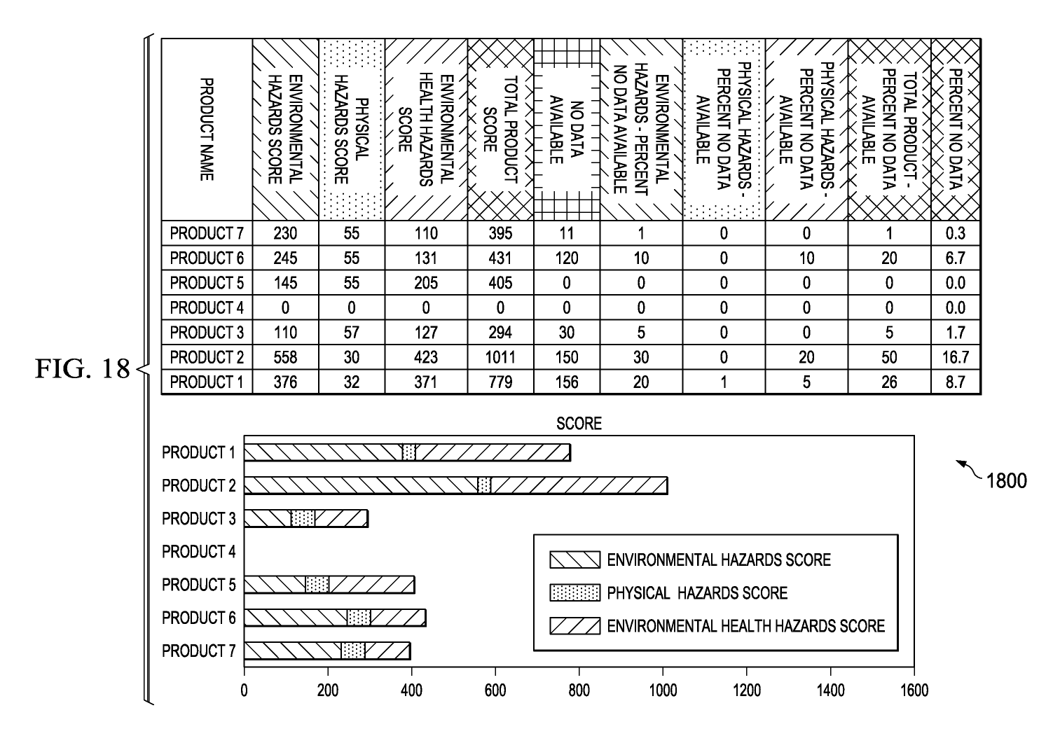

An exemplary product type graph 250 is illustrated in FIG. 18. The graph 250 may comprise a bar graph 1800 visually illustrating the product score as well as the hazard category scores for each of a plurality of products. In addition, information on the components for which no data is available may also be displayed with the bar graph 1800. In a particular embodiment, the system may not score a product if less than seventy percent 70% of the components by percentage has available data. In other embodiments, the cut-off percentage may be greater, such as eighty, ninety or ninety-five percent (80%, 90%, 95%), or less, such as sixty or sixty-five percent (60%, 65%).

The job suitable graph 252 may be similar to the product type graph 250, except that it only illustrates those products meeting the requirements for a job and/or indicates which products do not meet the criteria by graying them out or otherwise. Specifications and performance criteria for products 240 may be stored in a products module 206 or separately from the hazard engine 200.

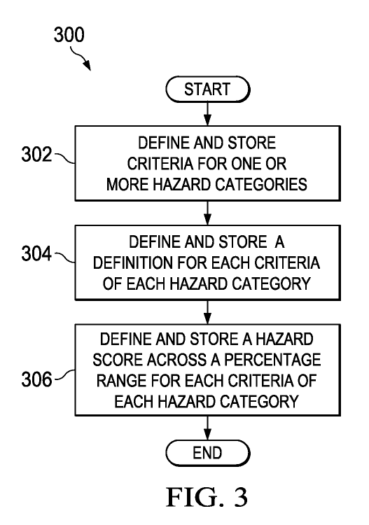

FIG. 3 illustrates an exemplary flow diagram of a method of defining and storing hazard scores for criteria in one or more hazard categories. Referring to FIG. 3, the method begins a step 302 in which criteria are defined and stored for one or more hazard categories. As previously discussed, the hazard categories may in one embodiment comprise a environmental hazard category 220, a physical hazard category 222, and an environmental health hazard category 224. The criteria may be based on standards published by a governmental body such as the United Nations, the United States, Europe, Japan, Australia, and/or other nation or governmental body. Specific embodiments may use criteria from Workplace Hazardous Materials Information System (WHMIS), Dangerous Substances Directive 67/548/EEC, OSHA Hazard Communication Standard—29 CFR 1910.120, and/or GHS.

Next, at step 304, a definition for each criteria of each hazard category is defined and stored. In one embodiment, the definitions may be those defined by a standard body such as a governmental body. Exemplary criteria and associated definitions for the environmental hazard category 220, the physical hazard category 222, and the environmental health hazard category 224 are illustrated by FIGS. 5-7.

Proceeding to step 306, a hazard score is defined and stored across a percentage range for each criteria of each hazard category. The hazard score may be a continuous score across a range or the range may be sub-divided into discreet sub-ranges. A maximum score for each criteria may be defined based on the impact of that criteria in a hazards category. In this embodiment, the score will be at or less than the maximum score based on the impact of the criterion to the hazard category at the associated percentage range.

Step 306 leads to the end of the method by which a hazard score may be defined for each of a plurality of criteria for each of one or more hazards categories. The hazard scores may be used in connection with product information to determine a comprehensive product hazard score that takes into account a number of hazards categories including, for example, environmental hazards, physical hazards, and environmental health hazards.

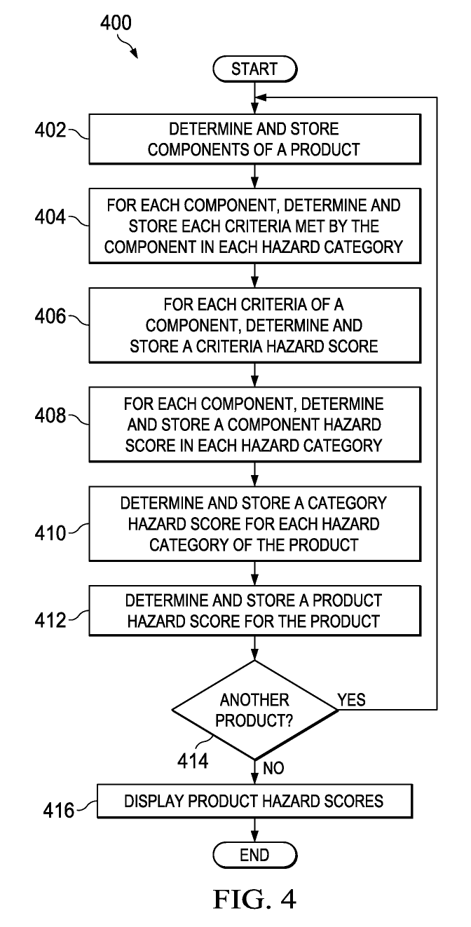

FIG. 4 illustrates an example flow diagram of a method of determining, storing and displaying product hazard scores. In addition, the system may print the hazard score, a representation of the hazard score, a comparative graph of hazard scores, the underlying component scores (e.g., environment hazard, environment health hazard, physical hazard scores), and/or any other information used in determining the scores. The system may also store, electronically communicate, display, update, and/or otherwise process one or more of the following. The method begins at step 402 in which components of a product are determined and stored. The percentage of the component in the product is also stored as part of the product information.

Next, at step 404, for each component, criteria met by the component is determined and stored for each hazard category. Thus, component may meet one or more criteria in each of one or more hazard categories. At step 406, for each criteria of a component, a hazard score is determined and stored. The hazard score may be determined from the criteria score module 204 including from the environmental criteria scores 230, the physical criteria scores 232 and environmental health criteria scores 234.

At step 408, a component hazard score is determined and stored in each hazard category. The competent hazard score may be total of the criteria hazard scores for a component in a hazard category. At step 410, a category hazard score is determined and stored for each hazard category. The category hazard score may be the sum of the component hazard scores. At step 412, a product hazard score is determined and stored for the product. The product hazard score may be the sum of the category hazard scores for the product. Thus, for each product, the product hazard engine 200 may determine and store a comprehensive product hazard score as well as the category hazard scores.

Proceeding to decisional step 214, if another product is to be evaluated, the Yes branch of decisional step 214 returns to step 204 in which components of the next product are determined and stored. After all products have been evaluated and product hazard scores determined, the No branch of decisional step 214 leads to step 216. At step 216, the product hazard scores are displayed. The product hazard scores may be displayed in lists or graphically. For example, the product hazard scores may be displayed in comparative graphs and may include the category sub-scores. Thus, in this embodiment, a comparison tool is provided. In this way, the properties of chemical products are quantified so that they can in some embodiments be prioritized for use based on the products potential health, safety, and environmental hazard. The method and system may provide a balance that quantifies a degree of hazard level of a chemical product for environmental hazards, physical hazards, and environmental health hazards categories. In the described embodiment, the lower the score, the more environmentally responsible the product may be. The score for products in the same usage type may be compared to determine the best environmental responsible product for use. In addition, scores or products with similar scores may be grouped (low hazard, medium hazard, high hazard, very high hazard, etc.) for comparison. Thus, in some embodiments, indications of scores or score groups may be displayed or used rather than the underlying scores. The scores may also be used to promote use of more environmentally responsible chemicals and products and help in the development of less hazardous chemical products and to help prioritize products in a chemical folio suitable for use on a particular job. Thus, for example, the use of various chemicals as a component in a product may be evaluated as described above for different products.

A number of embodiments of the invention have been described. Nevertheless, it will be understood that various modifications may be made without departing from the spirit and scope of the invention. Accordingly, other embodiments are within the scope of the following claims.

What is claimed is:

1. A system for presenting comprehensive hazard information for a plurality of products, comprising
a memory storing components for each of a plurality of products, an environmental hazard score for each component, an environmental health hazard score for each component, a physical hazard score for each component, and a product hazard score for each product based on the environmental hazard score, the environmental health hazard score, and the physical hazard score of each component of the product; and
a processor operable to process user request and to display the product hazard score for at least one product on a display.

2. The system of claim 1, further comprising the processor operable to display product scores for one or more products suitable for a job.

3. The system of claim 1, further comprising the processor operable to display a comparative graph of a plurality of products.

4. The system of claim 1, further comprising the environmental hazard score, the environmental health hazard score, and the physical hazard score weighted at least based on the percentage of the component in the product.

5. The system of claim 1, further comprising the environmental hazard score of a component weighted at least based on a level of environmental hazard of the component, the environmental health hazard score weighted at least based on a level of environmental health hazard of the component, and the physical hazard score weighted at least based on a level of physical hazard of the component.

6. The system of claim 1, further comprising:
the environmental hazard score comprising a plurality of acute aquatic toxicity, chronic aquatic toxicity, ozone depletion, volatile organic compounds, hazardous air pollutants, hazardous water pollutants, biodegradation, and bioaccumulation scores;
the environmental health hazard score comprising a plurality of carcinogenicity, mutagenicity, reproductive toxicity, endocrine disruptors, sensitizers, acute toxicity, corrosivity, acute target organ toxicity, chronic target organ toxicity, and aspiration hazard scores; and
the physical hazard scores comprising a plurality of explosive, pyrotechnic, flammable gas, oxidizing gas, gases under pressure, flammable liquid, flammable solid, self-reactive substance, pyrophoric, self-heating substance, emit flammable gases in contact with water, oxidizing liquid, oxidizing solid, organic peroxide, and corrosive to metals scores.

7. The system of claim 1, further comprising:
the environmental hazard score comprising a plurality of water, air, soil, sustainability and hazardous waste scores;
the environmental health hazard score comprising a plurality of carcinogen/mutagen/reproductive, toxicity, eye/skin, and aspiration scores; and
the physical hazard scores comprising a plurality of explosive, compressed gasses, flammable liquids, flammable solids, oxidizers, corrosives, and radioactive scores.

8. A comprehensive product scoring system, comprising:
a product score for each of a plurality of products;
the product score each based on scores of a plurality of hazard categories comprising:
an environmental hazard score based on an environmental criterion scores for each component of the product;
an environmental health hazard score based on an environmental health criterion scores for each component of the product; and
an physical hazard score based on an physical criterion scores for each component of the product; and
the criterion scores for each component weighted at least based on a level of hazard of the component in the hazard category and a percentage of the component in the product.

9. The system of claim 8, further comprising:
the environmental criterion score based on environmental criterion, the environmental health criterion score based on environmental health criterion, and the physical criterion score based on physical criterion; and
the environmental criterion, environmental health criterion and the physical criterion based on at least the Globally Harmonized System for Classification and Labeling of Chemicals (GHS).

10. The system of claim 8, further comprising the environmental criterion scores accounting for environmental impact of the component to air, water and soil.

11. The system of claim 8, the environmental criterion scores comprising aquatic toxicity, hazardous pollutants, biodegradation, and bioaccumulation scores.

12. The system of claim 8, the environmental criterion scores comprising acute aquatic toxicity, chronic aquatic toxicity, ozone depletion, volatile organic compounds, hazardous air pollutants, hazardous water pollutants, biodegradation, and bioaccumulation scores.

13. The system of claim 8, further comprising the environmental health criterion scores accounting for environmental health impact of the component to carcinogenicity, mutagenicity, reproductive toxicity, toxicity, eye/skin and aspiration.

14. The system of claim 8, the environmental health criterion scores comprising carcinogenicity, mutagenicity, reproductive toxicity, endocrine disruptors, sensitizers, acute toxicity, corrosivity, acute target organ toxicity, chronic target organ toxicity, and aspiration hazard scores.

15. The system of claim 8, further comprising the physical criterion scores accounting for physical impact of the component as explosive, compressed gasses, flammable liquid, flammable solid, oxidizer, corrosive, and radioactive.

16. The system of claim 8, the physical criterion scores comprising explosive, pyrotechnic, flammable gas, oxidizing gas, gases under pressure, flammable liquid, flammable solid, self-reactive substance, pyrophoric, self-heating substance, emit flammable gases in contact with water, oxidizing liquid, oxidizing solid, organic peroxide, and corrosive to metals scores.

17. A computer implemented method for presenting comprehensive hazard information for a plurality of products, comprising:
storing a list of chemical components for each of a plurality of products;
storing for each chemical component an environmental hazard score, an environmental health hazard score, and a physical hazard score;
storing a product hazard score for each product based on the environmental hazard score, the environmental health hazard score, and the physical hazard score of each component of the product; and
displaying the product hazard scores of the plurality of products.

18. The method of claim 17, wherein the environmental hazard score, the environmental health hazard score, and the physical hazard score are weighted at least based on a percentage of the component in the product.

19. The method of claim 17, wherein the environmental hazard score is weighted at least based on a level of environmental hazard of the component, the environmental health hazard score is weighted at least based on a level of environmental health hazard of the component, and the physical hazard score is weighted at least based on a level of physical hazard of the component.

20. The method of claim 17, further comprising displaying a graphical representation of the product hazard score of the plurality of products.
